(19) United States
(12) Patent Application Publication
(10) Pub. No.: US 2026/0187851 A1
(43) Pub. Date: Jul. 2, 2026

(54) Weight-Based Prediction Mode Determination for a RAHT Node

(71) Applicant: Comcast Cable Communications, LLC, Philadelphia, PA (US)

(72) Inventors: Sébastien Lasserre, Thorigné-Fouillard (FR); Jonathan Taquet, Talensac (FR)

(21) Appl. No.: 19/431,592

(22) Filed: Dec. 23, 2025

Related U.S. Application Data
(60) Provisional application No. 63/739,539, filed on Dec. 28, 2024.

(51) Int. Cl. G06T 9/00; G06T 9/40

(52) U.S. Cl. CPC G06T 9/001; G06T 9/40

(57) ABSTRACT

Systems, apparatuses, methods, and computer-readable media are described for choosing an attribute coding mode based on a weight associated with a group of points (e.g., voxels) in a point cloud associated with content. The value of the weight may correspond to the number/quantity of voxels. Inter, intra or average prediction mode may be selected to code attributes based on comparison of the weight with a threshold. Advantages such as improved compression performance may be achieved.

### CROSS-REFERENCE TO RELATED APPLICATIONS

This application claims the benefit of U.S. Provisional Application No. 63/739,539 filed on Dec. 28, 2024. The above referenced application is hereby incorporated by reference in its entirety.

### BACKGROUND

An object or scene may be described using volumetric visual data consisting of a series of points. The points may be stored as a point cloud format that includes a collection of points in three-dimensional space. As point clouds can get quite large in data size, transmitting and processing point cloud data may need a data compression scheme that is specifically designed with respect to the unique characteristics of point cloud data.

### SUMMARY

The following summary presents a simplified summary of certain features. The summary is not an extensive overview and is not intended to identify key or critical elements.

Point cloud frames associated with content may comprise geometry information and attribute information (e.g., color or texture of the geometry). Attribute information may be coded separately from geometry information in a point cloud. Attributes of a portion of decoded geometry may be coded, for example, using an attribute coding mode (e.g., an inter-prediction mode or an intra-prediction mode). The attribute coding/prediction mode may be determined based on a weight associated with a group of points (e.g., voxels) in the point cloud. The value of the weight may correspond to the number/quantity of voxels. For example, a larger number of voxels may correspond to a larger weight. For example, if the weight is higher than a threshold, an inter-prediction mode or an intra-prediction mode may be selected to code the attributes. An average prediction mode may be used for the coding, for example, if the weight is lower than the threshold. Advantages such as improved compression performance may be achieved.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example point cloud coding system.

FIG. 2 shows an example Morton order.

FIG. 3 shows an example scanning order.

FIG. 4 shows an example neighborhood of cuboids for coding the occupancy of a child cuboid.

FIG. 5 shows an example of a dynamic reduction function that may be used in dynamic Optimal Binary Coders with Update on the Fly (OBUF).

FIG. 6 shows an example method for coding occupancy of a cuboid using dynamic OBUF.

FIG. 7 shows an example of an occupied cuboid.

FIG. 8A shows an example cuboid corresponding to a TriSoup node.

FIG. 8B shows an example refinement to the TriSoup model.

FIG. 8C shows an example of coding a centroid residual value.

FIG. 9A shows an example of voxelization.

FIG. 9B shows an example of voxelization.

FIG. 10 shows an example method for encoding a point cloud.

FIG. 11 shows an example method for encoding attributes.

FIG. 12 shows an example method for decoding a point cloud.

FIG. 13A shows an example method for decoding attributes.

FIG. 13B shows an example of an inter-prediction attribute parametric model.

FIG. 13C shows an example of an inter-prediction attribute parametric model.

FIG. 14 shows an example method for determining attribute predictors.

FIG. 15 shows an example method for encoding attributes based on attribute predictors.

FIG. 16 shows an example method for encoding attributes based on attribute predictors.

FIG. 17 shows an example method for decoding attributes based on attribute predictors.

FIG. 18 shows an example method for decoding attributes based on attribute predictors.

FIG. 19 shows an example Region Adaptive Hierarchical Transform (RAHT) transformation.

FIG. 20 shows an example RAHT transformation.

FIG. 21A shows an example method for encoding attribute information for child RAHT nodes.

FIG. 21B shows an example method for decoding attribute information for child RAHT nodes.

FIG. 22 shows an example method for up-sampling the mean sums of attributes values of RAHT nodes.

FIG. 23 shows an example method for encoding attributes of a RAHT node.

FIG. 24 shows an example method for encoding attributes of a RAHT node.

FIG. 25 shows an example method for decoding attributes of a RAHT node.

FIG. 26 shows an example method for decoding attributes of a RAHT node.

FIG. 27A shows an example of the top-down traversal of a RAHT process.

FIG. 27B shows an example of the top-down traversal of the RAHT process.

FIG. 27C shows an example of the top-down traversal of a RAHT process.

FIG. 28A shows an example method for encoding attributes of a RAHT node.

FIG. 28B shows an example method for encoding attributes of a RAHT node.

FIG. 29A shows an example method for decoding attributes of a RAHT node.

FIG. 29B shows an example method for decoding attributes of a RAHT node.

FIG. 30 shows an example method for encoding attributes of a RAHT node.

FIG. 31 shows an example method for decoding attributes of a RAHT node.

FIG. 32 shows an example computer system in which examples of the present disclosure may be implemented.

FIG. 33 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of point cloud or point cloud sequence encoding or decoding systems. More particularly, the technology disclosed herein may relate to point cloud compression as used in encoding and/or decoding devices and/or systems.

At least some visual data may describe an object or scene in content and/or media using a series of points. Each point may comprise a position in two dimensions (x and y) and one or more optional attributes like color. Volumetric visual data may add another positional dimension to these visual data. For example, volumetric visual data may describe an object or scene in content and/or media using a series of points that each may comprise a position in three dimensions (x, y, and z) and one or more optional attributes like color, reflectance, time stamp, etc. Volumetric visual data may provide a more immersive way to experience visual data, for example, compared to the at least some visual data. For example, an object or scene described by volumetric visual data may be viewed from any (or multiple) angles, whereas the at least some visual data may generally only be viewed from the angle in which it was captured or rendered. As a format for the representation of visual data (e.g., volumetric visual data, three-dimensional video data, etc.) point clouds are versatile in their capability in representing all types of three-dimensional (3D) objects, scenes, and visual content. Point clouds are well suited for use in various applications including, among others: movie post-production, real-time 3D immersive media or telepresence, extended reality, free viewpoint video, geographical information systems, autonomous driving, 3D mapping, visualization, medicine, multi-view replay, and real-time Light Detection and Ranging (LiDAR) data acquisition.

As explained herein, volumetric visual data may be used in many applications, including extended reality (XR). XR encompasses various types of immersive technologies, including augmented reality (AR), virtual reality (VR), and mixed reality (MR). Sparse volumetric visual data may be used in the automotive industry for the representation of three-dimensional (3D) maps (e.g., cartography) or as input to assisted driving systems. In the case of assisted driving systems, volumetric visual data may be typically input to driving decision algorithms. Volumetric visual data may be used to store valuable objects in digital form. In applications for preserving cultural heritage, a goal may be to keep a representation of objects that may be threatened by natural disasters. For example, statues, vases, and temples may be entirely scanned and stored as volumetric visual data having several billions of samples. This use-case for volumetric visual data may be particularly relevant for valuable objects in locations where earthquakes, tsunamis and typhoons are frequent. Volumetric visual data may take the form of a volumetric frame. The volumetric frame may describe an object or scene captured at a particular time instance. Volumetric visual data may take the form of a sequence of volumetric frames (referred to as a volumetric sequence or volumetric video). The sequence of volumetric frames may describe an object or scene captured at multiple different time instances.

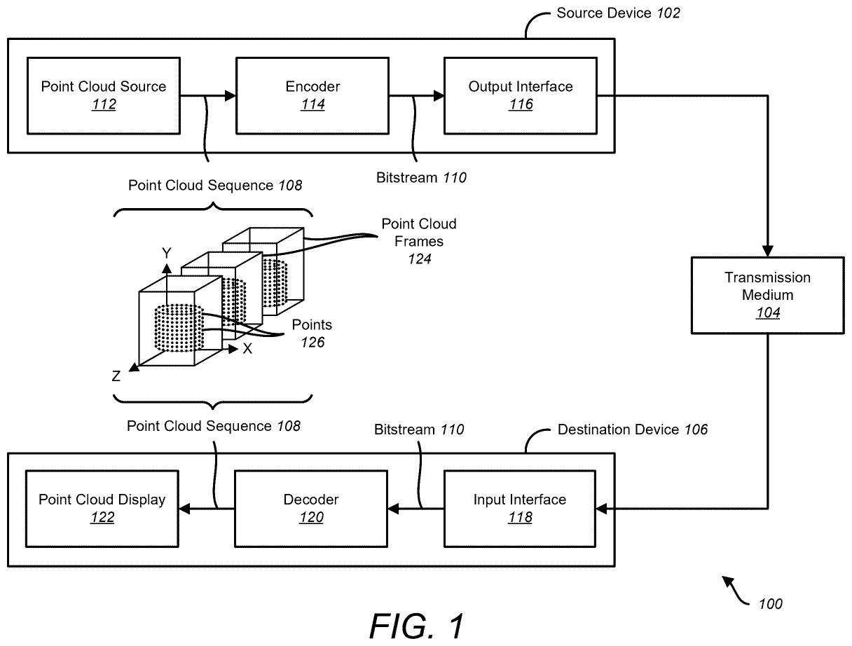

Volumetric visual data may be stored in various formats. A point cloud may comprise a collection of points in a 3D space. Such points may be used create a mesh comprising vertices and polygons, or other forms of visual content. As described herein, point cloud data may take the form of a point cloud frame, which describes an object or scene in content that is captured at a particular time instance. Point cloud data may take the form of a sequence of point cloud frames (e.g., point cloud video). As further described herein, point cloud data may be encoded by a source device (e.g., source device 102 as described herein with respect to FIG. 1) that outputs a bitstream containing the encoded point cloud data.

The source device may encode the point cloud data based on point cloud compression coding, for example, geometry-based point cloud compression (G-PCC) coding and/or video-based point cloud compression (V-PCC) coding, or next generation coding. A destination device (e.g., destination device 106 as described herein with respect to FIG. 1) receives the bitstream containing the point cloud data and decodes the bitstream containing the point cloud data. The destination device may decode the point cloud data by performing point cloud decompression coding. The decompression coding may be an inverse process of the point cloud compression coding. The point cloud decompression coding may include, for example, G-PCC coding. Decoding may be used to decompress the point cloud data for display and/or other forms of consumption (e.g., further analysis, storage, etc.).

The destination device (or a different device) may include, for example, a renderer for rendering the decoded point cloud data. The renderer may output content, for example, by rendering the point cloud data. The renderer may output content, for example, by rendering the point cloud data along with other data (e.g., audio data).

One format for storing volumetric visual data may be point clouds. A point cloud may comprise a collection of points in 3D space. Each point in a point cloud may comprise geometry information that may indicate the point's position in 3D space. For example, the geometry information may indicate the point's position in 3D space, for example, using three Cartesian coordinates (x, y, and z) and/or using spherical coordinates (r, phi, theta) (e.g., if acquired by a rotating sensor). The positions of points in a point cloud may be quantized according to a space precision. The space precision may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. A voxel may be referred to as a volumetric pixel. For example, similar to a pixel being the smallest unit in the example of dividing the 2D space (or 2D image) into discrete, uniform (e.g., equally sized) regions, a voxel may be the smallest unit of volume in the example of dividing 3D space into discrete, uniform regions. The sub-grid center coordinates may correspond to voxels. The sub-grid center coordinates may be referred to as a voxelized grid. A point in a point cloud may comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). A point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer. The object or scene may be generated from the capture of a real-world object or scene. The geometry information of a real-world object or a scene may be obtained by 3D scanning and/or photogrammetry. 3D scanning may include different types of scanning, for example, laser scanning, structured light scanning, and/or modulated light scanning. 3D scanning may obtain geometry information. 3D scanning may obtain geometry information, for example, by moving one or more laser heads, structured light cameras, and/or modulated light cameras relative to an object or scene being scanned. Photogrammetry may obtain geometry information. Photogrammetry may obtain geometry information, for example, by triangulating the same feature or point in different spatially shifted 2D photographs. Point cloud data may take the form of a point cloud frame. The point cloud frame may describe an object or scene captured at a particular time instance. Point cloud data may take the form of a sequence of point cloud frames. The sequence of point cloud frames may be referred to as a point cloud sequence or point cloud video. The sequence of point cloud frames may describe an object or scene captured at multiple different time instances.

The data size of a point cloud frame or point cloud sequence may be excessive (e.g., too large) for storage and/or transmission in many applications. For example, a single point cloud may comprise over a million points or even billions of points. Each point may comprise geometry information and one or more optional types of attribute information. The geometry information of each point may comprise three Cartesian coordinates (x, y, and z) and/or spherical coordinates (r, phi, theta) that may be each represented, for example, using at least 10 bits per component or 30 bits in total. The attribute information of each point may comprise a texture corresponding to a plurality of (e.g., three) color components (e.g., R, G, and B color components). Each color component may be represented, for example, using 8-10 bits per component or 24-30 bits in total. For example, a single point may comprise at least 54 bits of information, with at least 30 bits of geometry information and at least 24 bits of texture. If a point cloud frame includes a million such points, each point cloud frame may require 54 million bits or 54 megabits to represent. For dynamic point clouds that change over time, at a frame rate of 30 frames per second, a data rate of 1.62 gigabits per second may be required to send (e.g., transmit) the points of the point cloud sequence. Raw representations of point clouds may require a large amount of data, and the practical deployment of point-cloud-based technologies may need compression technologies that enable the storage and distribution of point clouds with a reasonable cost.

Encoding may be used to compress and/or reduce the data size of a point cloud frame or point cloud sequence to provide for more efficient storage and/or transmission. Decoding may be used to decompress a compressed point cloud frame or point cloud sequence for display and/or other forms of consumption (e.g., by a machine learning based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, for example, frameworks for medical applications or autonomous driving, may require lossless compression to avoid altering the results of a decision obtained, for example, based on the analysis of the sent (e.g., transmitted) and decompressed point cloud frame.

FIG. 1 shows an example point cloud coding (e.g., encoding and/or decoding) system 100. Point cloud coding system 100 may comprise a source device 102, a transmission medium 104, and a destination device 106. Source device 102 may encode a point cloud sequence 108 into a bitstream 110 for more efficient storage and/or transmission. Source device 102 may store and/or send (e.g., transmit) bitstream 110 to destination device 106 via transmission medium 104. Destination device 106 may decode bitstream 110 to display point cloud sequence 108 or for other forms of consumption (e.g., further analysis, storage, etc.). Destination device 106 may receive bitstream 110 from source device 102 via a storage medium or transmission medium 104. Source device 102 and destination device 106 may include any number of different devices. Source device 102 and destination device 106 may include, for example, a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, a vehicle (e.g., an autonomous vehicle), or a head-mounted display. A head-mounted display may allow a user to view a VR, AR, or MR scene and adjust the view of the scene, for example, based on movement of the user's head. A head-mounted display may be connected (e.g., tethered) to a processing device (e.g., a server, a desktop computer, a set-top box, or a video gaming console) or may be fully self-contained.

A source device 102 may comprise a point cloud source 112, an encoder 114, and an output interface 116. A source device 102 may comprise a point cloud source 112, an encoder 114, and an output interface 116, for example, to encode point cloud sequence 108 into a bitstream 110. Point cloud source 112 may provide (e.g., generate) point cloud sequence 108, for example, from a capture of a natural scene and/or a synthetically generated scene. A synthetically generated scene may be a scene comprising computer generated graphics. Point cloud source 112 may comprise one or more point cloud capture devices, a point cloud archive comprising previously captured natural scenes and/or synthetically generated scenes, a point cloud feed interface to receive captured natural scenes and/or synthetically generated scenes from a point cloud content provider, and/or a processor(s) to generate synthetic point cloud scenes. The point cloud capture devices may include, for example, one or more laser scanning devices, structured light scanning devices, modulated light scanning devices, and/or passive scanning devices.

Point cloud sequence 108 may comprise a series of point cloud frames 124 (e.g., an example shown in FIG. 1). A point cloud frame may describe an object or scene captured at a particular time instance. Point cloud sequence 108 may achieve the impression of motion by using a constant or variable time to successively present point cloud frames 124 of point cloud sequence 108. A point cloud frame may comprise a collection of points (e.g., voxels) 126 in 3D space. Each point 126 may comprise geometry information that may indicate the point's position in 3D space. The geometry information may indicate, for example, the point's position in 3D space using three Cartesian coordinates (x, y, and z). One or more of points 126 may comprise one or more types of attribute information. Attribute information may indicate a property of a point's visual appearance. For example, attribute information may indicate, for example, a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying), etc. One or more of points 126 may comprise, for example, light field data in the form of multiple view-dependent texture information. Light field data may be another type of optional attribute information. Color attribute information of one or more of points 126 may comprise a luminance value and two chrominance values. The luminance value may represent the brightness (e.g., luma component, Y) of the point. The chrominance values may respectively represent the blue and red components of the point (e.g., chroma components, Cb and Cr) separate from the brightness. Other color attribute values may be represented, for example, based on different color schemes (e.g., an RGB or monochrome color scheme).

Encoder 114 may encode point cloud sequence 108 into a bitstream 110. To encode point cloud sequence 108, encoder 114 may use one or more lossless or lossy compression techniques to reduce redundant information in point cloud sequence 108. To encode point cloud sequence 108, encoder 114 may use one or more prediction techniques to reduce redundant information in point cloud sequence 108. Redundant information is information that may be predicted at a decoder 120 and may not be needed to be sent (e.g., transmitted) to decoder 120 for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization. The G-PCC reference software encoder may perform voxelization, for example, by quantizing positions of points in a point cloud. Quantizing positions of points in a point cloud may create a grid in 3D space. The G-PCC reference software encoder may map the points to the center coordinates of the sub-grid volume (e.g., voxel) that their quantized locations reside in. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may use a transform tool, such as Region Adaptive Hierarchical Transform (RAHT), the Predicting Transform, and/or the Lifting Transform. The Lifting Transform may be built on top of the Predicting Transform. The Lifting Transform may include an extra update/lifting step. The Lifting Transform and the Predicting Transform may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104. The bitstream 110 may be sent (e.g., transmitted) to destination device 106. In addition or alternatively, output interface 116 may be configured to send (e.g., transmit), upload, and/or stream bitstream 110 to destination device 106 via transmission medium 104. Output interface 116 may comprise a wired and/or wireless transmitter configured to send (e.g., transmit), upload, and/or stream bitstream 110 according to one or more proprietary, open-source, and/or standardized communication protocols. The one or more proprietary, open-source, and/or standardized communication protocols may include, for example, Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the Internet) or file server(s) configured to store and/or send (e.g., transmit) encoded video data.

Destination device 106 may decode bitstream 110 into point cloud sequence 108 for display or other forms of consumption. Destination device 106 may comprise one or more of an input interface 118, a decoder 120, and/or a point cloud display 122. Input interface 118 may be configured to read bitstream 110 stored on transmission medium 104. Bitstream 110 may be stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary, open-source, standardized communication protocols, and/or any other communication protocol. Examples of the protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Decoder 120 may decode point cloud sequence 108 from encoded bitstream 110. For example, decoder 120 may operate in a same or similar manner as a decoder provided by G-PCC reference software. Decoder 120 may decode a point cloud sequence that approximates a point cloud sequence 108. Decoder 120 may decode a point cloud sequence that approximates a point cloud sequence 108 due to, for example, lossy compression of the point cloud sequence 108 by encoder 114 and/or errors introduced into encoded bitstream 110, for example, if transmission to destination device 106 occurs.

Point cloud display 122 may display a point cloud sequence 108 to a user. The point cloud display 122 may comprise, for example, a cathode rate tube (CRT) display, a liquid crystal display (LCD), a plasma display, a light emitting diode (LED) display, a 3D display, a holographic display, a head-mounted display, or any other display device suitable for displaying point cloud sequence 108.

Point cloud coding (e.g., encoding/decoding) system 100 is presented by way of example and not limitation. Point cloud coding systems different from the point cloud coding system 100 and/or modified versions of the point cloud coding system 100 may perform the methods and processes as described herein. For example, the point cloud coding system 100 may comprise other components and/or arrangements. Point cloud source 112 may, for example, be external to source device 102. Point cloud display device 122 may, for example, be external to destination device 106 or omitted altogether (e.g., if point cloud sequence 108 is intended for consumption by a machine and/or storage device). Source device 102 may further comprise, for example, a point cloud decoder. Destination device 106 may comprise, for example, a point cloud encoder. For example, source device 102 may be configured to further receive an encoded bit stream from destination device 106. Receiving an encoded bit stream from destination device 106 may support two-way point cloud transmission between the devices.

As described herein, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel or a volumetric pixel. A voxel may be considered as a 3D extension of pixels corresponding to 2D image grid coordinates.

An encoder may represent or code a point cloud (e.g., a voxelized). An encoder may represent or code a point cloud, for example, using an occupancy tree. For example, the encoder may split the initial volume or cuboid containing the point cloud into sub-cuboids. The initial volume or cuboid may be referred to as a bounding box. A cuboid may be, for example, a cube. The encoder may recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied sub-cuboid into, for example, two sub-cuboids (to form a binary tree), four sub-cuboids (to form a quadtree), or eight sub-cuboids (to form an octree). The encoder may split an occupied sub-cuboid to obtain further sub-cuboids. The sub-cuboids may have the same size and shape at a given depth level of the occupancy tree. The sub-cuboids may have the same size and shape at a given depth level of the occupancy tree, for example, if the encoder splits the occupied sub-cuboid along a plane passing through the middle of edges of the sub-cuboid.

The initial volume or cuboid containing the point cloud may correspond to the root node of the occupancy tree. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing the occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be each represented or indicated by a binary “1” in the 1-byte occupancy word. Unoccupied sub-cuboids may be each represented or indicated by a binary “0” in the 1-byte occupancy word. Occupied and un-occupied sub-cuboids may be represented or indicated by opposite 1-bit binary values (e.g., a binary “0” representing or indicating an occupied sub-cuboid and a binary “1” representing or indicating an unoccupied sub-cuboid) in the 1-byte occupancy word.

Each bit of an occupancy word may represent or indicate the occupancy of a different one of the eight sub-cuboids. Each bit of an occupancy word may represent or indicate the occupancy of a different one of the eight sub-cuboids, for example, following the so-called Morton order. For example, the least significant bit of an occupancy word may represent or indicate, for example, the occupancy of a first one of the eight sub-cuboids following the Morton order. The second least significant bit of an occupancy word may represent or indicate, for example, the occupancy of a second one of the eight sub-cuboids following the Morton order, etc.

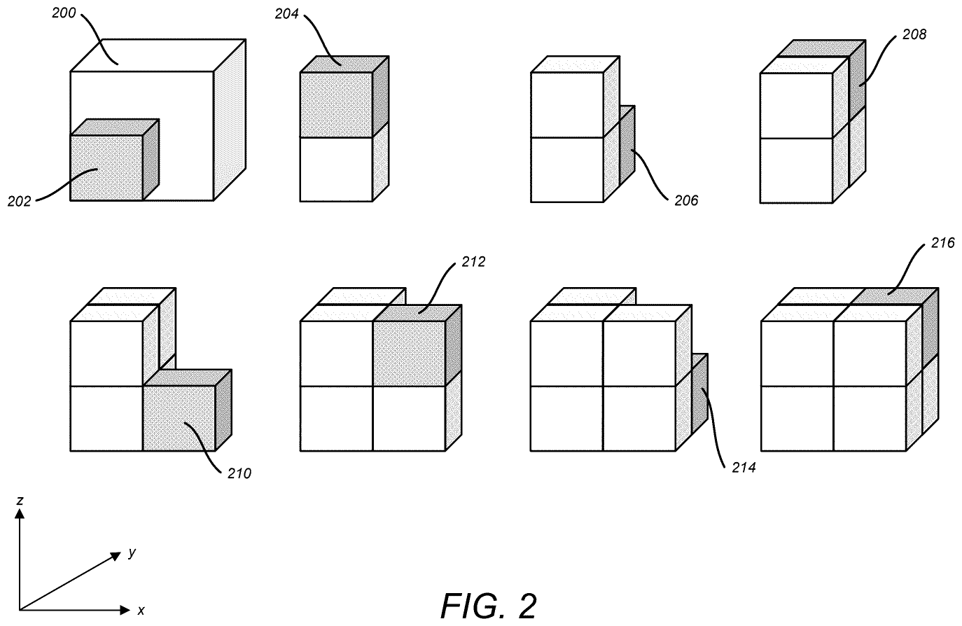

FIG. 2 shows an example Morton order. More specifically, FIG. 2 shows a Morton order of eight sub-cuboids 202-216 split from a cuboid 200. Sub-cuboids 202-216 may be labeled, for example, based on their Morton order, with child node 202 being the first in Morton order and child node 216 being the last in Morton order. The Morton order for sub-cuboids 202-216 may be a local lexicographic order in xyz.

The geometry of a point cloud may be represented by, and may be determined from, the initial volume and the occupancy words of the nodes in an occupancy tree. An encoder may send (e.g., transmit) the initial volume and the occupancy words of the nodes in the occupancy tree in a bitstream to a decoder for reconstructing the point cloud. The encoder may entropy encode the occupancy words. The encoder may entropy encode the occupancy words, for example, before sending (e.g., transmitting) the initial volume and the occupancy words of the nodes in the occupancy tree. The encoder may encode an occupancy bit of an occupancy word of a node corresponding to a cuboid. The encoder may encode an occupancy bit of an occupancy word of a node corresponding to a cuboid, for example, based on one or more occupancy bits of occupancy words of other nodes corresponding to cuboids that are adjacent or spatially close to the cuboid of the occupancy bit being encoded.

An encoder and/or a decoder may code (e.g., encode and/or decode) occupancy bits of occupancy words in sequence of a scan order. The scan order may also be referred to as a scanning order. For example, an encoder and/or a decoder may scan an occupancy tree in breadth-first order. All the occupancy words of the nodes of a given depth (e.g., level) within the occupancy tree may be scanned. All the occupancy words of the nodes of a given depth (e.g., level) within the occupancy tree may be scanned, for example, before scanning the occupancy words of the nodes of the next depth (e.g., level). Within a given depth, the encoder and/or decoder may scan the occupancy words of nodes in the Morton order. Within a given node, the encoder and/or decoder may scan the occupancy bits of the occupancy word of the node further in the Morton order.

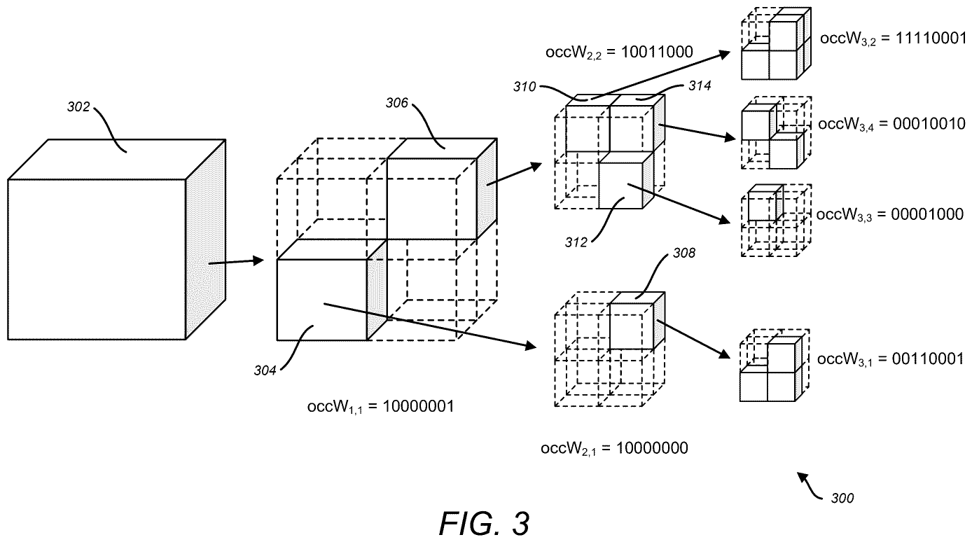

FIG. 3 shows an example scanning order. FIG. 3 shows an example scanning order (e.g., breadth-first order as described herein) for an occupancy tree 300. More specifically, FIG. 3 shows a scanning order for the first three example levels of an occupancy tree 300. A plurality of cuboids (e.g., cubes) may be generated, for example, at each level of the occupancy tree 300. In FIG. 3, a cuboid (e.g., cube) 302 corresponding to a root node of the occupancy tree 300 may be divided into eight sub-cuboids (e.g., sub-cubes). Two sub-cuboids 304 and 306 of the eight sub-cuboids may be occupied. The other six sub-cuboids of the eight sub-cuboids may be unoccupied. Following the Morton order, a first eight-bit occupancy word (e.g., occW_{1,1}) may be constructed to represent the occupancy word of the root node. An (e.g., each) occupancy bit of the first eight-bit occupancy word (e.g., occW_{1,1}) may represent or indicate the occupancy of a sub-cube of the eight sub-cuboids in the Morton order. For example, the least significant occupancy bit of the first eight-bit occupancy word occW_{1,1} may represent or indicate the occupancy of the first sub-cuboid of the eight sub-cuboids in the Morton order. The second least significant occupancy bit of the first eight-bit occupancy word occW_{1,1} may represent or indicate the occupancy of the second sub-cuboid of the eight sub-cuboids in the Morton order, etc.

Each of occupied sub-cuboids (e.g., two occupied sub-cuboids 304 and 306) may correspond to a node off the root node in a second level of an occupancy tree 300. The occupied sub-cuboids (e.g., two occupied sub-cuboids 304 and 306) may be each further split into eight sub-cuboids. For example, one of the sub-cuboids 308 of the eight sub-cuboids split from the sub-cube 304 may be occupied, and the other seven sub-cuboids may be unoccupied. Three of the sub-cuboids 310, 312, and 314 of the eight sub-cuboids split from the sub-cube 306 may be occupied, and the other five sub-cuboids of the eight sub-cuboids split from the sub-cube 306 may be unoccupied. Two second eight-bit occupancy words occW_{2,1} and occW_{2,2} may be constructed in this order to respectively represent the occupancy word of the node corresponding to the sub-cuboid 304 and the occupancy word of the node corresponding to the sub-cuboid 306.

Each of occupied sub-cuboids (e.g., four occupied sub-cuboids 308, 310, 312, and 314) may correspond to a node in a third level of an occupancy tree 300. The occupied sub-cuboids (e.g., four occupied sub-cuboids 308, 310, 312, and 314) may be each further split into eight sub-cuboids or 32 sub-cuboids in total. For example, four third level eight-bit occupancy words occW_{3,1}, occW_{3,2}, occW_{3,3} and occW_{3,4} may be constructed in this order to respectively represent the occupancy word of the node corresponding to the sub-cuboid 308, the occupancy word of the node corresponding to the sub-cuboid 310, the occupancy word of the node corresponding to the sub-cuboid 312, and the occupancy word of the node corresponding to the sub-cuboid 314.

Occupancy words of an example occupancy tree 300 may be entropy coded (e.g., entropy encoded by an encoder and/or entropy decoded by a decoder), for example, following the scanning order discussed herein (e.g., Morton order). The occupancy words of the example occupancy tree 300 may be entropy coded (e.g., entropy encoded by an encoder and/or entropy decoded by a decoder) as the succession of the seven occupancy words occW_{1,1} to occW_{3,4}, for example, following the scanning order discussed herein. The scanning order discussed herein may be a breadth-first scanning order. The occupancy word(s) of all node(s) having the same depth (or level) as a current parent node may have already been entropy coded, for example, if the occupancy word of a current child node belonging to the current parent node is being entropy coded. For example, the occupancy word(s) of all node(s) having the same depth (e.g., level) as the current child node and having a lower Morton order than the current child node may have also already been entropy coded. Part of the already coded occupancy word(s) may be used to entropy code the occupancy word of the current child node. The already coded occupancy word(s) of neighboring parent and child node(s) may be used, for example, to entropy code the occupancy word of the current child node. The occupancy bit(s) of the occupancy word having a lower Morton order than a particular occupancy bit may have also already been entropy coded and may be used to code the occupancy bit of the occupancy word of the current child node, for example, if the particular occupancy bit of the occupancy word of the current child node is being coded (e.g., entropy coded).

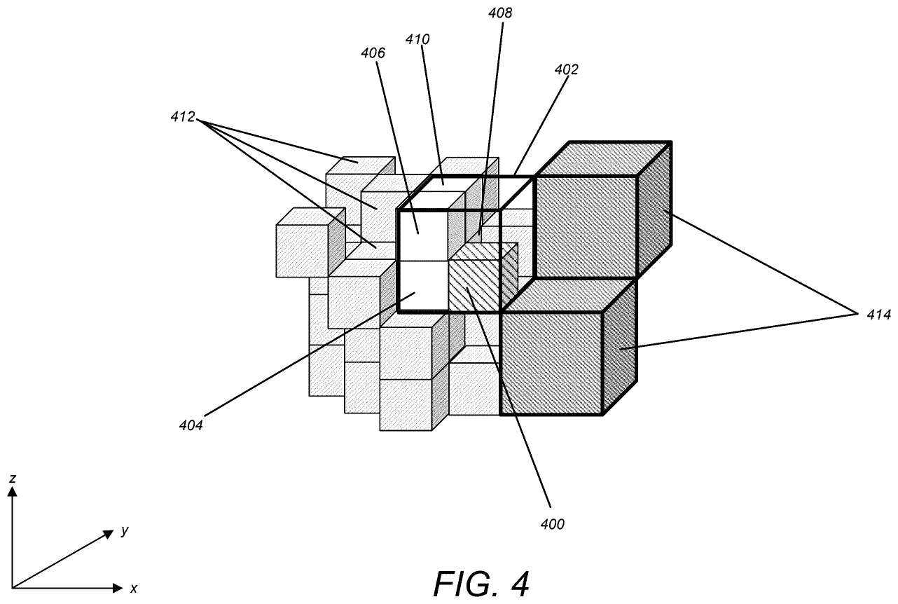

FIG. 4 shows an example neighborhood of cuboids for coding the occupancy of a child cuboid. More specifically, FIG. 4 shows an example neighborhood of cuboids with already-coded (e.g., previously-coded) occupancy bits. The neighborhood of cuboids with already-coded occupancy bits may be used to entropy code the occupancy bit of a current child cuboid 400. The neighborhood of cuboids with already-coded occupancy bits may be determined, for example, based on the scanning order of an occupancy tree representing the geometry of the cuboids in FIG. 4 as discussed herein. The neighborhood of cuboids, of a current child cuboid, may include one or more of: a cuboid adjacent to the current child cuboid, a cuboid sharing a vertex with the current child cuboid, a cuboid sharing an edge with the current child cuboid, a cuboid sharing a face with the current child cuboid, a parent cuboid adjacent to the current child cuboid, a parent cuboid sharing a vertex with the current child cuboid, a parent cuboid sharing an edge with the current child cuboid, a parent cuboid sharing a face with the current child cuboid, a parent cuboid adjacent to the current parent cuboid, a parent cuboid sharing a vertex with the current parent cuboid, a parent cuboid sharing an edge with the current parent cuboid, a parent cuboid sharing a face with the current parent cuboid, etc. As shown in FIG. 4, current child cuboid 400 may belong to a current parent cuboid 402. Following the scanning order of the occupancy words and occupancy bits of nodes of the occupancy tree, the occupancy bits of four child cuboids 404, 406, 408, and 410, belonging to the same current parent cuboid 402, may have already been coded. The occupancy bit of child cuboids 412 of preceding parent cuboids may have already been coded. The occupancy bits of parent cuboids 414, for which the occupancy bits of child cuboids have not already been coded, may have already been coded. The already-coded occupancy bits of cuboids 404, 406, 408, 410, 412, and 414 may be used to code the occupancy bit of the current child cuboid 400.

The number (e.g., quantity) of possible occupancy configurations (e.g., sets of one or more occupancy words and/or occupancy bits) for a neighborhood of a current child cuboid may be 2^{N}, where N is the number (e.g., quantity) of cuboids in the neighborhood of the current child cuboid with already-coded occupancy bits. The neighborhood of the current child cuboid may comprise several dozens of cuboids. The neighborhood of the current child cuboid (e.g., several dozens of cuboids) may comprise 26 adjacent parent cuboids sharing a face, an, edge, and/or a vertex with the parent cuboid of the current child cuboid and also several adjacent child cuboids having occupancy bits already coded sharing a face, an edge, or a vertex with the current child cuboid. The occupancy configuration for a neighborhood of the current child cuboid may have billions of possible occupancy configurations, even limited to a subset of the adjacent cuboids, making its direct use impractical. An encoder and/or decoder may use the occupancy configuration for a neighborhood of the current child cuboid to select the context (e.g., a probability model), among a set of contexts, of a binary entropy coder (e.g., binary arithmetic coder) that may code the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

An encoder and/or a decoder may use several methods to reduce the occupancy configurations for a neighborhood of a current child cuboid being coded to a practical number (e.g., quantity) of reduced occupancy configurations. The 2⁶ or 64 occupancy configurations of the six adjacent parent cuboids sharing a face with the parent cuboid of the current child cuboid may be reduced to 9 occupancy configurations. The occupancy configurations may be reduced by using geometry invariance. An occupancy score for the current child cuboid may be obtained from the 2²⁶ occupancy configurations of the 26 adjacent parent cuboids. The score may be further reduced into a ternary occupancy prediction (e.g., “predicted occupied,” “unsure”, or “predicted unoccupied”) by using score thresholds. The number (e.g., quantity) of occupied adjacent child cuboids and the number (e.g., quantity) of unoccupied adjacent child cuboids may be used instead of the individual occupancies of these child cuboids.

An encoder and/or a decoder using/employing one or more of the methods described herein may reduce the number (e.g., quantity) of possible occupancy configurations for a neighborhood of a current child cuboid to a more manageable number (e.g., a few thousands). It has been observed that instead of associating a reduced number (e.g., quantity) of contexts (e.g., probability models) directly to the reduced occupancy configurations, another mechanism may be used, namely Optimal Binary Coders with Update on the Fly (OBUF). An encoder and/or a decoder may implement OBUF to limit the number (e.g., quantity) of contexts to a lower number (e.g., 32 contexts).

OBUF may use a limited number (e.g., 32) of contexts (e.g., probability models). The number (e.g., quantity) of contexts in OBUF may be a fixed number (e.g., fixed quantity). The contexts used by OBUF may be ordered, referred to by a context index (e.g., a context index in the range of 0 to 31), and associated from a lowest virtual probability to a highest virtual probability to code a “1”. A Look-Up Table (LUT) of context indices may be initialized at the beginning of a point cloud coding process. For example, the LUT may initially point to a context (e.g., with a context index 15) with the median virtual probability to code a “1” for all input. The LUT may initially point to a context with the median virtual probability to code a “1”, among the limited number (e.g., quantity) of contexts, for all input. This LUT may take an occupancy configuration for a neighborhood of current child cuboid as input and output the context index associated with the occupancy configuration. The LUT may have as many entries as reduced occupancy configurations (e.g., around a few thousand entries). The coding of the occupancy bit of a current child cuboid may comprise steps including determining the reduced occupancy configuration of the current child node, obtaining a context index by using the reduced occupancy configuration as an entry to the LUT, coding the occupancy bit of the current child cuboid by using the context pointed to (or indicated) by the context index, and updating the LUT entry corresponding to the reduced occupancy configuration, for example, based on the value of the coded occupancy bit of the current child cuboid. The LUT entry may be decreased to a lower context index value, for example, if a binary “0” (e.g., indicating the current child cuboid is unoccupied) is coded. The LUT entry may be increased to a higher context index value, for example, if a binary “1” (e.g., indicating the current child cuboid is occupied) is coded. The update process of the context index may be, for example, based on a theoretical model of optimal distribution for virtual probabilities associated with the limited number (e.g., quantity) of contexts. This virtual probability may be fixed by a model and may be different from the internal probability of the context that may evolve, for example, if the coding of bits of data occurs. The evolution of the internal context may follow a well-known process similar to the process in CABAC.

An encoder and/or a decoder may implement a “dynamic OBUF” scheme. The “dynamic OBUF” scheme may enable an encoder and/or a decoder to handle a much larger number (e.g., quantity) of occupancy configurations for a neighborhood of a current child cuboid, for example, than general OBUF. The use of a larger number (e.g., quantity) of occupancy configurations for a neighborhood of a current child cuboid may lead to improved compression capabilities, and may maintain complexity within reasonable bounds. By using an occupancy tree compressed by OBUF, an encoder and/or a decoder may reach a lossless compression performance as good as 1 bit per point (bpp) for coding the geometry of dense point clouds. An encoder and/or a decoder may implement dynamic OBUF to potentially further reduce the bit rate by more than 25% to 0.7 bpp.

OBUF may not take as input a large variety of reduced occupancy configurations for a neighborhood of a current child cuboid, and may potentially cause a loss of useful correlation. With OBUF, the size of the LUT of context indices may be increased to handle more various occupancy configurations for a neighborhood of a current child cuboid as input. Due to such increase, statistics may be diluted, and compression performance may be worsened. For example, if the LUT has millions of entries and the point cloud has a hundred thousand points, then most of the entries may be never visited (e.g., looked up, accessed, etc.). Many entries may be visited only a few times and their associated context index may not be updated enough times to reflect any meaningful correlation between the occupancy configuration value and the probability of occupancy of the current child cuboid. Dynamic OBUF may be implemented to mitigate the dilution of statistics due to the increase of the number (e.g., quantity) of occupancy configurations for a neighborhood of a current child cuboid. This mitigation may be performed by a “dynamic reduction” of occupancy configurations in dynamic OBUF.

Dynamic OBUF may add an extra step of reduction of occupancy configurations for a neighborhood of a current child cuboid, for example, before using the LUT of context indices. This step may be called a dynamic reduction because it evolves, for example, based on the progress of the coding of the point cloud or, more precisely, based on already visited (e.g., looked up in the LUT) occupancy configurations.

As discussed herein, many possible occupancy configurations for a neighborhood of a current child cuboid may be potentially involved but only a subset may be visited if the coding of a point cloud occurs. This subset may characterize the type of the point cloud. For example, most of the visited occupancy configurations may exhibit occupied adjacent cuboids of a current child cuboid, for example, if AR or VR dense point clouds are being coded. On the other hand, most of the visited occupancy configurations may exhibit only a few occupied adjacent cuboids of a current child cuboid, for example, if sensor-acquired sparse point clouds are being coded. The role of the dynamic reduction may be to obtain a more precise correlation, for example, based on the most visited occupancy configuration while putting aside (e.g., reducing aggressively) other occupancy configurations that are much less visited. The dynamic reduction may be updated on-the-fly. The dynamic reduction may be updated on-the-fly, for example, after each visit (e.g., a lookup in the LUT) of an occupancy configuration, for example, if the coding of occupancy data occurs.

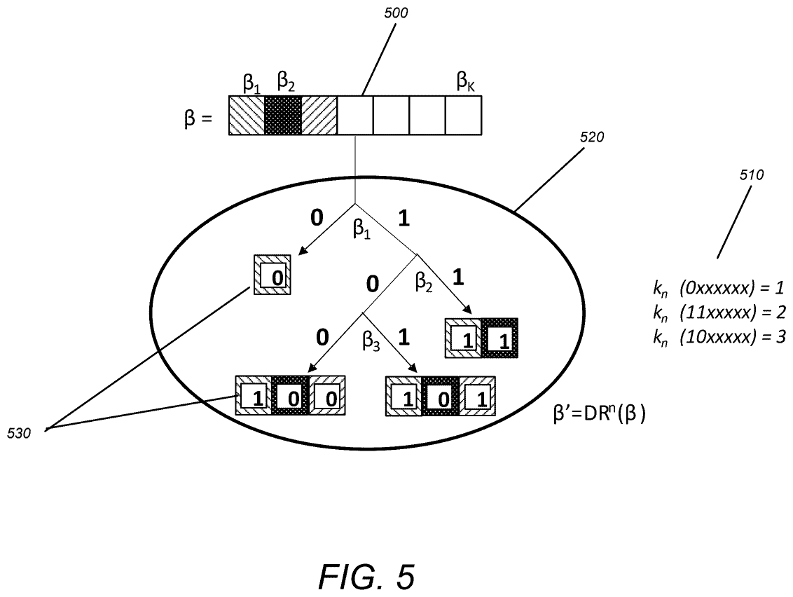

FIG. 5 shows an example of a dynamic reduction function DR that may be used in dynamic OBUF. The dynamic reduction function DR may be obtained by masking bits Rj of occupancy configurations 500:

$$β = {β}_{1} … {β}_{K}$$

made of K bits. The size of the mask may decrease, for example, if occupancy configurations are visited (e.g., looked up in the LUT) a certain number (e.g., quantity) of times. The initial dynamic reduction function DR⁰ may mask all bits for all occupancy configurations such that it is a constant function DR⁰(β)=0 for all occupancy configurations β. The dynamic reduction function may evolve from a function DRⁿ to an updated function DRⁿ⁺¹. The dynamic reduction function may evolve from a function DRⁿ to an updated function DRⁿ⁺¹, for example, after each coding of an occupancy bit. The function may be defined by:

$${β}^{′} = {DR}^{n} ( β ) = {β}_{1} … {β}_{k n ( β )}$$

where kₙ(β) 510 is the number (e.g., quantity) of non-masked bits. The initialization of DR⁰ may correspond to k₀(β)=0, and the natural evolution of the reduction function toward finer statistics may lead to an increasing number (e.g., quantity) of non-masked bits kₙ(β)≤kₙ₊₁(β). The dynamic reduction function may be entirely determined by the values of kₙ for all occupancy configurations β.

The visits (e.g., instances of a lookup in the LUT) to occupancy configurations may be tracked by a variable NV(β′) for all dynamically reduced occupancy configurations β′=DRⁿ(β). The corresponding number (e.g., quantity) of visits NV(β^{V′}) may be increased by one, for example, after each instance of coding of an occupancy bit based on an occupancy configuration β^{V}. If this number (e.g., quantity) of visits NV(β^{V′}) is greater than a threshold th_{V},

$$N V ( {β}^{{V}^{′}} ) > t {h}_{V}$$

then the number (e.g., quantity) of unmasked bits kₙ(β) may be increased by one for all occupancy configurations β being dynamically reduced to β^{V′}. This corresponds to replacing the dynamically reduced occupancy configuration β^{V′} by the two new dynamically reduced occupancy configurations β^{0′} and β^{1′} defined by

$${β}^{{0}^{′}} = {β}^{{V}^{′}} 0 = {β}_{1}^{V} … {β}_{kn ( β )}^{V} 0 and {β}^{{1}^{′}} = {β}^{{V}^{′}} 1 = {β}_{1}^{V} … {β}_{kn ( β )}^{V} 1.$$

In other words, the number (e.g., quantity) of unmasked bits has been increased by one kₙ₊₁(β)=kₙ(β)+1 for all occupancy configurations β such that DRⁿ (β)=β^{V′}. The number (e.g., quantity) of visits of the two new dynamically reduced occupancy configurations may be initialized to zero:

$$N V ( {β}^{{0}^{′}} ) = N V ( {β}^{{1}^{′}} ) = 0 \qquad ( I )$$

At the start of the coding, the initial number (e.g., quantity) of visits for the initial dynamic reduction function DR⁰ may be set to

$$N V ( D {R}^{0} ( β ) ) = N V ( 0 ) = 0 ,$$

and the evolution of NV on dynamically reduced occupancy configurations may be entirely defined.

The corresponding LUT entry LUT[β^{V′}] may be replaced by the two new entries LUT[β^{0′}] and LUT[β^{1′}] that are initialized by the coder index associated with β^{V′}. The corresponding LUT entry LUT[β^{V}] may be replaced by the two new entries LUT[β^{0′}] and LUT[β^{1′}] that are initialized by the coder index associated with β^{V′}, for example, if a dynamically reduced occupancy configuration β^{V′} is replaced by the two new dynamically reduced occupancy configurations β^{0′} and β^{1′}

$$L U T [ {β}^{{0}^{,}} ] = L U T [ {β}^{{1}^{,}} ] = L U T [ {β}^{{V}^{,}} ] , \qquad ( II )$$

and then evolve separately. The evolution of the LUT of coder indices on dynamically reduced occupancy configurations may be entirely defined.

The reduction function DRⁿ may be modeled by a series of growing binary trees Tⁿ 520 whose leaf nodes 530 are the reduced occupancy configurations β′=DRⁿ (β). The initial tree may be the single root node associated with 0=DR⁰(β). The replacement of the dynamically reduced to β^{V′} by β^{0′} and β^{1′} may correspond to growing the tree Tⁿ from the leaf node associated with β^{V′}, for example, by attaching to it two new nodes associated with β^{0′} and β^{1′}. The tree Tⁿ⁺¹ may be obtained by this growth. The number (e.g., quantity) of visits NV and the LUT of context indices may be defined on the leaf nodes and evolve with the growth of the tree through equations (I) and (II).

The practical implementation of dynamic OBUF may be made by the storage of the array NV[β′] and the LUT[β′] of context indices, as well as the trees Tⁿ 520. An alternative to the storage of the trees may be to store the array kₙ[β] 510 of the number (e.g., quantity) of non-masked bits.

A limitation for implementing dynamic OBUF may be its memory footprint. In some applications, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher (e.g., more significant) bits βᵢ (e.g., β₀, β₁, etc.) may be the first bits to be unmasked. Higher (e.g., more significant) bits βᵢ (e.g., β₀, β₁, etc.) may be the first bits to be unmasked, for example, during the evolution of the dynamic reduction function DR. The order of neighbor-based information put in the bits βᵢ may impact the compression performance. Neighboring information may be ordered from higher (e.g., highest) priority to lower priority and put in this order into the bits βᵢ, from higher to lower weight. The priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge (but not sharing a face) with the current child node. Adjacent nodes sharing an edge with the current child node may have higher priority than adjacent nodes sharing only a vertex with the current child node.

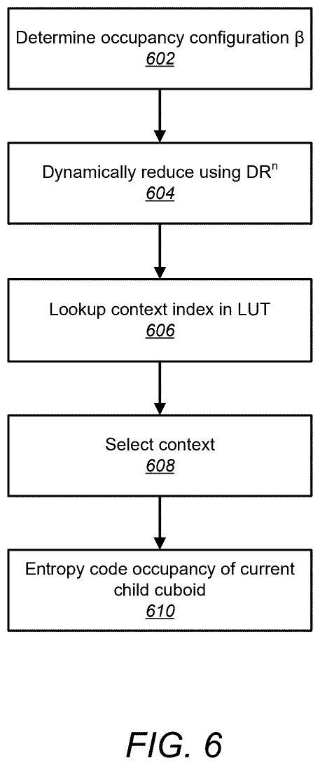

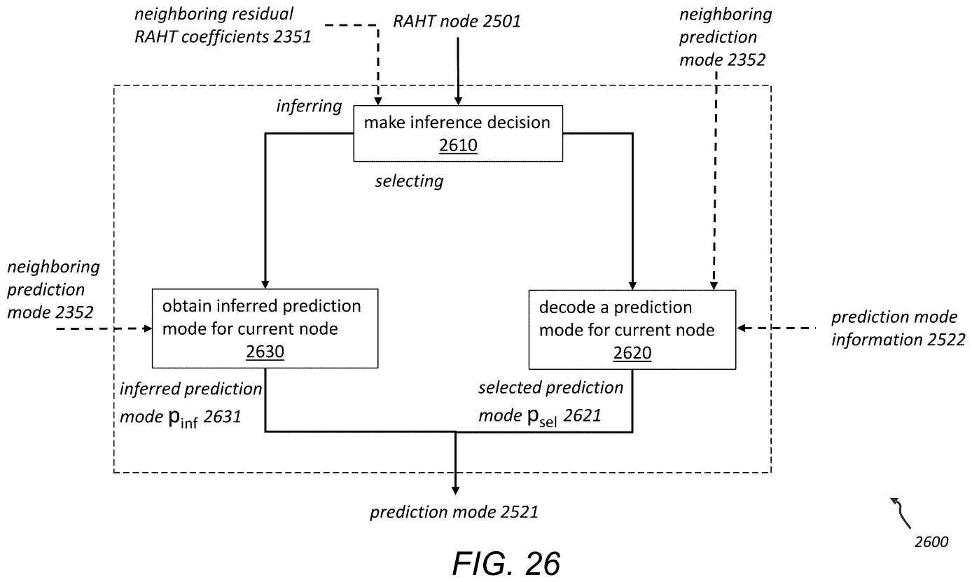

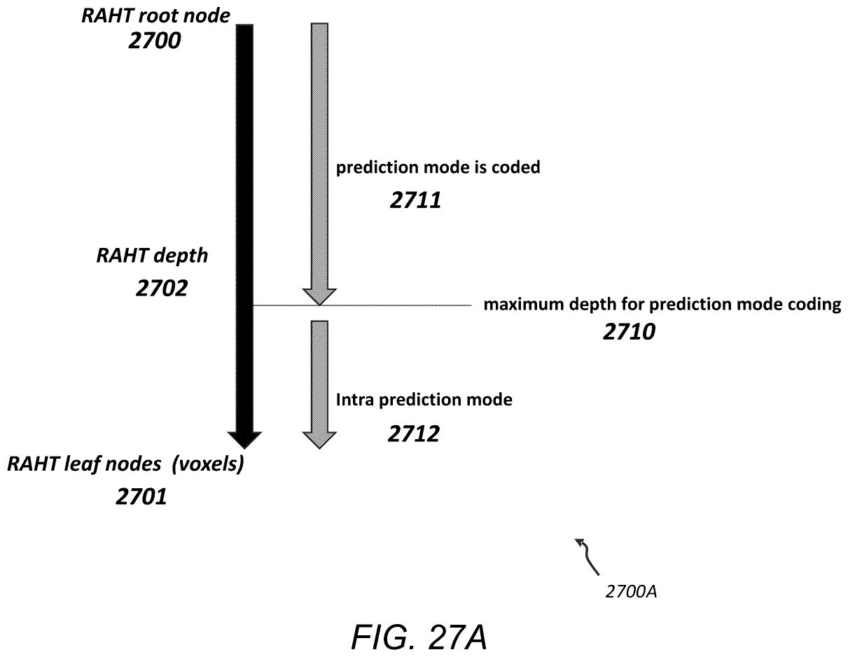

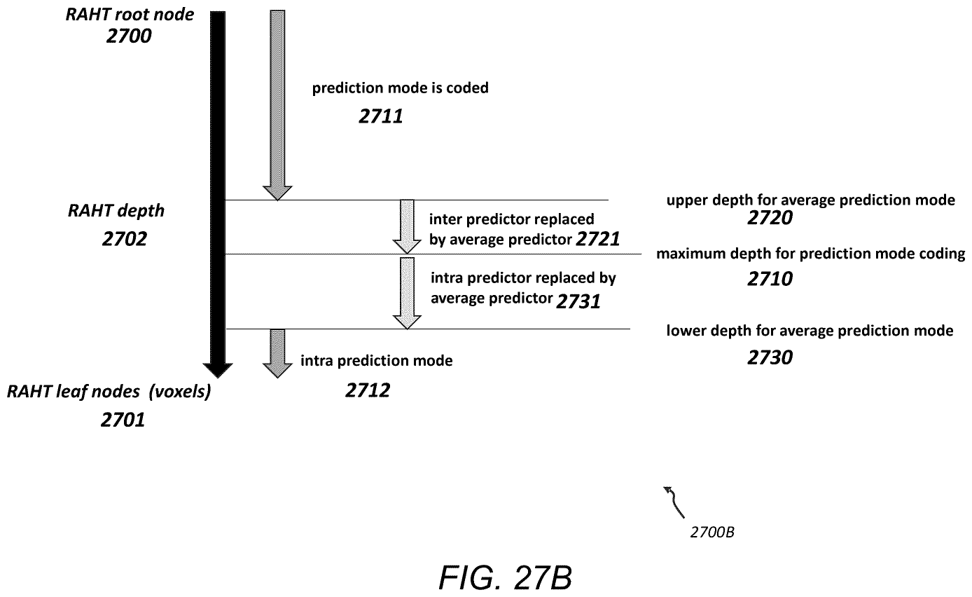

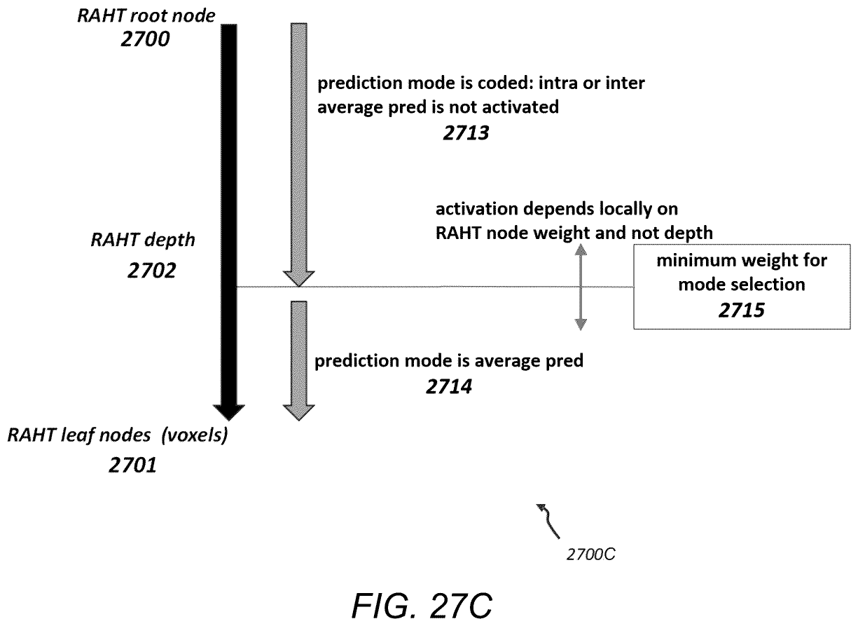

FIG. 6 shows an example method for coding occupancy of a cuboid using dynamic OBUF. More specifically, FIG. 6 shows an example method for coding occupancy bit of a current child cuboid using dynamic OBUF. One or more steps of FIG. 6 may be performed by an encoder and/or a decoder (e.g., the encoder 114 and/or decoder 120 in FIG. 1). All or portions of the flowchart may be implemented by a coder (e.g., the encoder 114 and/or decoder 120 in FIG. 1), an example computer system 2600 in FIG. 26, and/or an example computing device 2730 in FIG. 27.

At step 602, an occupancy configuration (e.g., occupancy configuration β) of the current child cuboid may be determined. The occupancy configuration (e.g., occupancy configuration β) of the current child cuboid may be determined, for example, based on occupancy bits of already-coded cuboids in a neighborhood of the current child cuboid. At step 604, the occupancy configuration (e.g., occupancy configuration β) may be dynamically reduced. The occupancy configuration may be dynamically reduced, for example, using a dynamic reduction function DRⁿ. For example, the occupancy configuration β may be dynamically reduced into a reduced occupancy configuration β′=DRⁿ (β). At step 606, context index may be looked up, for example, in a look-up table (LUT). For example, the encoder and/or decoder may look up context index LUT[β′] in the LUT of the dynamic OBUF. At step 608, context (e.g., probability model) may be selected. For example, the context (e.g., probability model) pointed to by the context index may be selected. At step 610, occupancy of the current child cuboid may be entropy coded. For example, the occupancy bit of the current child cuboid may be entropy coded (e.g., arithmetic coded), for example, based on the context. The occupancy bit of the current child cuboid may be coded based on the occupancy bits of the already-coded cuboids neighboring the current child cuboid.

Although not shown in FIG. 6, the encoder and/or decoder may update the reduction function and/or update the context index. For example, the encoder and/or decoder may update the reduction function DRⁿ into DRⁿ⁺¹ and/or update the context index LUT[β′], for example, based on the occupancy bit of the current child cuboid. The method of FIG. 6 may be repeated for additional or all child cuboids of parent cuboids corresponding to nodes of the occupancy tree in a scan order, such as the scan order discussed herein with respect to FIG. 3.

In general, the occupancy tree is a lossless compression technique. The occupancy tree may be adapted to provide lossy compression, for example, by modifying the point cloud on the encoder side (e.g., down-sampling, removing points, moving points, etc.). The performance of the lossy compression may be weak. The lossy compression may be a useful lossless compression technique for dense point clouds.

One approach to lossy compression for point cloud geometry may be to set the maximum depth of the occupancy tree to not reach the smallest volume size of one voxel but instead to stop at a bigger volume size (e.g., N×N×N cuboids (e.g., cubes), where N>1). The geometry of the points belonging to each occupied leaf node associated with the bigger volumes may then be modeled. This approach may be particularly suited for dense and smooth point clouds that may be locally modeled by smooth functions such as planes or polynomials. The coding cost may become the cost of the occupancy tree plus the cost of the local model in each of the occupied leaf nodes.

A scheme for modeling the geometry of the points belonging to each occupied leaf node associated with a volume size larger than one voxel may use sets of triangles as local models. The scheme may be referred to as the “TriSoup” scheme. TriSoup is short for “Triangle Soup” because the connectivity between triangles may not be part of the models. An occupied leaf node of an occupancy tree that corresponds to a cuboid with a volume greater than one voxel may be referred to as a Tri Soup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may comprise a position (pₖ) of the vertex (Vₖ) along the TriSoup edge.

In addition to the occupancy words of an occupancy tree, an encoder may entropy encode, for each TriSoup node of the occupancy tree, the TriSoup vertex presence flags and positions of each TriSoup edge belonging to TriSoup nodes of the occupancy tree. A decoder may similarly entropy decode the Tri Soup vertex presence flags and positions of each TriSoup edge and vertex along a respective TriSoup edge belonging to a TriSoup node of the occupancy tree, in addition to the occupancy words of the occupancy tree.

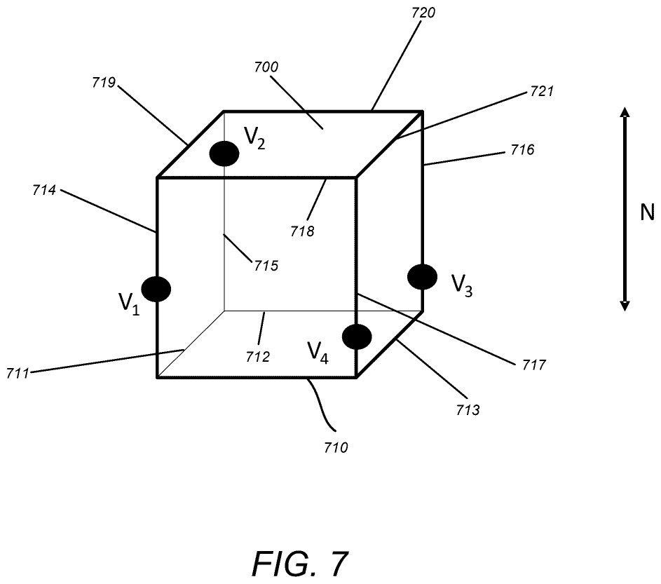

FIG. 7 shows an example of an occupied cuboid (e.g., cube) 700. More specifically, FIG. 7 shows an example of an occupied cuboid (e.g., cube) 700 of size N×N×N (where N>1) that corresponds to a TriSoup node of an occupancy tree. An occupied cuboid 700 may comprise edges (e.g., TriSoup edges 710-721). The TriSoup node, corresponding to the occupied cuboid 700, may comprise a presence flag (sₖ) for each edge (e.g., each TriSoup edge of the TriSoup edges 710-721). For example, the presence flag of a TriSoup edge 714 may indicate that a TriSoup vertex V₁ is present on the TriSoup edge 714. The presence flag of a TriSoup edge 715 may indicate that a TriSoup vertex V₂ is present on the TriSoup edge 715. The presence flag of a TriSoup edge 716 may indicate that a TriSoup vertex V₃ is present on the TriSoup edge 716. The presence flag of a TriSoup edge 717 may indicate that a TriSoup vertex V₄ is present on the TriSoup edge 717. The presence flags of the remaining TriSoup edges each may indicate that a TriSoup vertex is not present on their corresponding TriSoup edge. The TriSoup node, corresponding to the occupied cuboid 700, may comprise a position for each TriSoup vertex present along one of its TriSoup edges 710-721. More specifically, the TriSoup node, corresponding to the occupied cuboid 700, may comprise a position p₁ for TriSoup vertex V₁, a position p₂ for TriSoup vertex V₂, a position p₃ for TriSoup vertex V₃, and a position p₄ for TriSoup vertex V₄. The TriSoup vertices may be shared among TriSoup nodes along common TriSoup edge(s).

A presence flag (sₖ) and, if the presence flag (sₖ) may indicate the presence of a vertex, a position (pₖ) of a current TriSoup edge may be entropy coded. The presence flag (sₖ) and position (pₖ) may be individually or collectively referred to as vertex information or TriSoup vertex information. A presence flag (sₖ) and, if the presence flag (sₖ) indicates the presence of a vertex, a position (pₖ) of a current TriSoup edge may be entropy coded, for example, based on already-coded presence flags and positions, of present TriSoup vertices, of TriSoup edges that neighbor the current TriSoup edge. A presence flag (sₖ) and, if the presence flag (sₖ) may indicate the presence of a vertex, a position (pₖ) of a current TriSoup edge (e.g., indicating a position of the vertex the edge is along) may be additionally or alternatively entropy coded. The presence flag (sₖ) and the position (pₖ) of a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be obtained and dynamically reduced into a reduced configuration β_{TS}′=DRⁿ (β_{TS}), for example, by using a dynamic OBUF scheme for TriSoup. A context index LUT[β_{TS}] may be obtained from the OBUF LUT. At least a part of the vertex information of the current TriSoup edge may be entropy coded using the context (e.g., probability model) pointed to by the context index.

The Tri Soup vertex position (pₖ) (if present) along its TriSoup edge may be binarized. The TriSoup vertex position (pₖ) (if present) along its TriSoup edge may be binarized, for example, to use a binary entropy coder to entropy code at least part of the vertex information of the current TriSoup edge. A number (e.g., quantity) of bits N_{b} may be set for the quantization of the TriSoup vertex position (pₖ) along the TriSoup edge of length N. The TriSoup edge of length N may be uniformly divided into 2^{Nb} quantization intervals. By doing so, the TriSoup vertex position (pₖ) may be represented by N_{b} bits (pₖ^{j}=1, . . . , N_{b}) that may be individually coded by the dynamic OBUF scheme as well as the bit corresponding to the presence flag (sₖ). The neighborhood configuration β_{TS}, the OBUF reduction function DRⁿ, and the context index may depend on the nature, characteristic, and/or property of the coded bit (e.g., a presence flag (sₖ), a highest position bit (pₖ₁), a second highest position bit (pₖ₂), etc.) of the coded bit (e.g., presence flag (sₖ), highest position bit (pₖ¹), second highest position bit (pₖ²), etc.). There may practically be several dynamic OBUF schemes, each dedicated to a specific bit of information (e.g., presence flag (sₖ) or position bit (pₖ^{j})) of the vertex information.

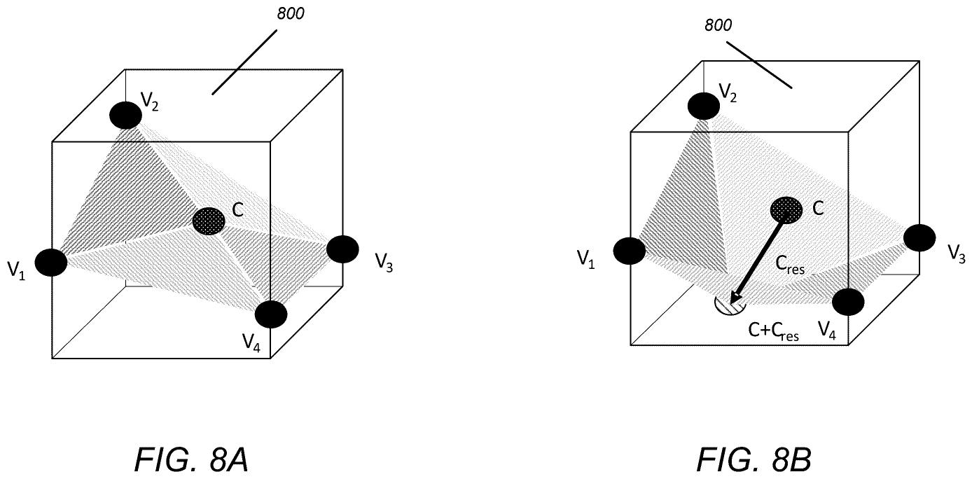

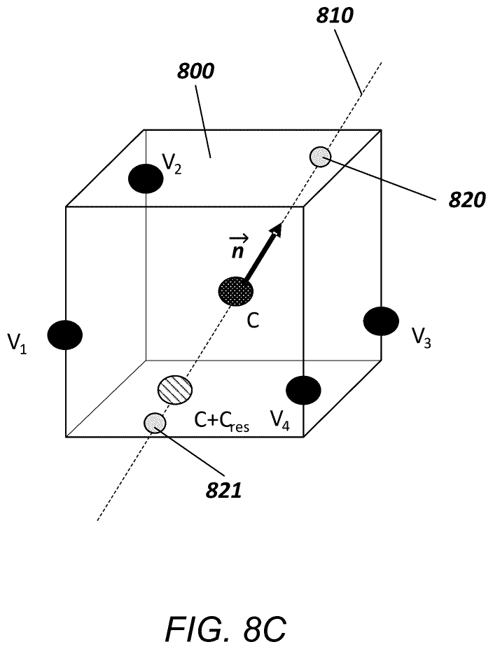

FIG. 8A shows an example cuboid 800 (e.g., a cube) corresponding to a TriSoup node. A cuboid 800 may correspond to a TriSoup node with a number K of TriSoup vertices Vₖ. Within cuboid 800, TriSoup triangles may be constructed from the TriSoup vertices Vₖ. TriSoup triangles may be constructed from the Tri Soup vertices Vₖ, for example, if at least three (K≥3) TriSoup vertices are present on the TriSoup edges of cuboid 800. For example, with respect to FIG. 8A, four TriSoup vertices may be present and TriSoup triangles may be constructed. The TriSoup triangles may be constructed around the centroid vertex C defined as the mean of the TriSoup vertices Vₖ. A dominant direction may be determined, then vertices Vₖ may be ordered by turning around this direction, and the following K TriSoup triangles (listed as triples of vertices) may be constructed: V₁V₂C, V₂V₃C, . . . , V_{K}V₁C. The dominant direction may be chosen among the three directions respectively parallel to the axes of the 3D space to increase or maximize the 2D surface of the triangles, for example, if the triangles are projected along the dominant direction. By doing so, the dominant direction may be somewhat perpendicular to a local surface defined by the points of the point cloud belonging to the TriSoup node.

FIG. 8B shows an example refinement to the TriSoup model. The TriSoup model may be refined by coding a centroid residual value. A centroid residual value Cᵣₑₛ may be coded into the bitstream. A centroid residual value Cᵣₑₛ may be coded into the bitstream, for example, to use C+Cᵣₑₛ instead of C as a pivoting vertex for the triangles. By using C+Cᵣₑₛ as the pivoting vertex for the triangles, the vertex C+Cᵣₑₛ may be closer to the points of the point cloud than the centroid C, the reconstruction error may be lowered, leading to lower distortion at the cost of a small increase in bitrate needed for coding Cᵣₑₛ.

FIG. 8C shows an example of encoding a centroid residual value. An encoder may encode, for example, a centroid residual value Cᵣₑₛ into a bitstream. An adjusted centroid C+Cᵣₑₛ may be used instead of the centroid C for generating TriSoup triangles of a cuboid 800 (corresponding to a TriSoup node), for example, corresponding to a portion of a point cloud. The triangles may be generated based on the adjusted centroid C+Cᵣₑₛ and adjacent pairs of vertices of an ordering of the vertices V₁-V₄ (e.g., as described in FIG. 8A). The TriSoup triangles of the cuboid 800 may be voxelized (e.g., at the decoder), for example, to generate voxels representing (or modeling) the portion, of the point cloud, corresponding to the cuboid 800. The adjusted centroid C+Cᵣₑₛ may be used instead of the centroid C, for example, as a pivoting vertex for the triangles. A unitary vector \vec{n} (e.g., also referred to as a unit vector or as a normalized vector) may be determined as a (normalized) mean and/or as a normalization of normal vectors to the triangles (V₁V₂C, V₂V₃C, . . . , V_{K}V₁C). The triangles (V₁V₂C, V₂V₃C, . . . , V_{K}V₁C) may be constructed by centroid C and pairs of the vertices of the cuboid 800, for example, by pivoting around the centroid C (e.g., as described in FIG. 8A). The unit vector \vec{n} may be the normalized vector of the following mean of cross-products (e.g., representing areas of the triangles): (\vec{V₁C}×\vec{V₂C}+\vec{V₃C}×\vec{V₃C}+ . . . +\vec{V_{K}C}×\vec{V₁C})/K. The unit vector n may be determined by dividing the mean vector (n) by the norm (or length) of the mean vector (i.e., \vec{n}=n/∥n∥).

A value resulting from each cross product is equal to an area of a parallelogram formed by the two vectors in the cross product. Therefore, the value may be representative of an area of a triangle formed by the two vectors because the area of the triangle is equal to half of the value. The unit vector n may be indicative of the direction normal to a local surface that is represented by the point cloud, for example, since the unit vector \vec{n} indicates a direction of the triangles (e.g., TriSoup triangles) representing (e.g., modeling) the portion of the point cloud. A one-component residual αᵣₑₛ along the line (C, \vec{n}) 810 may be coded (e.g., encoded) instead of a 3D centroid residual value Cᵣₑₛ, for example, to increase (e.g., maximize) the effect of the centroid residual value Cᵣₑₛ and/or to decrease (e.g., minimize) its coding cost. The 3D centroid residual value Cᵣₑₛ may be, for example, the one-component residual αᵣₑₛ multiplied by the unitary vector \vec{n} (e.g., Cᵣₑₛ=αᵣₑₛ\vec{n}).

The encoder may determine the residual value αᵣₑₛ. The encoder may determine the residual value of αᵣₑₛ, for example, as the intersection between the current point cloud and the line (C, \vec{n}), which is along the same direction of the normalized vector \vec{n}. A set of points, of the portion of the point cloud, closest (e.g., within a threshold distance and/or a threshold number of/quantity of points) to the line may be determined. The set of points may be projected on the line and the residual value αᵣₑₛ may be the mean component along the line of the projected points. The mean may be a weighted mean, for example, whose weights may depend on a distance of the set of points from the line. A point from the set closer to the line may, for example, have a higher weight than another point from the set farther from the line.

The residual value αᵣₑₛ may be quantized. The residual value αᵣₑₛ may be quantized, for example, by a uniform quantization function that may have a quantization step similar to the quantization precision of the TriSoup vertices Vₖ. The quantization error may be uniform over all vertices Vₖ and/or C+Cᵣₑₛ such that the local surface may be uniformly approximated.

The residual value αᵣₑₛ may be binarized and/or coded (e.g., entropy coded) into the bitstream. The residual value αᵣₑₛ may be binarized and/or coded (e.g., entropy coded) into the bitstream, for example, by using a typical unary-based (coding) scheme. The residual value αᵣₑₛ may be coded, for example, using a set of flags. A flag f₀ may be coded, for example, to indicate if the residual value αᵣₑₛ is equal to zero. If the flag f₀ indicates the residual value αᵣₑₛ is zero, no further syntax elements may be needed. If αᵣₑₛ is not equal to zero, a sign bit may be coded and/or the residual magnitude |αᵣₑₛ|−1 may be coded using an entropy code. The residual magnitude may be coded, for example, using a unary scheme that may code successive flags fᵢ(i≥1) indicating if the residual value magnitude |αᵣₑₛ| is equal to ‘i’. A binary entropy coder may binarize the residual value αᵣₑₛ into the flags fᵢ (i≥0). A binary entropy coder may entropy code the binarized residual value and/or the sign bit.

Compression of the residual value αᵣₑₛ may be improved. Compression of the residual value αᵣₑₛ may be improved, for example, by determining bounds as shown in FIG. 8C. The line (C, \vec{n}) 810 may intersect the current cuboid 800 (corresponding to a TriSoup node) at two bounding points 820 and 821. The encoder may ensure that the point C+Cᵣₑₛ (e.g., the adjusted centroid vertex) is located between the two bounding points 820 and 821. By ensuring that the point C+Cᵣₑₛ is located between the two bounding points 820 and 821, this implies bounds on the (quantized) residual value αᵣₑₛ such that the (quantized) residual value αᵣₑₛ may belong to an integral interval [m, M], where m≤0≤M. Some bits of the binarized residual value αᵣₑₛ may be inferred. Aᵣₑₛ may be necessarily equal to zero, for example, if m=M=0. The sign bit may be necessarily positive, for example, if m=0<M. The magnitude of the residual value |αᵣₑₛ| may be bounded by either |m| or M such that the magnitude may be coded by a truncated unary (coding) scheme that may infer the value of the last of successive flags fᵢ(i≥1), for example, if the residual value αᵣₑₛ is not equal to zero and its sign is known.

The coder (e.g., the binary entropy coder) used to code the binarized residual value αᵣₑₛ may be a context-adaptive binary arithmetic coder (CABAC). The probability model (or context or entropy coder) used to code at least one bit (fᵢ or sign bit) of the binarized residual value αᵣₑₛ may be updated, for example, depending on the value of the at least one bit (fᵢ or sign bit) of the binarized residual value αᵣₑₛ. The probability model of the coder (e.g., the binary entropy coder) may be determined, for example, based on contextual information. The contextual information may comprise the values of the bounds m and M, the location of vertices Vₖ, and/or the size of the TriSoup node (e.g., the cuboid 800). The selection of the coder (or the selection of the probability model of the coder) may be performed by a dynamic OBUF scheme that may use the contextual information described herein as entry (e.g., inputs).

The reconstruction of a decoded point cloud from a set of TriSoup triangles may be referred to as “voxelization” and may be performed, for example, by ray tracing or rasterization, for each triangle individually before duplicate voxels from the voxelized triangles are removed.

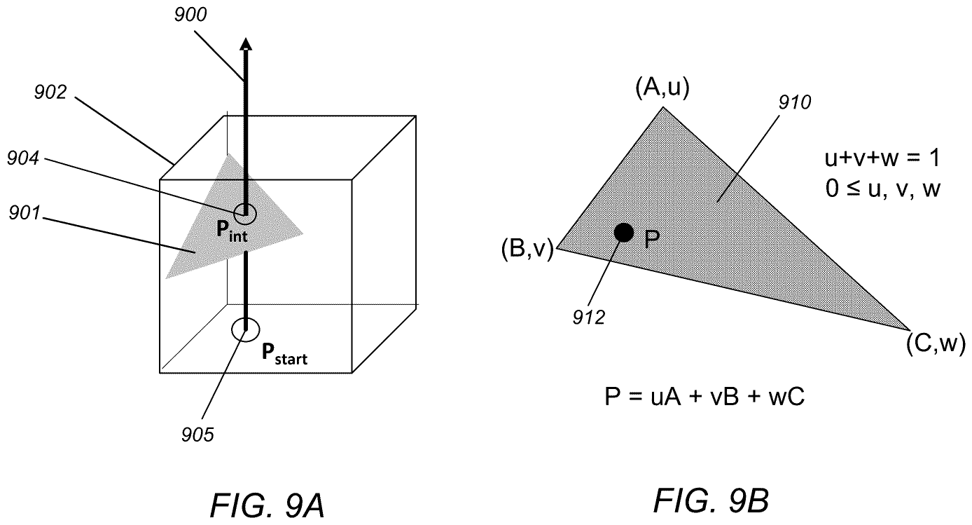

FIG. 9A shows an example of voxelization using ray tracing. Ray-triangle intersection algorithms, such as the Möller-Trumbore algorithm, may take advantage of launching rays, for example, to determine whether rays intersect with TriSoup triangles and if so, at what points of the TriSoup triangles. Rays may be launched from integral coordinates that correspond to the centers of voxels. As shown in FIG. 9A, rays, for example, ray 900 may be launched substantially parallel to one of the three coordinate axes of the 3D space, starting from integral coordinates (sometimes referred to as integer coordinates) such as an origin point 905 (shown as origin or starting point Pₛₜₐᵣₜ in FIG. 9A).

An intersection point 904 (shown as Pᵢₙₜ in FIG. 9A), if any, between ray 900 and a TriSoup triangle 901 belonging to a cube 902, corresponding to a TriSoup node, may be rounded (or, e.g., quantized) to obtain a decoded point corresponding to a voxel. A ray, for example, launched substantially parallel to a coordinate axis in 3D space, may intersect a TriSoup triangle. The ray may intersect the TriSoup triangle, for example, if and only if the projection, along the ray direction, of the center of a voxel belongs to the TriSoup triangle. In other words, the ray may be determined to intersect the TriSoup triangle if the point of intersection corresponds to the center of the voxel. This intersection may be determined, for example, by using a ray-triangle intersection algorithm (e.g., tracing or ray casting technique) such as the Möller-Trumbore algorithm to generate voxels representing the triangle.

Ray tracing techniques such as the Möller-Trumbore algorithm is based on generating, with respect to a triangle, barycentric coordinates of points of intersection between rays and a plane of the triangle. Then, points of the triangle may be determined from the barycentric coordinates.

FIG. 9B shows an example of voxelization using barycentric coordinates. More particularly, FIG. 9B shows an example of voxelization using barycentric coordinates (u, v, w) of a point 912 (P) relative to a TriSoup triangle 910 having vertices labeled A, B, and C in the 3D space. Point 912 may be determined as an intersection between a ray and a plane of TriSoup triangle 910 (e.g., containing or passing through the three vertices A, B, and C of TriSoup triangle 910). The ray may be launched, for example, substantially parallel to one of the three coordinate axes in 3D space. In some examples, this intersection point 912 may be uniquely represented as a sum of the three vertices of TriSoup triangle 910:

$$P = u A + v B + w C$$

under the condition u+v+w=1. Therefore, any point P of the plane (containing TriSoup triangle 910) has unique coordinates (u,v,w) in the barycentric coordinate system. A point with barycentric coordinates (u,v,w) may include an ordered triple of numbers u, v, and w. A point with barycentric coordinates (u,v,w) that sum to 1 (e.g., u+v+w=1) may be referred to as homogeneous barycentric coordinates and/or normalized barycentric coordinates. The barycentric coordinates of the intersection point with respect to TriSoup triangle 910 may be determined using algorithms, for example, the Möller-Trumbore algorithm.

By converting points with Cartesian coordinates in 3D space to homogeneous barycentric coordinates, the three vertices A, B, C of TriSoup triangle 910 may comprise respective barycentric coordinates A(1,0,0), B(0,1,0) and C(0,0,1). The convex hull (e.g., the TriSoup triangle 910) of the three vertices A, B, and C may be equal to the set of all points such that the barycentric coordinates u, v, and w is each greater than or equal to zero:

$$0 \leq u , v , w$$

Therefore, the intersection point may be determined to belong to TriSoup triangle 910, for example, based on the intersection point having barycentric coordinates with an ordered triple of values that are each greater than or equal to zero. Relatedly, if at least one of barycentric coordinates (i.e., one of u, v, or w) is negative or less than 0, then the intersection point may be determined to not belong to TriSoup triangle because it will be on the plane, but not on an edge or within the TriSoup triangle. A point determined to belong to TriSoup triangle 910 may be the ray intersecting TriSoup triangle 910 (e.g., within or at an edge of TriSoup triangle 910).

Attribute coding may comprise a process to code attributes of a current point cloud. The attributes may comprise, for example, attributes associated with the geometry of the current point cloud. Attribute coding may be performed (e.g., globally) on the decoded (e.g., reconstructed) geometry of a current point cloud. Global coding may induce high memory traffic and/or footprint as well as high computation complexity. A two-pass encoding/decoding process may be required in at least some applications. In the two-pass encoding/decoding process, encoding/decoding may be performed on the attributes, for example, after completion of geometry encoding/decoding. Such two-pass encoding/decoding may induce even higher memory traffic and/or footprint as well as overall latency, for example, before outputting geometry and attributes of a first point of the decoded point cloud.

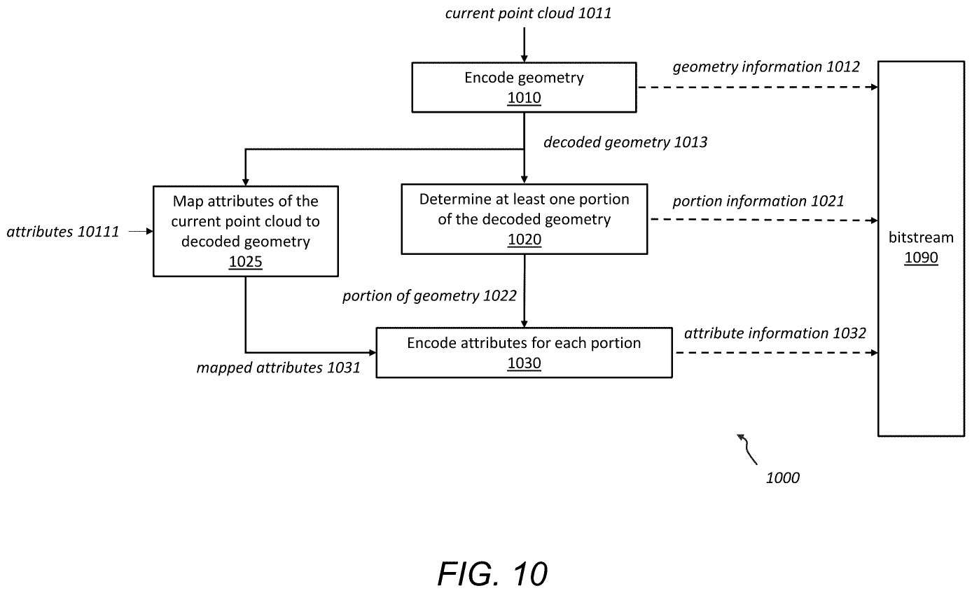

Local coding of attributes may be enabled. For example, Attribute Coding Units (ACU) has been introduced to enable local coding of attributes. ACU may be determined by dividing (e.g., segmenting) an overall decoded geometry (e.g., decoded geometry 1013 of FIG. 10) of a current point cloud (e.g., current point cloud 1011 of FIG. 10) into a set of ACUs. Each ACU may comprise (e.g., contain) a portion of geometry of the decoded geometry. The portion of geometry may indicate 3D positions in the 3D space of a subset of points of the decoded geometry (e.g., as decoded by a decoder or encoded and then decoded by an encoder). Points of the decoded geometry may refer to voxels, as described herein.

The attribute coding (e.g., encoding/decoding) may be localized to portions of the overall decoded geometry, and the attribute coding of each ACU (associated with each portion of geometry of the current point cloud) may be processed locally. Local attribute coding may bring advantages such as reduced memory traffic and footprint as well as computation complexity, for example, compared to global attribute coding.

Local attribute coding may be realized in various ways. For example, the geometry of the current point cloud may be restricted to a subset of nodes of the occupancy tree, and the restricted geometry and the associated attributes may be encoded/decoded locally by segmenting the restricted geometry into ACUs. For example, the 3D space encompassing a point cloud may be split into regions defined by subsets of nodes of the occupancy tree. The geometry of a (e.g., each) region of the 3D space may be encoded to obtain a part of the decoded geometry of the current point cloud, and this part may be segmented into a set of ACUs that are attribute encoded. For example, the geometry of a first region of the 3D space may be encoded to obtain a first part of the decoded geometry of the current point cloud. The first part may be segmented into a first set of ACUs that are attribute encoded. The geometry of a second region of the 3D space may be encoded to obtain a second part of the decoded geometry of the current point cloud. The second part may be segmented into a second set of ACUs that are attribute encoded. The memory footprint and traffic may be limited within a few regions, for example, due to neighborhood prediction between regions. The latency of point cloud codec may be reduced to the time needed for encoding geometry and attributes of a few regions. Smaller regions may lead to smaller memory footprint and traffic as well as shorter latency. The regions may be slices (also referred to as bricks) of a volume encompassing/containing the point cloud.

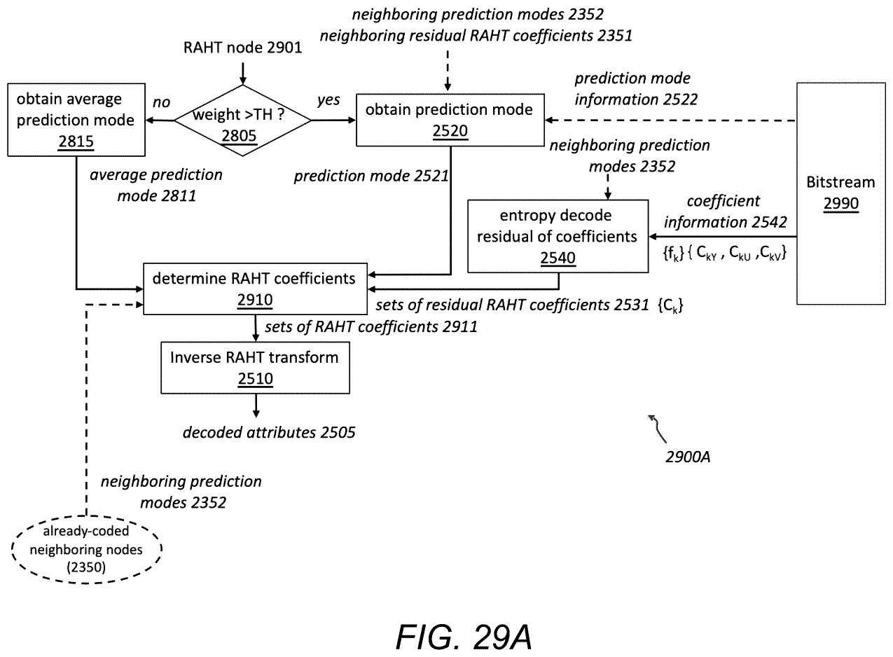

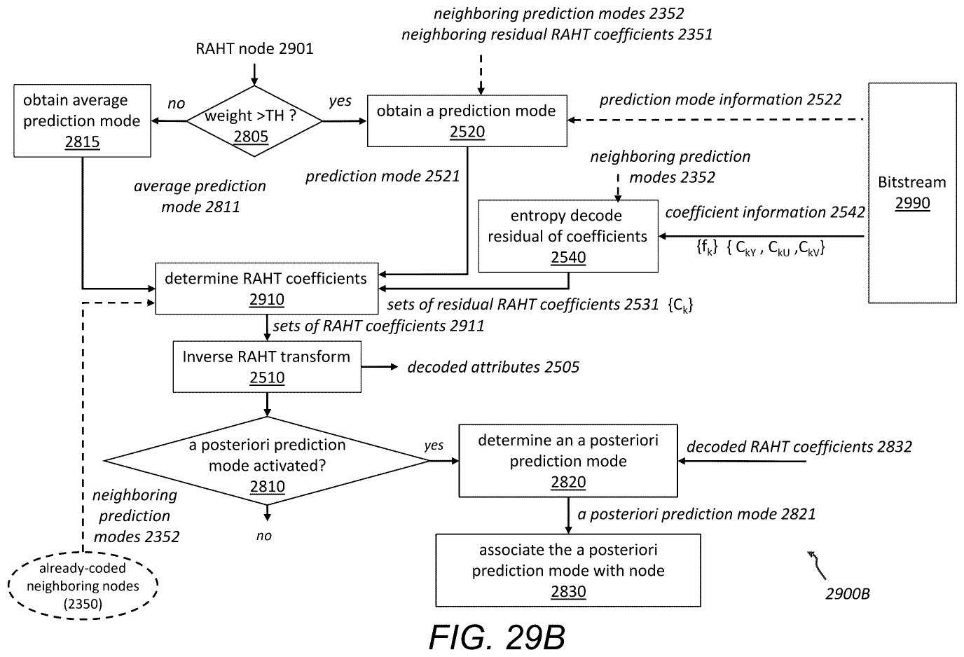

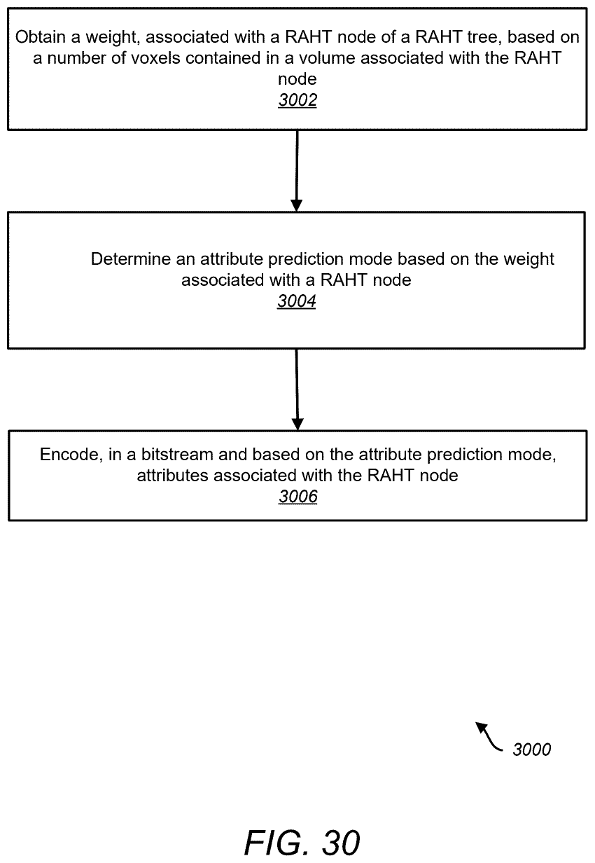

FIG. 10 shows an example method for encoding a point cloud. More specifically, FIG. 10 shows an example process 1000 of a method for encoding geometry and attributes of a current point cloud 1011. One or more steps of the example process 1000 may be performed and/or implemented by an encoder (e.g., encoder 114 of FIG. 1), an example computer system 2900 as described herein with respect to FIG. 29, and/or an example computing device 3030 as described herein with respect to FIG. 30. In some examples, steps 1010-1030 may represent components within the encoder. The current point cloud 1011 may be a point cloud frame of a sequence of point cloud frames of a dynamic point cloud.

At step 1010, an encoder may encode geometry. The encoder may encode geometry of the current point cloud. The encoder may encode geometry information 1012 representative of the geometry of the current point cloud 1011. The encoder may encode geometry information 1012 representative of the geometry of the current point cloud 1011, for example, into a bitstream 1090. The encoder may obtain a decoded (e.g., reconstructed) geometry 1013 of the point cloud 1011 as discussed herein.

At step 1020, the encoder may determine at least one portion (e.g., portion of geometry 1022) of the decoded geometry 1013. Each portion of geometry 1022 may comprise a subset of points of the decoded geometry 1013. For example, each portion of geometry 1022 may comprise positions (e.g., 3D positions) in the 3D space of the subset of points.

In some examples, the decoded geometry 1013 may be divided (e.g., segmented) into a set of ACUs, and each ACU of the set of ACUs may comprise a respective portion of geometry 1022 of the decoded geometry 1013.

The encoder may encode portion information 1021. The encoder may encode portion information 1021, for example, in the bitstream 1090. The portion information 1021 may be part of the attribute information 1032. The portion information 1021 may indicate segmentation selections of the decoded geometry 1013 into the set of ACUs. For example, the portion information 1021 may indicate how the decoded geometry 1013 is segmented into the set of ACUs.

Attributes of the current point cloud 1011 (e.g., attributes associated with the points of the current point cloud) may be coded. Attributes of the current point cloud 1011 may be coded, for example, after the coding (e.g., encoding and/or decoding) of the geometry (e.g., underlying geometry) has been performed. The encoder may have direct access to the attribute values associated with the decoded geometry. The encoder may have direct access to the attribute values associated with the decoded geometry, for example, if the geometry coding is a lossless coding. A lossless coding may be performed, for example, by using an octree scheme. The attributes associated with each point of the current point cloud may be the attributes associated with the corresponding point of the decoded geometry 1013.

The decoded geometry 1013 may differ from the geometry of the current point cloud. The decoded geometry 1013 may differ from the geometry of the current point cloud, for example, if the geometry coding is a lossy coding. A lossy coding may be performed, for example, by using a Tri Soup scheme. The attributes 10111 of the current point cloud 1011 may be mapped, by the encoder and from the geometry of the current point cloud 1011, to the decoded geometry 1013. The attributes 10111 of the current point cloud 1011 may be mapped to the decoded geometry 1013, for example, to determine mapped attributes 1031 associated with the decoded geometry 1013. For example, the mapped attributes 1031 may be assigned to each point of the decoded geometry 1013.

At step 1025, the encoder may map attributes of the current point cloud to decoded geometry. The encoder may determine mapped attributes 1031 of the decoded geometry 1013, for example, by mapping the attributes 10111 of the current point cloud 1011 to the decoded geometry 1013.

As discussed herein, attributes may indicate a property of a point's visual appearance such as texture, color, material, transparency, reflectance, time stamp, velocity, etc. For attributes that are colors, this attribute mapping performed by the encoder may be known as a recoloring process. The attribute mapping for attributes that are colors may be known as a recoloring process, for example, because the colors of the original geometry are used to color (e.g., recolor) the decoded geometry.

Mapped attributes may be determined based on various methods. In some examples, attributes may comprise colors and the mapped attributes may be determined based on recoloring the attributes. In some examples, mapped attributes may be determined based on a k nearest neighbor (KNN) search algorithm. The KNN search algorithm may use, for example, a space partitioning algorithm such as a k-dimensional (KD, or k-d) Tree search, a Ball/metric Tree search, brute force search, etc. The KNN search algorithm may be used, for example, to determine nearest points from the geometry of the current point cloud 1011 to the decoded geometry 1013. For example, a mapped attribute of a point of the decoded geometry 1013 may be the average attribute values associated with the nearest points of the current point cloud 1011 relative to the point of the decoded geometry 1013. In some examples, the decoded geometry 1013 may be the same as the geometry of the current point cloud 1011. The decoded geometry 1013 may be the same as the geometry of the current point cloud 1011, for example, if/when the geometry compression is lossless. In these examples, the attribute mapping may associate attributes of each point of the current point cloud 1011 to the same point of the decoded geometry 1013.

At step 1030, the encoder may encode attributes for each portion of geometry 1022. The encoder may encode the mapped attributes 1031 associated with each portion of geometry 1022, for example, in the bitstream 1090. The attributes of points associated with a portion of geometry 1022 may be encoded. The attributes of points associated with a portion of geometry 1022 may be encoded, for example, before encoding the attributes of points belonging to another portion of the decoded geometry 1013. Attribute encoding may be performed locally. The encoder may encode attribute information 1032 representing the encoded attributes.

Attributes associated with portions of the decoded geometry 1013 may be encoded based on a selected order. For example, attributes associated with portions of the decoded geometry 1013 may be encoded based on a scanning order. The encoder may distinguish between already encoded/decoded portions of the decoded geometry 1013 (e.g., portions of the decoded geometry 1013 whose attributes have been encoded/decoded) and other portions of the decoded geometry 1013 (e.g., portions of the decoded geometry 1013 whose attributes have not been encoded/decoded).

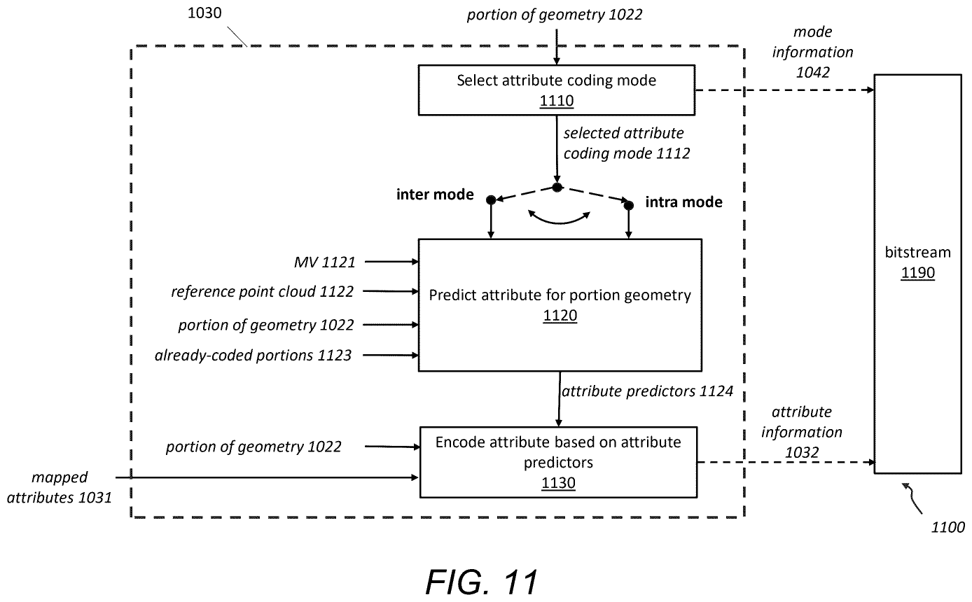

FIG. 11 shows an example method for encoding attributes. More specifically, FIG. 11 shows an example process 1100 of a method for encoding attributes associated with a portion of geometry 1022 of the decoded geometry 1013. One or more steps of the example process 1100 may be performed and/or implemented by an encoder (e.g., encoder 114 of FIG. 1), an example computer system 2900 as described herein with respect to FIG. 29, and/or an example computing device 3030 as described herein with respect to FIG. 30. In some examples, steps 1110-1130 may represent components within the encoder.

Process 1100 may comprise operations of step 1030 that may encode mapped attributes 1031 associated with the portion of geometry 1022 as attribute information 1032. The step 1030 may encode mapped attributes 1031 associated with the portion of geometry 1022 as attribute information 1032, for example, in a bitstream 1190.

At step 1110, an encoder may select an attribute coding mode. An encoder may select an attribute coding mode 1112 for encoding the attributes of the portion of geometry 1022.

The encoder may encode mode information 1042 that indicates the selected attribute coding mode 1112. The encoder may encode mode information 1042 that indicates the selected attribute coding mode 1112, for example, in the bitstream 1190. For example, the attribute information 1032 encoded in the bitstream 1190 may comprise the mode information 1042.

The selection step 1110 of the attribute coding mode 1112 may be performed in implementations of point cloud coding. In some implementations of point cloud coding, the selection step 1110 of the attribute coding mode 1112 by the process 1100 may be performed by a Rate-Distortion Optimization (RDO). In the RDO, the attribute coding mode 1112 may be selected as being a candidate attribute coding mode with a smallest cost (e.g., C_{mode}) from a list of candidate attribute coding modes. The cost (e.g., C_{mode}) of a candidate attribute coding mode may be determined (e.g., computed) as a Lagrange cost. The Lagrange cost may be a combination of a bitrate (e.g., R_{mode}) and a distortion (e.g., D_{mode}). The Lagrange cost may be determined, for example, based on C_{mode}=D_{mode}+λ*R_{mode}, where λ>0 and is a fixed Lagrange parameter. The bitrate (e.g., R_{mode}) may be obtained for a candidate attribute coding mode as being a sum of bitrates caused by coding both the mode information 1042 and the attribute information 1032 in the bitstream 1190. The distortion (e.g., D_{mode}) may be obtained for the candidate attribute coding mode by comparing the attributes associated with portion of geometry 1022 with decoded attributes associated with the decoded portion of geometry 1222. The distortion (e.g., D_{mode}) may be obtained based on the candidate attribute coding mode.

RDO may put a plurality of (e.g., many) candidate attribute coding modes in competition. The plurality of candidate attribute coding modes may (e.g., usually) include at least one inter-prediction-based attribute coding mode and at least one intra-prediction-based attribute coding mode. An inter-prediction-based attribute coding mode may be an attribute coding mode using attribute predictors obtained based on an inter-prediction mode. An intra-prediction-based attribute coding mode may be an attribute coding mode using attribute predictors obtained based on an intra-prediction mode.

At step 1120, the encoder may determine (e.g., predict) attribute(s) for portion of geometry. The encoder may determine attribute predictors 1124 of attributes associated with the portion of geometry 1022. For example, for each point of the portion of geometry 1022, one respective attribute predictor may be determined for predicting the attribute associated with that point.

At step 1120, the encoder may determine attribute predictors 1124 based on a selected attribute coding mode. For example, if/when an inter-prediction-based attribute coding mode is selected, the encoder may determine/obtain attribute predictors 1124 from an inter-prediction attribute parametric model. The inter-prediction attribute parametric model may be based on a Motion Vector (MV) field 1121, reference point cloud (e.g., for attributes, i.e., reference point cloud for attributes) 1122, and the portion of geometry 1022.

Parameters of the inter-prediction attribute parametric model may be determined/set based on (e.g., by) the selected attribute coding mode 1112. For example, if/when an intra-prediction-based attribute coding mode is selected, the encoder may determine attribute predictors 1124 from an intra-prediction attribute parametric model. The intra-prediction attribute parametric model may be based on at least one already-coded (e.g., already-decoded) portion 1123 of the decoded geometry 1013. Parameters of the intra-prediction attribute parametric model may be determined/set based on (e.g., by) the selected attribute coding mode 1112.

At step 1130, the encoder may encode attribute(s) based on attribute predictors. The encoder may encode the mapped attributes 1031 associated with the portion of geometry 1022 based on the attribute predictors 1124. The encoder may encode the mapped attributes 1031 associated with the portion of geometry 1022 as attribute information 1032, for example, in the bitstream 1190.

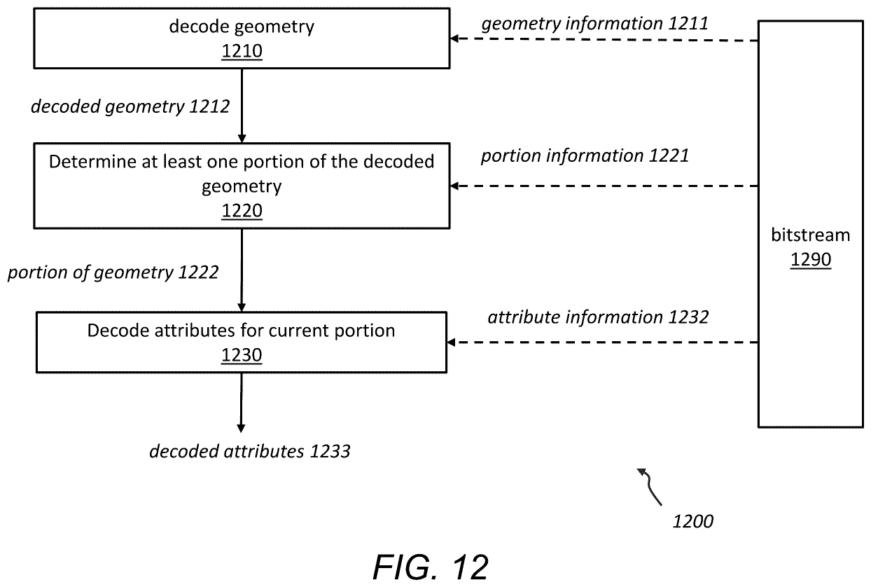

FIG. 12 shows an example method for decoding a point cloud. More specifically, FIG. 12 shows an example process 1200 of a method for decoding geometry and attributes of a current point cloud. One or more steps of the example process 1200 may be performed and/or implemented by a decoder (e.g., decoder 120 of FIG. 1), an example computer system 2900 as described herein with respect to FIG. 29, and/or an example computing device 3030 as described herein with respect to FIG. 30. In some examples, steps 1210-1230 may represent components within the decoder.

The decoded point cloud may be a point cloud frame of a sequence of point cloud frames of a dynamic point cloud. The decoded point cloud may comprise decoded geometry 1212 and decoded attributes 1233. Each decoded attribute 1233 may be associated with one point of the decoded geometry 1212.

At step 1210, a decoder may decode geometry. A decoder may obtain a decoded geometry 1212 by decoding geometry information 1211 from a bitstream 1290, as discussed herein.

For example, the bitstream 1290 may be generated by the encoding method of FIG. 10.

At step 1220, the decoder may determine at least one portion of the decoded geometry 1212. For example, the decoded geometry 1212 may be divided (e.g., segmented) into a set of ACUs. Each ACU of the set of ACUs may comprise a respective portion of geometry 1222 of the decoded geometry 1212. For example, the portion of geometry 1222 may comprise positions in the 3D space of a subset of points of the decoded geometry 1212.

The decoder may decode portion information 1221 from the bitstream 1290. The decoder may decode portion information 1221, for example, from (e.g., part of) attribute information 1232. The portion information 1221 may indicate segmentation selections of the decoded geometry 1212 into the set of ACUs. For example, the portion information 1221 may indicate how the decoded geometry 1212 is segmented into the set of ACUs.

At step 1230, the decoder may decode attributes for the current portion of geometry. The decoder may obtain decoded attributes 1233 associated with a (e.g., each) portion of geometry 1212. The decoder may obtain decoded attributes 1233 associated with a (e.g., each) portion of geometry 1212, for example, by decoding attribute information 1232. The attributes of points associated with a portion of geometry 1222 may be decoded. The attributes of points associated with a portion of geometry 1222 may be decoded, for example, before decoding the attributes of points belonging to another portion of the decoded geometry 1212.

Attributes associated with portions of the decoded geometry 1212 may be decoded based on a selected order. For example, attributes associated with portions of the decoded geometry 1212 may be decoded based on (or according to) a scanning order. The decoder may distinguish between already decoded portions of the decoded geometry 1212 (e.g., portions of the decoded geometry 1212 whose attributes have been decoded) and other portions of the decoded geometry 1212 (e.g., portions of the decoded geometry 1212 whose attributes have not been decoded).

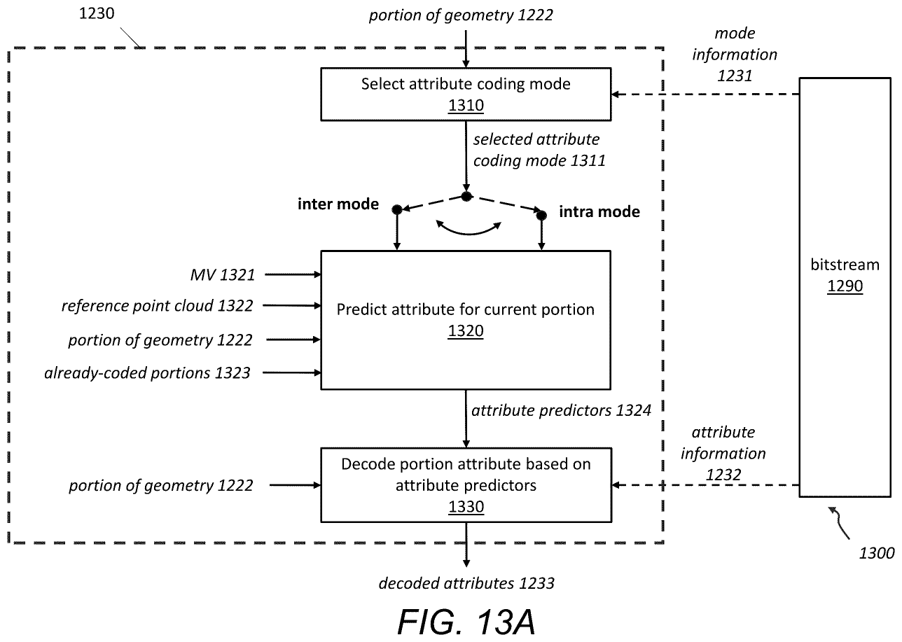

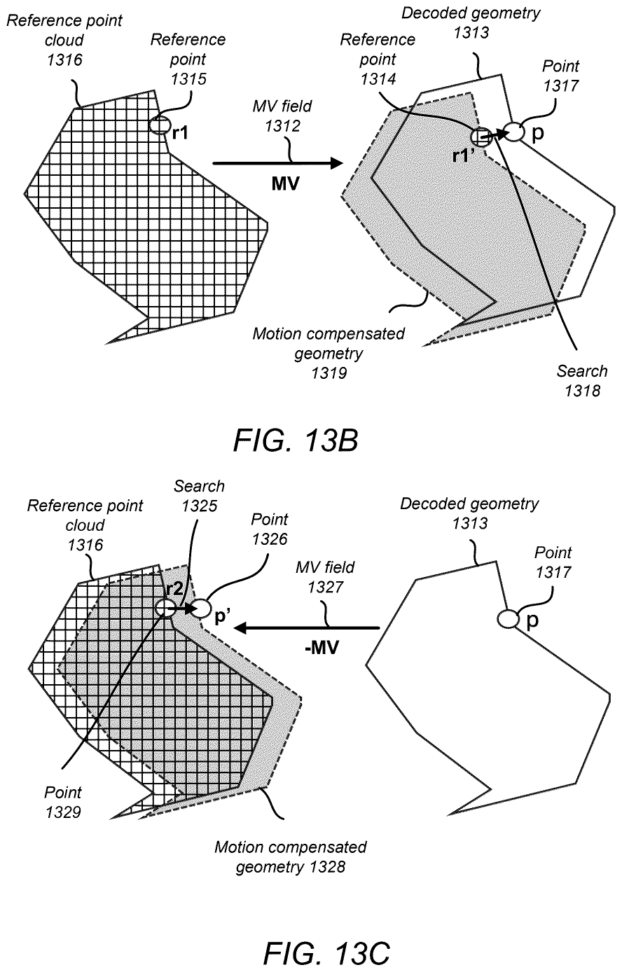

FIG. 13A shows an example method for decoding attributes. More specifically, FIG. 13A shows an example process 1300 of a method for decoding attributes associated with a portion of geometry 1222 of the decoded geometry 1212. One or more steps of the example process 1300 may be performed and/or implemented by a decoder (e.g., decoder 120 of FIG. 1), an example computer system 2900 as described herein with respect to FIG. 29, and/or an example computing device 3030 as described herein with respect to FIG. 30. In some examples, steps 1310-1330 may represent components within the decoder.

Process 1300 may comprise operations of step 1230 that may obtain decoded attributes 1233 associated with portion of geometry 1222. The step 1230 may obtain decoded attributes 1233 associated with portion of geometry 1222, for example, by decoding attribute information 1232 from the bitstream 1290.

At step 1310, a decoder may select an attribute coding mode. A decoder may select an attribute coding mode 1311 for decoding the attributes of the portion of geometry 1222.

The decoder may decode mode information 1231 that indicates the selected attribute coding mode 1311. The decoder may decode mode information 1231 that indicates the selected attribute coding mode 1311, for example, from the bitstream 1290. For example, the mode information 1231 may indicate either intra-prediction attribute coding mode or inter-prediction attribute coding mode.

At step 1320, the decoder may determine (e.g., predict) attribute(s) for current portion of geometry. The decoder may determine attribute predictors 1324 of attributes associated with the portion of geometry 1222. For example, for each point of the portion of geometry 1222, one respective attribute predictor is determined for predicting the attribute associated with that point.

At step 1320, the decoder may determine attribute predictors 1324 based on a selected attribute coding mode. For example, if/when an inter-prediction attribute coding mode is selected, the decoder may determine/obtain attribute predictors 1324 from an inter-prediction attribute parametric model. The inter-prediction attribute parametric model may be based on a Motion Vector (MV) field 1321, reference point cloud (e.g., for attributes) 1322, and the portion of geometry 1222. Parameters of the inter-prediction attribute parametric model may be determined/set based on (e.g., by) the selected attribute coding mode 1311. For example, FIGS. 13B and 13C described below show two examples of the inter-prediction attribute parametric model. The inter-prediction attribute parametric model may be applied to project (used for projecting) attributes of the reference point cloud (e.g., for attributes) 1322 onto the portion of geometry 1222 to determine attribute predictors 1324 for attributes of points/vertices of the portion of geometry 1222.

FIG. 13B shows an example of an inter-prediction attribute parametric model. More specifically, FIG. 13B shows an example of point-to-point projection distance between a point of the portion of (decoded) geometry 1313 and its nearest neighbor point of a motion compensated geometry 1319.

The motion compensated geometry 1319 may be obtained by motion compensation of the reference point cloud (e.g., for attributes) 1316. The motion compensated geometry 1319 may be obtained by motion compensation of the reference point cloud (e.g., for attributes) 1316, for example, based on MV field 1312. The reference point cloud (e.g., for attributes) 1316 may be the reference point cloud (e.g., for attributes) 1122, 1322. The portion of the geometry 1313 may be the portion of geometry 1022, 1222.

The MV field 1312 may comprise a set of motion vectors including a motion vector MV. The MV may be used to move (e.g., translate) reference point 1315 (r1) of the reference point cloud (e.g., for attributes) 1316 to a reference point 1314 (r1′) of the motion compensated geometry 1319. The nearest point of the motion compensated geometry 1319, in a neighborhood of the point 1317 of the portion of geometry 1313, may comprise reference point 1314. The nearest point (e.g., reference point 1314) may be selected in a search 1318. The nearest point (e.g., reference point 1314) may be selected in a search 1318, for example, by minimizing a point-to-point projection distance between each candidate point of the motion compensated geometry 1319 in the neighborhood of the point 1317, and the point 1317. Discontinuities of the motion compensated geometry 1319 may be introduced. Discontinuities of the motion compensated geometry 1319 may be introduced, for example, due to MV field 1312 which may not provide a granular translation of points. For example, MV field 1312 may include one MV applied to (e.g., used for) reference point cloud (e.g., for attribute) 1316. MV field 1312 may include an MV determined for a set of cuboids or per cuboid of reference point cloud (e.g., for attributes) 1316. The MV may not be determined per point of reference point cloud (e.g., for attributes) 1316 due to high complexity. As search 1318 may be performed on points of the motion compensated geometry 1319, the entirety of the motion compensated geometry 1319 may need to be generated and maintained, so that search 1318 for each point of the portion of geometry 1313 may be performed. For example, the entirety of the motion compensated geometry 1319 may need to be generated and maintained before search 1318 for each point of the portion of geometry 1313 may be performed.

A point-to-point projection distance may be determined (e.g., calculated) between a point of the portion of geometry 1313 and its nearest neighbor point of a motion compensated geometry 1319. A (e.g., each) point-to-point projection distance may be a difference between a point of the reference point cloud (e.g., for attributes) 1316 and its nearest neighbor point of a motion compensated geometry 1319. The motion compensated geometry 1319 may be obtained by performing motion compensation of the portion of the geometry 1313. The motion compensated geometry 1319 may be obtained by motion compensation of the decoded geometry of the current point cloud based on MV field.

FIG. 13C shows an example of an inter-prediction attribute parametric model. More specifically, FIG. 13C shows an example of point-to-point projection distance between a point 1329 of the reference point cloud (e.g., for attributes) 1316 and its nearest neighbor point of a motion compensated geometry 1328.

The motion compensated geometry 1328 may be obtained by motion compensation of the portion of geometry 1313. The motion compensated geometry 1328 may be obtained by motion compensation of the portion of geometry 1313, for example, based on MV field 1327. The MV field 1327 may comprise a motion vector −MV that is the inverse (e.g., having an opposite sign) of the MV field 1312. For example, point 1317 of the portion of geometry 1313 may be moved (e.g., translated) by a motion vector −MV of MV field 1327 to determine a motion-compensated position for point 1317. The motion-compensated position for point 1317 may be shown as point 1326 (p′) of the motion compensated geometry 1328. The nearest point of the motion compensated geometry 1328, in a neighborhood of the point 1329 of the reference point cloud (e.g., for attributes) 1316, may comprise point 1326. The nearest point (e.g., point 1326) may be selected in a search 1325.

The nearest point (e.g., point 1326) may be selected in a search 1325, for example, by minimizing a point-to-point projection distance between each candidate point of the motion compensated geometry 1328 in the neighborhood of the point 1329, and the point 1329 of the reference point cloud (e.g., for) attributes 1316.

The attribute projection quality may be determined. The attribute projection quality may be determined, for example, based on a comparison of the mapped attributes and the corresponding projected attributes. The attribute projection quality determining may be performed by the comparison of attributes expressed on a same geometry (e.g., the portion of the (decoded) geometry 1313), for example, to avoid any geometry discrepancy. The attribute projection quality may be based on differences between compared attributes. An attribute may be represented as a vector. An attribute difference may be determined (e.g., computed) as an attribute distance between vectors representing attributes that are compared. Attribute distance and attribute difference may be used interchangeably herein.

The attribute projection quality may be based on point-to-point attribute distances calculated for the set of points of the portion of geometry. The attribute projection quality may be an average or a maximum of the point-to-point attributes distances. A point-to-point attribute distance may be a difference between attributes associated with a point of the set of points of the portion of geometry and corresponding projected attributes associated with this point.

Returning to FIG. 13A, at step 1320, if/when an intra-prediction attribute mode is selected, the decoder may determine attribute predictors 1324 from an intra-prediction attribute parametric model. The intra-prediction attribute parametric model may be based on at least one already-coded (e.g., already-decoded) portion 1323 of the geometry 1222. Parameters of the intra-prediction attribute parametric model may be determined/set based on (e.g., by) the selected attribute coding mode 1311.

At step 1330, the decoder may decode portion attribute(s) based on attribute predictors. The decoder may decode attribute information 1232 from the bitstream 1290. The decoder may obtain the decoded attributes 1233 associated with the portion of geometry 1222. The decoder may obtain the decoded attributes 1233 associated with the portion of geometry 1222, for example, based on the decoded attribute information and the attributes predictors 1324.

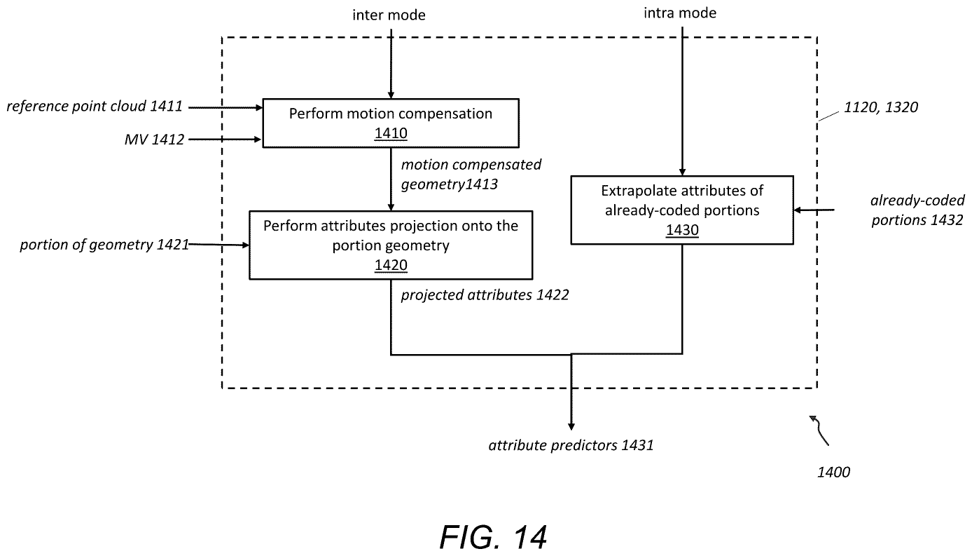

FIG. 14 shows an example method for determining attribute predictors. More specifically, FIG. 14 shows an example process 1400 of a method for determining attribute predictors 1431 of attributes associated with a portion of geometry 1421. One or more steps of the example process 1400 may be performed and/or implemented by a coder such as an encoder (e.g., encoder 114 of FIG. 1) or a decoder (e.g., decoder 120 of FIG. 1), an example computer system 2900 as described herein with respect to FIG. 29, and/or an example computing device 3030 as described herein with respect to FIG. 30. In some examples, steps 1410-1430 may represent components within the coder.

The process 1400 may be performed (e.g., identically) at both the encoder and the decoder. The process 1400 may be performed (e.g., identically) at both the encoder and the decoder, for example, to determine same attribute predictors 1431. The operations of FIG. 14 may be performed separately by the encoder and/or the decoder.

Steps 1410-1420 may relate to a process for determining inter-prediction-based attribute predictors. Step 1430 may relate to a process for determining intra-prediction-based attribute predictors.

The process for determining inter-prediction-based attribute predictors may correspond to step 1120 of FIG. 11 if/when the selected attribute coding mode 1112 may indicate an inter-prediction attribute mode (inter mode). The process for determining inter-prediction-based attribute predictors may correspond to step 1320 of FIG. 13A if/when the selected attribute coding mode 1112 may indicate an inter-prediction attribute mode (inter mode). The process for determining intra-prediction-based attribute predictors may correspond to step 1120 of FIG. 11 if/when the selected attribute coding mode 1112 may indicate an intra-prediction attribute mode (intra mode). The process for determining intra-prediction-based attribute predictors may correspond to step 1320 of FIG. 13A if/when the selected attribute coding mode 1112 may indicate an intra-prediction attribute mode (intra mode).

The portion of geometry 1421 may be the portion of geometry 1022 as described with respect to FIG. 10. The portion of geometry 1022 may be, for example, the portion of the decoded geometry 1013 as described with respect to FIG. 10. The attribute predictors 1431 may be the attribute predictors 1124 as described with respect to FIG. 11. The portion of geometry 1421 may be the portion of geometry 1222 of the decoded geometry 1212 as described with respect to FIG. 12. The attribute predictors 1431 may be the attribute predictors 1324 as described with respect to FIG. 13A. Reference point cloud (e.g., for attributes) 1411 may correspond to the reference point cloud (e.g., for attributes) 1122 as described with respect to FIG. 11 and the reference point cloud (e.g., for attributes) 1322 as described with respect to FIG. 13A.

Steps 1410-1420 may show operations of the process for determining inter-prediction-based attribute predictors. The process may obtain projected attributes 1422 (e.g., of the decoded geometry 1013, 1212). Part of projected attributes 1422 may be used as attribute predictors 1431 for attributes associated with points of portion of geometry 1421.

As explained herein with respect to FIG. 13B and FIG. 13C, the process for determining inter-prediction-based attribute predictors may include motion compensation of the geometry of the reference point cloud (e.g., for attributes) 1411 to generate a motion compensated geometry 1413. Reference point cloud for (e.g., attributes) 1411 may correspond to reference point cloud (e.g., for attributes) 1122 of FIG. 11 and/or to reference point cloud (e.g., for attributes) 1322 of FIG. 13A.

At step 1410, the coder (e.g., encoder/decoder) may perform motion compensation. The coder (e.g., encoder/decoder) may obtain the motion compensated geometry 1413 by performing motion compensation of the geometry of the reference point cloud (e.g., reference point cloud for attributes) 1411 based on MV field 1412. The MV field 1412 may correspond to MV field 1121 of FIG. 11 and MV field 1321 of FIG. 13A.

The encoder may obtain the MV field 1121. An encoder may obtain the MV field 1121, for example, by performing a motion search. An encoder may obtain the MV field 1121, for example, by performing a motion search such that the MV field 1121 may approximate the 3D motion field of attributes from the reference point cloud (e.g., for attributes) 1411 to the attributes of the current point cloud 1011. The motion search may (e.g., typically) be an iterative method that may test (or evaluate, assess, check, examine, inspect, analyze, etc.) (e.g., locally) multiple candidate motion vectors, and may select a candidate motion vector among the multiple candidate motion vectors. The selected candidate motion vector may minimize a distortion (e.g., cost) between the attributes of the current point cloud 1011 and attributes of the motion compensated geometry 1413 using the candidate motion vector.

The distortion, used by the motion search, for a point of the current point cloud 1011 may be determined. The distortion, used by the motion search, for a point of the current point cloud 1011 may be determined, for example, by comparing the attribute of this point and the attribute of (e.g., one of) its closest neighbor in the motion compensated geometry.

The encoder may encode information that indicates the reference point cloud (e.g., for attributes) 1411 among multiple candidate reference point clouds (e.g., for attributes). The encoder may encode the MV field 1121 as geometry information 1012. The decoder may obtain the reference point cloud (e.g., for attributes) 1411 and MV field 1321 by decoding geometry information 1211 and attribute information 1232 from the bitstream 1290.

At step 1420, the coder (e.g., encoder/decoder) may perform attribute(s) projection onto the portion geometry. The coder may determine projected attributes 1422. For example, the coder may determine projected attributes 1422 associated with the decoded geometry 1013, 1212 based on attributes of the reference point cloud (e.g., for attributes) 1411.

Projected attributes 1422 and attributes of the decoded geometry 1013, 1212 may belong to the same geometry. The prediction of the attributes of the portion of geometry 1022, 1222 based on the projected attributes may be much more efficient because the geometry discrepancy has been removed.

The encoder/decoder may generate (e.g., build or configure) an attribute projection model from a motion compensated geometry 1413. The attribute projection model may be used to perform attribute projection associated with the motion compensated geometry 1413.

For example, the motion compensated geometry 1413 may be obtained by performing motion compensation of the geometry of the reference point cloud (e.g., for attributes) 1411. The attribute projection may determine a projection of the motion compensated geometry 1413 onto the decoded geometry 1421. For example, the motion compensated geometry 1413 may be obtained by performing motion compensation of the decoded geometry 1421. The attribute projection may determine a projection of the motion compensated geometry 1413 onto the geometry of the reference point cloud (e.g., for attributes) 1411.

Since points of motion compensated geometry 1413 may represent motion compensated points of reference point cloud (e.g., for attributes) 1411 (or decoded geometry 1421), points of motion compensated geometry 1413 may correspond respectively to points of decoded geometry 1421 (or reference point cloud (e.g., for attributes) 1411, respectively). The result of the attribute projection process at step 1420 may be a form of projection of attributes of reference point cloud (e.g., for attributes) 1411 (e.g., after using/applying MV field 1412) onto decoded geometry 1013, 1212.

The attribute projection model may be a data structure used to (e.g., efficiently) perform attribute projection onto a specific position of a point. For example, the data structure may be a spatial-partitioning data structure such as a tree data structure (e.g., a KD tree or an octree). The data structure may be used to search for a set of one or more points (e.g., Nₚₜₛ) belonging to the motion compensated geometry 1413. The set of one or more points (e.g., Nₚₜₛ) may be with positions in the neighborhood of a particular point (e.g., point p) from the decoded geometry 1421. The set of one or more points (e.g., Nₚₜₛ) may be with positions in the neighborhood of a particular point (e.g., point p) from reference point cloud (e.g., for attributes) 1411. The set of one or more points (e.g., Nₚₜₛ) may be determined to be within the neighborhood for a particular point (e.g., point p) based on distances of the set of one or more points (e.g., Nₚₜₛ) from the point (e.g., point p) being within or less than a threshold value. The threshold value may be a predetermined value. The threshold value may be determined (e.g., computed) by the encoder and/or signaled to the decoder in the bitstream. The set of one or more points (e.g., Nₚₜₛ) may be determined as a number (or quantity) of points with positions that are closest to the point (e.g., point p). The number may be a predetermined quantity. The number may be determined (e.g., computed) by the encoder and/or signaled to the decoder in the bitstream. The distance may be a distance such as a Manhattan distance (i.e., L1 norm), an Euclidean distance (i.e., L2 norm), Chebyshev distance (i.e., L-infinity or L∞ norm), or a Minkowski distance.

The attributes values associated with each point within the set of one or more points (e.g., Nₚₜₛ) may be used at step 1420 for determining projected attributes values for the point (e.g., point p). For example, the projected attributes values may be attribute predictors of attributes for the point (e.g., point p). A value of each attribute of the point (e.g., point p) may be predicted or projected based on values of corresponding attributes (with the same type as each attribute) of the set of one or more points (e.g., Nₚₜₛ).

A projected attribute (e.g., attribute predictor) for the point (e.g., point p) may be determined. A projected attribute (e.g., attribute predictor) for the point (e.g., point p) may be determined, for example, as an average of the attribute values, of the set of one or more points (e.g., Nₚₜₛ), weighted by respective distance between the one or more points (e.g., Nₚₜₛ) and the point (e.g., point p). The distance may be a distance such as a Manhattan distance (i.e., L1 norm), an Euclidean distance (i.e., L2 norm), Chebyshev distance (i.e., L-infinity or L∞ norm), or a Minkowski distance.

The projected attributes representing the attribute predictors for the point (e.g., point p) may be determined to be the corresponding values of the attributes of a point from the motion compensated geometry 1413 closest to the point (e.g., point p). This may enable faster projection because only one point is searched and selected from motion compensated geometry 1413 to determine an attributes predictor for the point (e.g., point p) from decoded geometry 1013, 1212.

At step 1430, the coder (e.g., encoder/decoder) may extrapolate attributes of already-coded portions. The coder may determine attribute predictors 1431 for the portion of geometry 1022, 1222. The coder may determine attribute predictors 1431 for the portion of geometry 1022, 1222, for example, based on intra-prediction attribute mode using at least one already-coded portion 1432. The already-coded portions 1432 may be the already-coded portions 1123 of FIG. 11 or the already-coded portions 1323 of FIG. 13A.

The coder (e.g., encoder/decoder) may generate (e.g., determine) the intra-prediction attribute mode based on the intra prediction mode (e.g., selected attribute coding mode 1112, 1311). For example, the attribute predictors 1431 may be obtained by extrapolating at least one attribute associated with at least one already-coded portions 1432. For example, the intra prediction mode (e.g., selected attribute coding mode 1112, 1311) may indicate that the at least one already-coded portion 1432 may comprise at least one spatial neighbor portion of the portion of geometry 1421. In some examples, the portion of geometry 1421 may be encompassed by a current ACU. The spatial neighbor portion of the portion of geometry 1421 may comprise points encompassed by an ACU having a part of its boundary overlapping with at least a portion of a boundary of the current ACU. Boundary may be defined as faces, edges and vertices of a cuboid, for example, if/when ACUs are cuboids in shape. Sharing a part of the boundary may be defined as having a common face, a common edge, or a common vertex (e.g., corner).

The intra prediction mode (e.g., selected attribute coding mode 1112, 1311) may indicate that the attribute predictors 1431 may be obtained based on extrapolation of at least one attribute associated with the at least one spatial neighbor portion of the portion of geometry 1421. Extrapolation of at least one attribute associated with the at least one spatial neighbor portion of the portion of geometry 1421 may be determined. Extrapolation of at least one attribute associated with the at least one spatial neighbor portion of the portion of geometry 1421 may be determined, for example, by fitting a 3D attribute model for the at least one attribute associated with the at least one spatial neighbor portion of the portion of geometry 1421, and by extending (e.g., extrapolating) the fitted 3D attribute model to the portion of geometry 1421. A 3D attribute model may take spatial coordinates as input and provide modeled attributes as output. Model parameters may be fit (e.g., learned) on at least one attribute associated with the at least one spatial neighbor portion of the portion of geometry 1421.

The intra prediction mode (e.g., selected attribute coding mode 1112, 1311) may have various indications. In some examples, the intra prediction mode (e.g., selected attribute coding mode 1112, 1311) may indicate that attribute predictors 1431 may be determined based on averages of attributes associated with the spatial neighbor portion of the portion of geometry 1421. In some examples, the intra prediction mode (e.g., selected attribute coding mode 1112, 1311) may indicate that attribute predictors 1431 may be determined based on a maximum of attributes associated with the spatial neighbor portion of the portion of geometry 1421. In some examples, the intra prediction mode (e.g., selected attribute coding mode 1112, 1311) may indicate a spatial direction. The spatial neighbor portion of the portion of geometry 1421 may be selected along the spatial direction. In some examples, the intra prediction mode (e.g., selected attribute coding mode 1112, 1311) may indicate that a maximum number/quantity of spatial neighbor portions of the portion of geometry 1421 may be selected. In some examples, the intra prediction mode (e.g., selected attribute coding mode 1112, 1311) may indicate a maximum distance between the spatial neighbor portion of the portion of geometry 1421 and the portion of geometry 1421. For example, the maximum distance may be between any point of the geometry 1421 and any other point of the portion of geometry 1421. For example, the maximum distance may be between centers (or opposite corners) of the spatial neighbor portion of the portion of geometry 1421 and the portion of geometry 1421. In some examples, the intra prediction mode (e.g., selected attribute coding mode 1112, 1311) may indicate an index of/to a list of indices, each index indicating one of the intra-prediction attribute modes or one of their combinations as described herein.

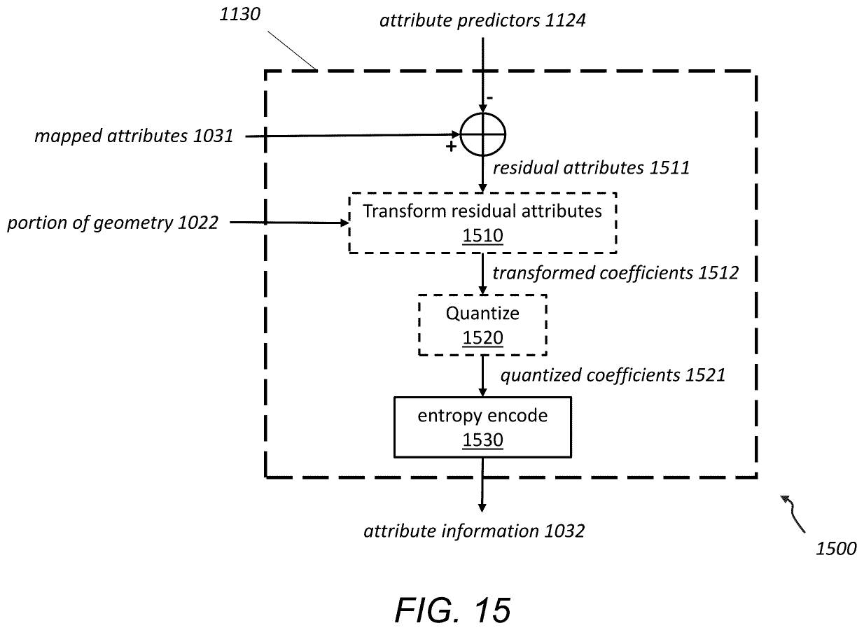

FIG. 15 shows an example method for encoding attributes based on attribute predictors. More specifically, FIG. 15 shows an example process 1500 of a method for encoding attributes based on attribute predictors 1124 associated with portion of geometry 1022. One or more steps of the example process 1500 may be performed and/or implemented by an encoder (e.g., encoder 114 of FIG. 1), an example computer system 2900 as described herein with respect to FIG. 29, and/or an example computing device 3030 as described herein with respect to FIG. 30. In some examples, steps 1510-1530 may represent components within the encoder.

The encoder may determine residual attributes 1511. The encoder may determine residual attributes 1511, for example, by subtracting the attribute predictors 1124 from the mapped attributes 1031 associated with portion of geometry 1022.

At step 1510, the encoder may transform residual attributes. The encoder may determine transformed coefficients 1512. The encoder may determine transformed coefficients 1512, for example, by using/applying a 3D transform (e.g., RAHT transform, Haar transform) for/to the residual attributes 1511 based on portion of geometry 1022.

At step 1520, the encoder may perform quantizing. The encoder may determine quantized residual attributes or quantized coefficients 1521. The encoder may determine quantized residual attributes or quantized coefficients 1521, for example, by quantizing the residual attributes 1511 or the transformed coefficients 1512, respectively.

At step 1530, the encoder may perform entropy encoding. The encoder may entropy encode the residual attributes 1511 or the transformed coefficients 1512 or the quantized residual attributes or the quantized coefficients 1521 as attribute information 1032.

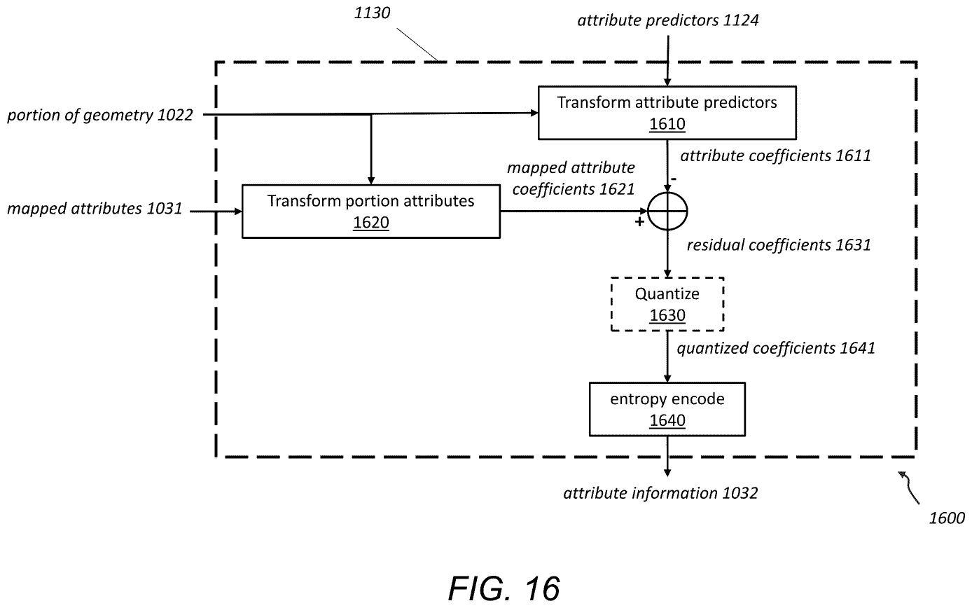

FIG. 16 shows an example method for encoding attributes based on attribute predictors. More specifically, FIG. 16 shows another example process 1600 of a method for encoding attributes based on attribute predictors 1124 associated with portion of geometry 1022. One or more steps of the example process 1600 may be performed and/or implemented by an encoder (e.g., encoder 114 of FIG. 1), an example computer system 2900 as described herein with respect to FIG. 29, and/or an example computing device 3030 as described herein with respect to FIG. 30. In some examples, steps 1610-1640 may represent components within the encoder.

At step 1610, the encoder may transform attribute predictors. The encoder may determine attribute coefficients 1611. The encoder may determine attribute coefficients 1611, for example, by applying/using a 3D transform to/for the attribute predictors 1124 based on portion of geometry 1022.

At step 1620, the encoder may transform portion attributes. The encoder may determine mapped attribute coefficients 1621. The encoder may determine mapped attribute coefficients 1621, for example, by applying/using 3D transform to/for the mapped attributes 1031 based on portion of geometry 1022.

The encoder may determine residual coefficients 1631. The encoder may determine residual coefficients 1631, for example, by subtracting the attribute coefficients 1611 from the mapped attribute coefficients 1621.

At step 1630, the encoder may perform quantizing. The encoder may determine quantized coefficients 1641. The encoder may determine quantized coefficients 1641, for example, by quantizing the residual coefficients 1631.

At step 1640, the encoder may perform entropy encoding. The encoder may entropy encode the residual coefficients 1631 or the quantized coefficients 1641 as attribute information 1032.

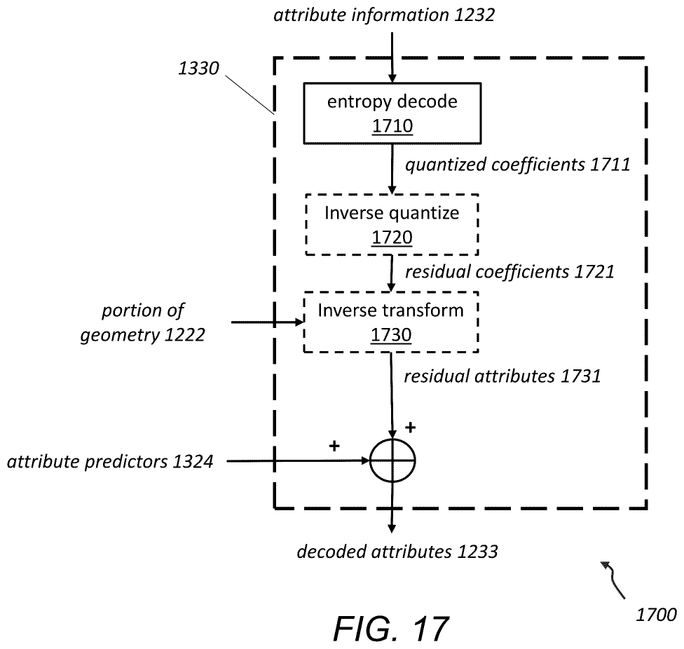

FIG. 17 shows an example method for decoding attributes based on attribute predictors.

More specifically, FIG. 17 shows an example process 1700 of a method for decoding attributes based on attribute predictors 1324 associated with portion of geometry 1222. One or more steps of the example process 1700 (e.g., corresponding to step 1330 of FIG. 13A) may be performed and/or implemented by a decoder (e.g., decoder 120 of FIG. 1), an example computer system 2900 as described herein with respect to FIG. 29, and/or an example computing device 3030 as described herein with respect to FIG. 30. In some examples, steps 1710-1730 may represent components within the decoder.

At step 1710, the decoder may perform entropy decoding. The decoder may entropy decode quantized coefficients 1711 from attribute information 1232. The decoder may entropy decode quantized coefficients 1711, for example, from the bitstream 1290.

At step 1720, the decoder may perform inverse quantizing. The decoder may determine residual coefficients 1721. The decoder may determine residual coefficients 1721, for example, by inverse quantizing the quantized coefficients 1711. In some examples, the decoder may entropy decode residual coefficients 1721 from the bitstream 1290.

At step 1730, the decoder may perform inverse transforming. The decoder may determine residual attributes 1731. The decoder may determine residual attributes 1731, for example, by applying/using inverse 3D transform to/for the residual coefficients 1721 based on portion of geometry 1222.

The decoder may determine decoded attributes 1233. The decoder may determine decoded attributes 1233, for example, by adding the residual attributes 1731 with the attribute predictors 1324.

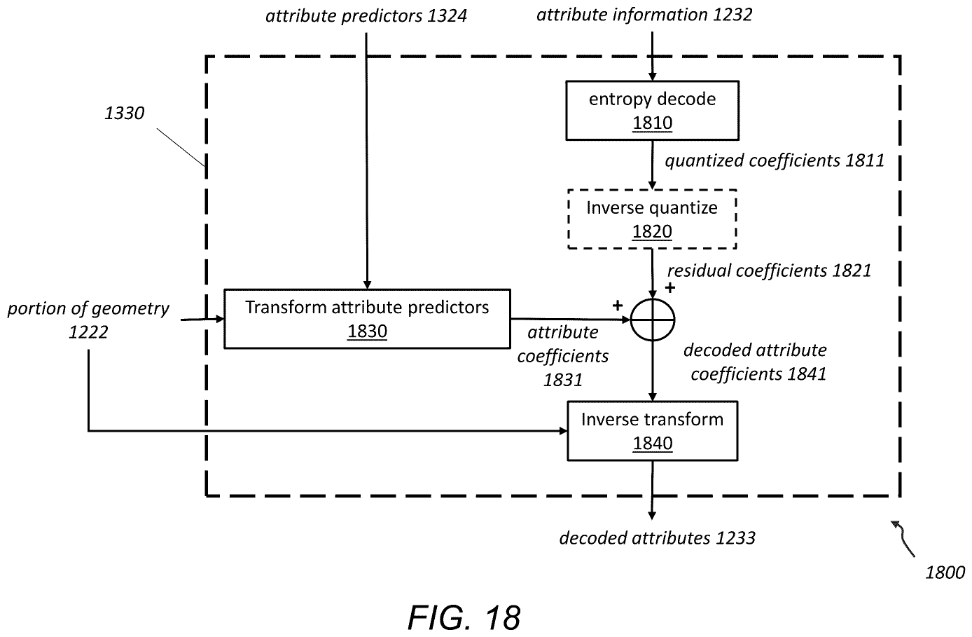

FIG. 18 shows an example method for decoding attributes based on attribute predictors. More specifically, FIG. 18 shows another example process 1800 of a method for decoding attributes based on attribute predictors 1324 associated with portion of geometry 1222. One or more steps of the example process 1800 (e.g., corresponding to step 1330 of FIG. 13A) may be performed and/or implemented by a decoder (e.g., decoder 120 of FIG. 1), an example computer system 2900 as described herein with respect to FIG. 29, and/or an example computing device 3030 as described herein with respect to FIG. 30. In some examples, steps 1810-1840 may represent components within the decoder.

At step 1810, the decoder may perform entropy decoding. The decoder may entropy decode quantized coefficients 1811 from attribute information 1232. The decoder may entropy decode quantized coefficients 1811 from attribute information 1232, for example, from the bitstream 1290.

At step 1820, the decoder may perform inverse quantizing. The decoder may determine residual coefficients 1821. The decoder may determine residual coefficients 1821, for example, by inverse quantizing the quantized coefficients 1811. In some examples, the decoder may entropy decode, from the bitstream 1290, residual coefficients 1821.

At step 1830, the decoder may transform attribute predictors. The decoder may determine attribute coefficients 1831. The decoder may determine attribute coefficients 1831, for example, by applying/using 3D transform to/for the attribute predictors 1324 based on the portion of geometry 1222.

The decoder may determine decoded attribute coefficients 1841. The decoder may determine decoded attribute coefficients 1841, for example, by adding the residual coefficients 1821 with the attribute coefficients 1831.

At step 1840, the decoder may perform inverse transforming. The decoder may determine decoded attributes 1233. The decoder may determine decoded attributes 1233, for example, by applying/using an inverse 3D transform to/for the decoded attribute coefficients 1841 based on portion of geometry 1222.

3D transform may be used/selected for transforming residual attributes 1511 of FIG. 15, mapped attributes 1031 and attribute predictors 1124 of FIG. 16, and/or attribute predictors 1324 of FIG. 18. The 3D transform may be the region-adaptive hierarchical transform (RAHT) scheme, for example, in G-PCC. Inverse 3D transform of this 3D transform may be used/selected for inverse transforming residual coefficients 1721 of FIG. 17 and/or decoded attribute coefficients 1841 of FIG. 18.

The RAHT scheme may be based on the iterative use of a two-point transform. In the framework of point cloud attribute coding, a two-point RAHT transform may be applied to (e.g., used for) two sets (e.g., A₁ and A₂) of attributes. The two sets (e.g., A₁ and A₂) of attributes may comprise respective number/quantity (e.g., w₁ and w₂) of attributes and respective associated coefficients (e.g., c_{A1} and c_{A2}). The associated coefficients (e.g., c_{A1} and c_{A2}) may be representative of the sum of attribute values over their respective set divided by the square root of the number/quantity of attributes.

$${c}_{A i} = \frac{1}{\sqrt{{w}_{i}}} {\sum }_{a ∈ {A}_{i}} a . ( {w}_{i} = {\#A}_{i} ) \qquad \text{(*} )$$

The two-point RAHT transform may depend on the weights w₁ and w₂ and may be defined by a 2×2 matrix as follows:

$$RAHT ( {w}_{1} , {w}_{2} ) = \frac{1}{\sqrt{{w}_{1} + {w}_{2}}} [ \begin{matrix}\sqrt{{w}_{1}} & \sqrt{{w}_{2}} \\ - \sqrt{{w}_{2}} & \sqrt{{w}_{1}}\end{matrix} ] .$$

Two new coefficients DC and AC may be determined, for example, if/when applied to (e.g., used for) the two coefficients c_{A1} and c_{A2}:

$$[ \begin{matrix}DC \\ AC\end{matrix} ] = RAHT ( {w}_{1} , {w}_{2} ) [ \begin{matrix}{c}_{A 1} \\ {c}_{A 2}\end{matrix} ] \qquad ( 1 )$$

As shown below, the above property (*) on coefficients still holds for the DC coefficient:

$$DC = \frac{1}{\sqrt{{w}_{1} + {w}_{2}}} ( \sqrt{{w}_{1}} {c}_{A 1} + \sqrt{{w}_{2}} {c}_{A 2} ) = \frac{1}{\sqrt{{w}_{1} + {w}_{2}}} ( {\sum }_{a ∈ {A}_{1}} a + {\sum }_{a ∈ {A}_{2}} a ) = \frac{1}{\sqrt{{w}_{1} + {w}_{2}}} {\sum }_{a ∈ {A}_{1} ⋃ {A}_{2}} a = {c}_{A 1 ⋃ A 2}$$

The two-point RAHT transform may be applied/used iteratively to/for DC coefficients. This may be referred to as the RAHT iterative method. If (e.g., once) AC coefficients are determined, AC coefficients do not undergo any further transformation. At the start of the RAHT iterative method, there may be initial sets of attributes. The quantity of the initial sets of attributes may be the same as the quantity of the points in the coded geometry. For example, there may be as many initial sets Aᵢ of attributes as there are points in the coded geometry S. Each initial set (e.g., Aᵢ) of attributes may contain one attribute (e.g., w₁=1) and the coefficient c_{Ai} may be equal to the value of this one attribute, thus fulfilling the property (*). By induction, the property (*) may hold for all subsequent DC coefficients, for example, all subsequent DC coefficients determined after iterative application of the two-point RAHT transform. In some examples, the points of the coded geometry (e.g., S) may refer to voxels generated/determined to represent points of the coded geometry (e.g., S).

Determined coefficients may be the union of a set of DC coefficients fulfilling the property (*) and a set of AC coefficients. Determined coefficients may be the union of a set of DC coefficients fulfilling the property (*) and a set of AC coefficients, for example, at any stage of the RAHT iterative method. The RAHT iterative method may continue until DC coefficients are depleted and only one DC coefficient is left. This one DC coefficient may be equal to C_{A} where A is the set of all attributes to be transformed. The RAHT iterative method may (e.g., a priori) follow any order among pairs of DC coefficients.

The attributes to be transformed may be residual attributes 1511, attribute predictors 1124, mapped attributes 1031, and/or attribute predictors 1324. The one obtained DC coefficient C_{A} may be transformed coefficients 1512, attributes coefficients 1611, mapped attributes coefficients 1621, and/or attributes coefficients 1831.

The two-point inverse RAHT transform may be defined by a 2×2 matrix as follows:

$$i R A H T ( {w}_{1} , {w}_{2} ) = \frac{1}{\sqrt{{w}_{1} + {w}_{2}}} [ \begin{matrix}\sqrt{{w}_{1}} & - \sqrt{{w}_{2}} \\ \sqrt{{w}_{2}} & \sqrt{{w}_{1}}\end{matrix} ]$$

The two-point inverse RAHT may be applied to (e.g., used for) DC and AC coefficients to obtain (e.g., recover or reconstruct) the two coefficients c_{A1} and c_{A2}:

$$[ \begin{matrix}{c}_{A 1} \\ {c}_{A 2}\end{matrix} ] = iRAHT ( {w}_{1} , {w}_{2} ) [ \begin{matrix}DC \\ AC\end{matrix} ]$$

The inverse iterative RAHT method/scheme may apply/use the inverse two-point RAHT to/for DC and AC coefficients in a reverse order relative to obtaining DC and AC coefficients by the iterative RAHT scheme. At the end of the inverse iterative RAHT scheme, coefficients (e.g., c_{Ai}) associated with the initial sets (e.g., Aᵢ) of attributes may be obtained. These coefficients (e.g., c_{A1}) may be equal to the values of the one attributes associated with the initial sets (e.g., Aᵢ). For example, attributes associated with the initial sets (e.g., Aᵢ) may be the residual attributes 1731 or decoded attributes 1233.

The RAHT iterative scheme may follow an octree in a specific iterative order. The RAHT iterative scheme may follow an octree in a specific iterative order, for example, in G-PCC. DC coefficients associated with occupied child nodes of a parent node in the octree may undergo a cascade of two-point RAHT transformations until one DC coefficient remains, together with AC coefficients. For example, up to eight DC coefficients associated with up to eight occupied child nodes of a parent node in the octree may undergo a cascade of two-point RAHT transformations until one DC coefficient remains, together with up to seven AC coefficients. This one DC coefficient may be pushed at the parent node level and the scheme may be repeated at upper octree depth (e.g., at lower depth indexes) until the root node is reached.

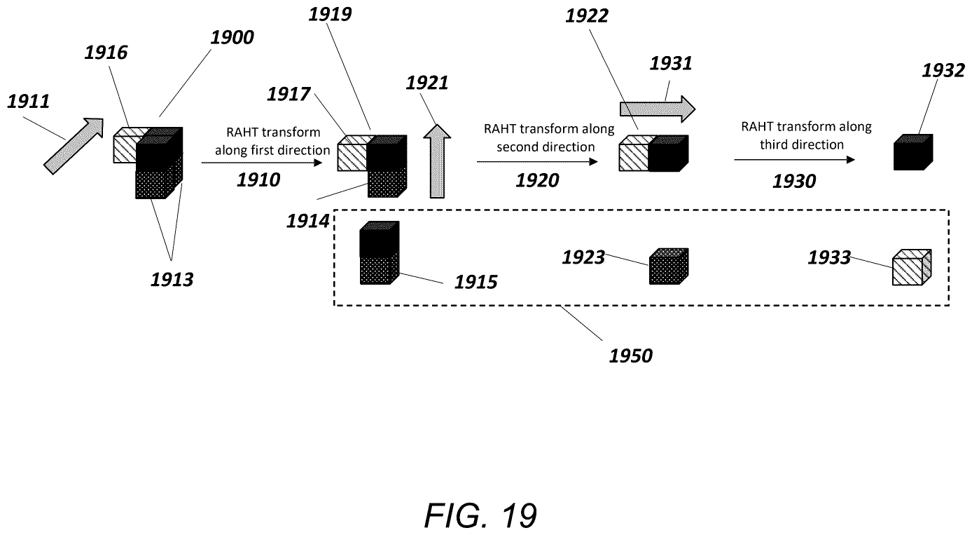

FIG. 19 shows an example RAHT transformation. More specifically, FIG. 19 shows an example RAHT transformation, of a RAHT scheme, based on (e.g., applied to) an octree. The RAHT transformation may be based on (e.g., applied to) child nodes of an octree parent node along three successive directions.

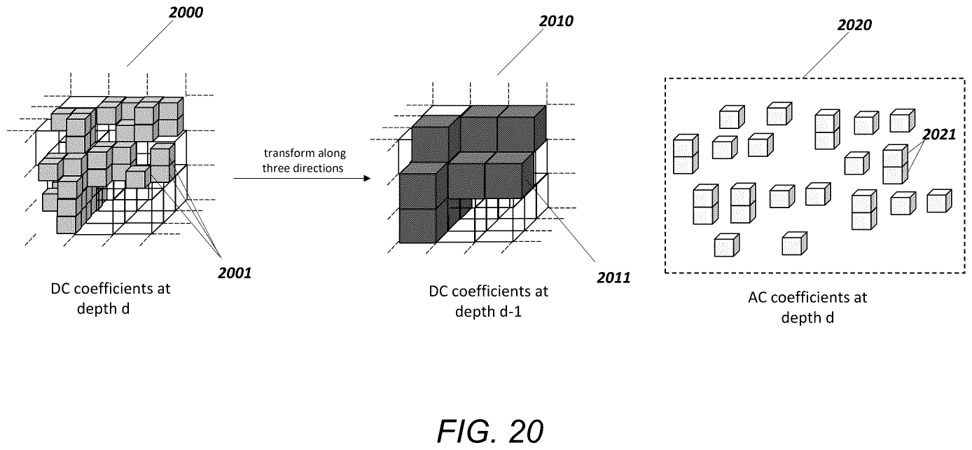

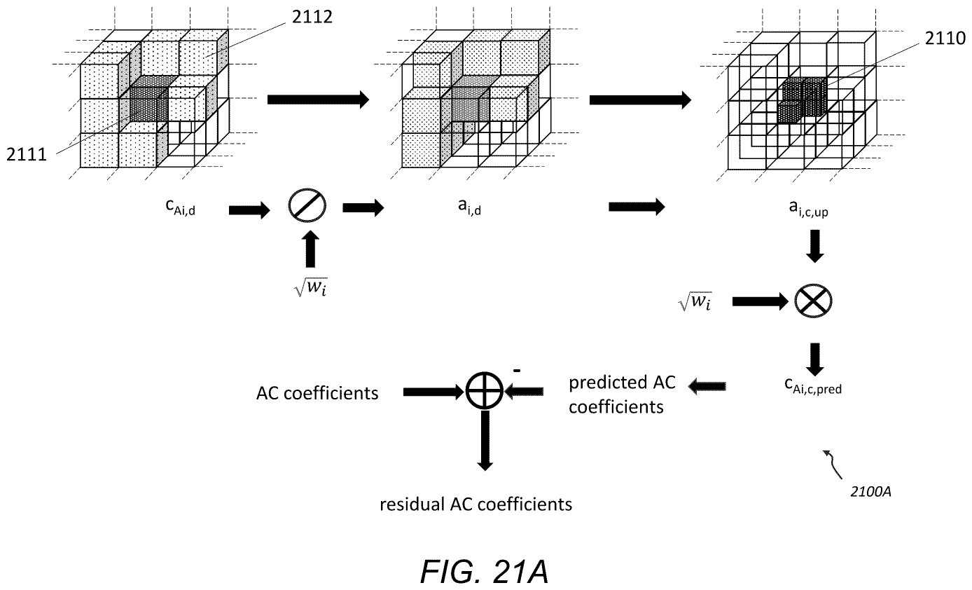

The parent node 1900 may have multiple (e.g., five) occupied child nodes each having a respective associated coefficients (e.g., cᵢ) and weights (e.g., w₁). A first RAHT transformation 1910 may be performed along a first direction 1911. If there are two adjacent occupied child nodes 1913 along the first direction, the two adjacent occupied child nodes 1913 may undergo a two-point RAHT transform. The two adjacent occupied child nodes 1913 may undergo a two-point RAHT transform, for example, to determine a new DC coefficient 1914 and an AC coefficient 1915. The AC coefficient 1915 may be pushed to a set 1950 of AC coefficients. The node may be left as is and its DC coefficient 1917 may be kept, for example, if there is only one occupied child node 1916 along the first direction. In this example, the child nodes may be collapsed along the first direction to determine a new set 1919 of nodes (e.g., a set of three nodes), with associated new DC coefficients. A second RAHT transformation 1920 may be performed, for example, after the first RAHT transformation. The second RAHT transformation 1920 may be performed, for example, along a second direction 1921. The second RAHT transformation 1920 may be performed, for example, in a similar way as the first RAHT transformation 1910. The second RAHT transformation 1920 may be performed, for example, to determine child nodes 1922. The child nodes 1922 may have been collapsed along the first two directions 1911 and 1921. AC coefficients 1923 may be pushed to the set 1950 of AC coefficients, for example, together with the collapse. A third RAHT transformation 1930 may be performed, for example, after the second RAHT transformation. The third RAHT transformation 1930 may be performed, for example, along a third direction 1931. The RAHT transformation 1930 may be performed, for example, in a similar way as the first and/or second RAHT transformation. RAHT transformation 1930 may be performed, for example, to determine a (e.g., unique) child node 1932. The child node 1932 may result from the collapse along all three directions. AC coefficients 1933 may be pushed to the set 1950 of AC coefficients, for example, together with the collapse. The child node 1932 may have an associated DC coefficient that is pushed to the parent node (e.g., as shown in FIG. 20).

FIG. 20 shows an example RAHT transformation. More specifically, FIG. 20 shows an example RAHT transformation based on (e.g., applied to) octree nodes (e.g., all octree nodes). The RAHT transformation may be based on (e.g., applied to) octree nodes (e.g., all octree nodes), for example, at depth ‘d’, to determine DC coefficients (e.g., at depth d−1) and AC coefficients. FIG. 20 shows an example of occupied nodes 2000 of an octree at depth ‘d’. Occupied nodes 2000 may undergo a RAHT transformation along the three directions. Occupied nodes 2000 may undergo a RAHT transformation along the three directions, for example, to push DC coefficients up to their occupied parent nodes 2010 that belong to the octree (e.g., at depth d−1). For example, DC coefficients for each node may be pushed up to a corresponding occupied parent node. For example, the three DC coefficients of the child nodes 2001 may undergo a RAHT transformation along the three directions. The three DC coefficients of the child nodes 2001 may undergo a RAHT transformation along the three directions, for example, to determine a (e.g., unique) DC coefficient associated with their parent node 2011 and two AC coefficients 2021. The two AC coefficients 2021 may be pushed to a set 2020 of AC coefficients. By performing this method for (e.g., all) occupied nodes 2000 of the octree (e.g., at depth ‘d’), the DC coefficients associated with occupied nodes of the octree (e.g., at depth ‘d’) may be transformed into DC coefficients associated with occupied parent nodes 2010 of the octree (e.g., at depth d−1) and a set 2020 of AC coefficients.

The RAHT transformation method may be a bottom-up method. This bottom-up method may be repeated based on depth (e.g., depth per depth). This bottom-up method may be repeated based on depth (e.g., depth per depth), for example, until reaching the minimum depth (the root node). The result of the RAHT transformation over the complete octree may comprise a set of coefficients comprising a (e.g., unique) DC coefficient and a set of (e.g., many) AC coefficients.

The RAHT transformation method may (e.g., typically) start from the highest/deepest depth. The highest/deepest depth may be, for example, farthest from the root node with a low depth index. At the highest/deepest depth, occupied child nodes may correspond to a (e.g., unique) point (e.g., voxel) of the coded geometry S. The (e.g., unique) point (e.g., voxel) may be associated with a/an (e.g., unique) attribute among the set (e.g., ‘a’) of attributes. The DC coefficient at the highest/deepest depth may be set as the value of the (e.g., unique) attribute associated with each occupied node, and the weights (e.g., ‘w’) may be set to 1.

The inverse RAHT method (e.g., on an octree) may be a top-down method. This top-down method may be used from the root node down to the last depth. The root node may comprise the lowest depth index or the most shallow depth. The last depth may comprise the highest depth index or the deepest depth. The last depth may be made of leaf nodes that each may contain only one point (e.g., voxel) of the point cloud. Each leaf node at the last depth may comprise only one attribute associated with the one point (e.g., voxel). The DC coefficients of occupied nodes 2010 of the octree at a lower depth (e.g., depth d−1) may be inverse transformed into DC coefficients of occupied nodes 2000 of the octree at a higher depth (e.g., depth d). The DC coefficients of occupied nodes 2010 of the octree at a lower depth (e.g., depth d−1) may be inverse transformed into DC coefficients of occupied nodes 2000 of the octree at a higher depth (e.g., depth d), for example, by applying/using the inverse two-point RAHT transform to/for the DC coefficient of each of the occupied node of the octree at the lower depth (e.g., depth d−1) and to/for the related AC coefficients from set 2020 of AC coefficients. The inverse two-point RAHT transform may be applied/used along the three directions, in a reverse order, such as to invert the node transformation process of FIG. 19. By doing so, DC coefficients of the leaf nodes may be obtained, and the values of these DC coefficients may correspond to the attributes associated with the (e.g., unique) point of each of the leaf nodes.

Like geometry coding of a point cloud, coding of attributes associated with the points of a current point cloud may benefit from inter-frame prediction using a motion compensated point cloud. The motion compensated point cloud may obtain (e.g., inherit) attributes from a reference point cloud that has been motion compensated. Points may keep their associated attributes. Points may keep their associated attributes, for example, during motion. Motion compensated attributes may be, for example, the attributes associated with the points of the motion compensated point cloud. The motion compensated attributes may be used to (e.g., better) compress the attributes of the coded geometry of the current point cloud.

Inter RAHT scheme may be used at steps 1610, 1620, 1730, 1830, and 1840 as described herein. Inter RAHT scheme may define an inter prediction mode that may use inter prediction for predicting the values of the DC and AC coefficients (i.e., DC coefficients and AC coefficients) determined by the RAHT iterative method or the inverse RAHT iterative method. In some examples, because the generation of DC and AC coefficients may follow an octree, it may be beneficial to maintain a common attribute octree structure for both the portion of geometry (e.g., portion of geometry 1022, 1222) and a motion compensated portion of geometry. A common bounding box encompassing both portion of geometries (i.e., both the portion of geometry and the motion compensated portion of geometry) may be determined. An octree partitioning may be performed, from a root node associated with the common bounding box, for both portion of geometries. This may lead to two octree partitioning. The two octree partitioning may be different. The two octree partitioning may be different, for example, if/when the portion of geometries are not equal. It may be likely that the portion of geometries are not equal. The two octrees may have a common subtree starting from the root node. On this subtree, occupied node topology may be the same, and a common set of DC and AC coefficients may be determined for both portion of geometries. The subset (e.g., the common set) of DC and AC coefficients associated with nodes of the common subtree may be predicted from DC and AC coefficients. The subset (e.g., the common set) of DC and AC coefficients may be determined from the attributes of the portion of geometry (e.g., portion of geometry 1022, 1222). The DC and AC coefficients may be determined from the attributes of the motion compensated portion of geometry. The encoder and/or decoder may determine coefficient residual values. The encoder and/or decoder may determine coefficient residual values, for example, by subtracting the DC and AC coefficients determined from the attributes of the motion compensated portion of geometry from the DC and AC coefficients associated with nodes of the common subtree and determined from the attributes of the portion of geometry (e.g., portion of geometry 1022, 1222).

The DC and AC coefficients that are not associated with nodes of the common subtree may not be predicted. The DC and AC coefficients that are not associated with nodes of the common subtree may be transformed (e.g., directly) in a similar way as performed for the case without inter prediction.

Predicted DC coefficients of the portion of geometry (e.g., portion of geometry 1022, 1222) may be determined. Predicted DC coefficients of the portion of geometry (e.g., portion of geometry 1022, 1222) may be determined, for example, instead of predicting AC coefficients. Predicted DC coefficients of the portion of geometry (e.g., portion of geometry 1022, 1222) may be determined at a (e.g., some) depth, for example, if (e.g., assuming) both the octree of the portion of geometry (e.g., portion of geometry 1022, 1222) and the octree of the motion compensated portion of geometry may have a same occupancy of a node at this depth. The predicted DC coefficients may be determined based on (e.g., from) their co-located DC coefficients of the motion compensated portion of geometry. DC residual values may be determined. DC residual values may be determined, for example, by subtracting the predicted DC coefficients from the DC coefficients of the portion of geometry (e.g., portion of geometry 1022, 1222). The RAHT transformation may go up in the octree starting from DC residual values replacing the DC coefficients of the portion of geometry (e.g., portion of geometry 1022, 1222).

A RAHT scheme process that does not use information from a reference point cloud different from the current point cloud may be called an intra RAHT scheme. Intra RAHT scheme may define an intra prediction mode for predicting the values of the DC and the AC coefficients determined by the RAHT iterative method or the inverse RAHT iterative method.

Intra prediction may be performed between DC and AC coefficients of an intra RAHT scheme and may be referred to as inter-depth prediction. In some implementations of point cloud coding, this inter-depth prediction within portion of geometry (e.g., portion of geometry 1022, 1222) may be integrated into the RAHT scheme as being an intra prediction mode.

The inter-depth prediction mode may predict the DC coefficients associated with a current RAHT node of a RAHT tree at a depth (e.g., depth d). The inter-depth prediction mode may predict the DC coefficients associated with a current RAHT node of a RAHT tree at a depth (e.g., depth ‘d’), for example, by using interpolation of DC coefficients associated with nodes of the octree at a lower depth (e.g., depth d−1). A lower depth may comprise a lower depth index corresponding to shallower depth of the RAHT tree. A lower depth may indicate a depth level closer to root node of RAHT tree. A higher depth may indicate a depth level closer to leaf nodes of RAHT tree (i.e., farther from root node). The inter-depth prediction mode may (e.g., also) predict AC coefficients of a current RAHT node. The inter-depth prediction mode may predict AC coefficients of a current RAHT node, for example, by using attribute information from a parent node and attribute information from already-coded neighboring RAHT nodes of the parent node of the current RAHT node.

A RAHT tree may comprise RAHT nodes that are linked together according to a parent-child relationships defined as an occupancy tree over the decoded geometry. A RAHT node of the RAHT tree may be a node of the occupancy tree that is associated with a DC coefficient. The node of the occupancy tree may be (e.g., also) associated with one or more AC coefficients. The DC coefficients and the one or more AC coefficients may be obtained, for example, by applying/using the iterative RAHT (e.g., by an encoder) or inverse iterative RAHT method (e.g., by a decoder) to/for the points belonging to the sub-volumes associated with the occupied nodes of the occupancy tree.

Already-coded neighboring RAHT nodes of the parent node of the current RAHT node may include nodes that may interact with (or are spatially close to) the parent node. For example, already-coded neighboring RAHT nodes of the parent node of the current RAHT node may include nodes that are siblings to the parent node. The siblings may comprise the seven siblings in an octree structure. In some examples, already-coded neighboring RAHT nodes may include nodes that may share a face (e.g., a portion of a face), an edge (e.g., a portion of an edge), or a vertex (e.g., corner) with the parent node.

The inter-depth prediction as discussed herein may be implemented in a bounded domain. For example, the inter-depth prediction may be implemented in a mean attribute domain which is naturally bounded by the attribute value range. The bounded property of the mean attribute domain may be advantageous. For example, the bounded property of the mean attribute domain may correlate to a more physical meaning and/or may provide better numerical stability of the inter-depth prediction. This may lead to a more efficient prediction.

Mean sums of attributes values (e.g., a_{i,d}) determined (e.g., calculated) for RAHT nodes at a parent RAHT node (e.g., at depth d) may be used to predict a mean sum of attribute values (e.g., a_{i,c}) associated with each child RAHT node (e.g., at depth d+1) of the parent RAHT node. The mean sums of attributes values (e.g., a_{i,d}) determined (e.g., calculated) for RAHT nodes at a parent node (e.g., at depth d) may comprise a mean sum of attributes values (e.g., a_{i,d}) determined (e.g., calculated) for the parent RAHT node and (e.g., possibly) a mean sum of attributes values (e.g., aᵢ) determined (e.g., calculated) from one or more already-coded neighboring RAHT nodes of the RAHT parent node.

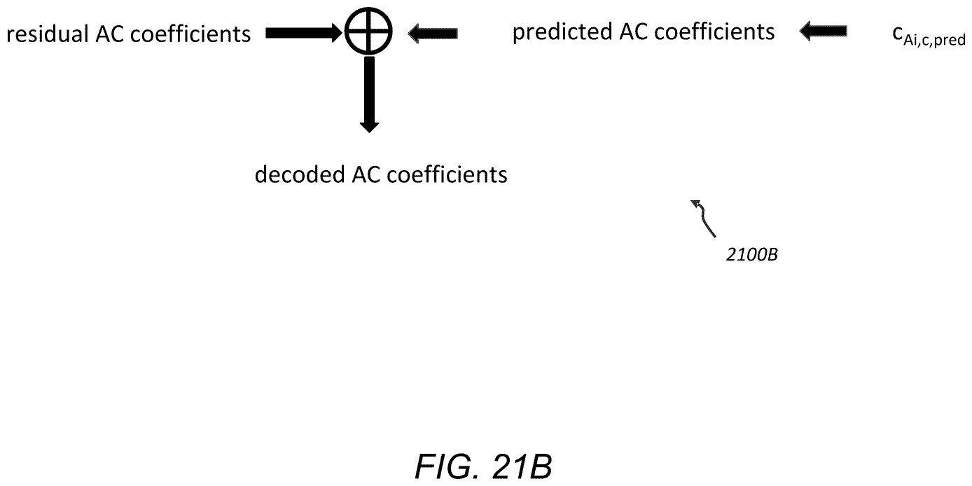

FIG. 21A shows an example method for encoding attribute information for child RAHT node(s). More specifically, FIG. 21A shows an example process 2100A of a method for encoding attribute information for child RAHT node(s) 2110 (e.g., at depth d) of a parent RAHT node 2111 (e.g., at depth d−1) using top-down coding and inter-depth prediction. One or more steps of the example process 2100A may be performed and/or implemented by an encoder (e.g., encoder 114 of FIG. 1), an example computer system 2900 as described herein with respect to FIG. 29, and/or an example computing device 3030 as described herein with respect to FIG. 30.

A set of already-coded neighboring RAHT nodes 2112 of the parent RAHT node 2111 may comprise RAHT nodes of the RAHT tree at the parent node depth (e.g., depth d−1). These RAHT nodes may share at least a vertex with the parent RAHT node 2111.

The encoder may determine the DC coefficients (e.g., c_{Ai,d}) for the parent RAHT node 2111 and each of the already-coded neighboring RAHT nodes 2112. The encoder may determine (e.g., calculate) a mean sum of the attributes value (e.g., a_{i,d}) for the parent RAHT node 2111 and a mean sum of attributes value (e.g., a_{i,d}) for each of the already-coded neighboring RAHT nodes 2112. The encoder may determine (e.g., calculate) a mean sum of the attributes value (e.g., a_{i,d}) for the parent RAHT node 2111 and a mean sum of attributes value (e.g., a_{i,d}) for each of the already-coded neighboring RAHT nodes 2112, for example, by dividing the coefficients (e.g., c_{Ai,d}) of each of those RAHT nodes by the square root of its corresponding number/quantity of attributes (e.g., \sqrt{wᵢ}). For example, a mean sum of attributes a_{i,d} may be obtained as

$${a}_{i , d} = \frac{{c}_{Ai , d}}{\sqrt{{w}_{i}}} = \frac{{\sum }_{a ∈ {A}_{i}} a}{{w}_{i}} .$$

The encoder may obtain a predicted mean sum of attributes (e.g., a_{i,c,up}) for each child RAHT node 2110. The encoder may obtain a predicted mean sum of attributes (e.g., a_{i,c,up}) for each child RAHT node 2110, for example, by up-sampling the mean sums of attributes values (e.g., a_{i,d}) determined (e.g., calculated) for the RAHT nodes at the parent node depth (e.g., depth ‘d−1’).

The encoder may determine a predicted DC coefficient (e.g., c_{Ai,c,pred}) for each child RAHT node 2110. The encoder may determine a predicted DC coefficient (e.g., c_{Ai,c,pred}) for each child RAHT node 2110, for example, by multiplying the predicted mean sum of attributes (e.g., a_{i,c,up}) determined (e.g., calculated) for each child RAHT node 2110 by the square root of its corresponding number/quantity of attributes (e.g., \sqrt{wᵢ}).

The encoder may determine predicted AC coefficients from predicted DC coefficient (e.g., c_{Ai,c,pred}). The encoder may determine predicted AC coefficients from predicted DC coefficient (e.g., c_{Ai,c,pred}), for example, based on equation (1). The encoder may determine residual AC coefficients. The encoder may determine residual AC coefficients, for example, by subtracting the predicted AC coefficients from original AC coefficients (or AC coefficients) associated with each child RAHT node 2110. Original AC coefficients associated with a child RAHT node 2110 may be determined. Original AC coefficients associated with a child RAHT node 2110 may be determined, for example, by the (e.g., usual) RAHT transform from original attributes to be coded. The residual AC coefficients may be encoded in a bitstream. The residual AC coefficients may be encoded in a bitstream, for example, through quantization (e.g., steps 1520, 1630) and entropy coding (e.g., step 1530, 1640).

FIG. 21B shows an example method for decoding attribute information for child RAHT node(s). More specifically, FIG. 21B shows an example process 2100B of a method for decoding attribute information for child RAHT node(s) (e.g., at depth d) of a parent RAHT node (e.g., at depth d−1) using top-down decoding and inter-depth prediction. The decoder may perform top-down decoding because the inter-depth prediction goes from a higher depth (e.g., depth ‘d’) to a lower depth (e.g., depth d−1). The decoder may perform top-down decoding, for example, if/when inter-depth prediction is used in the RAHT transform and coding. One or more steps of the example process 2100B may be performed and/or implemented by a decoder (e.g., decoder 120 as described herein with respect to FIG. 1), an example computer system 2900 as described herein with respect to FIG. 29, and/or an example computing device 3030 as described herein with respect to FIG. 30.

The decoder may generate the predicted AC coefficients. For example, the decoder may use (e.g., employ) the same inter-depth prediction process to generate the predicted mean sum of attributes values (e.g., c_{Ai,c,pred}) for each child node (e.g., child node 2110 in FIG. 21A) and the predicted AC coefficients. The decoder may reconstruct the residual AC coefficients from a bitstream. The decoder may reconstruct the residual AC coefficients from a bitstream, for example, through entropy decoding (e.g., steps 1710, 1810) and inverse quantization (e.g., step 1720, 1820). The decoder may determine decoded AC coefficients. The decoder may determine decoded AC coefficients, for example, by adding the predicted AC coefficients to the reconstructed residual AC coefficients.

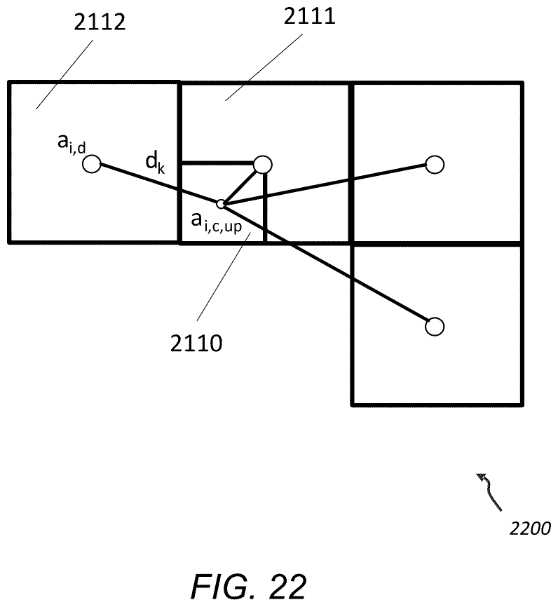

FIG. 22 shows an example method for up-sampling the mean sums of attributes values of RAHT nodes. More specifically, FIG. 22 shows an example process 2200 of a method for up-sampling the mean sums of attributes values of RAHT nodes (e.g., at depth ‘d−1’). The RAHT nodes may include, for example, the parent RAHT node 2111 and the already-coded neighboring RAHT nodes 2112. For clarity and ease of explanation, this example is shown in two dimensions. Extension to three dimensions may be understood in light of the description herein.

The up-sampling operation may relate a child RAHT node to a parent RAHT node or its neighboring RAHT node. For example, the up-sampling operation may consider (e.g., use) a distance metric (e.g., dₖ) relating the child RAHT node 2110 to a RAHT node (e.g., k) at a depth (e.g., depth ‘d−1’). The RAHT node (e.g., k) at a depth (e.g., depth ‘d−1’) may be either the parent RAHT node 2111 or each of the (e.g., three) already-coded neighboring RAHT nodes 2112. This distance metric (e.g., dₖ) may represent a geometric distance between a center point of the sub-volume corresponding to the child RAHT node 2110 and a center point of the sub-volume corresponding to the RAHT node (e.g., k) 2111, 2112. The inverse

$$( e . g . , {d}_{k}^{- 1} )$$

of the distance metric (e.g., dₖ) may represent the relative weight of correlation between attribute information from the child RAHT node 2110 and the RAHT node (e.g., k). Other weighting factors, or additional weighting factors, may be used in other implementations of the up-sampling operation.

The predicted mean sum of attributes (e.g., a_{i,cup}) for the child RAHT node 2110 may be given. The predicted mean sum of attributes (e.g., a_{i,cup}) for the child RAHT node 2110 may be given, for example, by the weighted sum:

$${a}_{i , c , up} = {\sum }_{k} \frac{{d}_{k}^{- 1} {a}_{k}}{{\sum }_{k} {d}_{k}^{- 1}}$$

where αₖ may indicate the mean sum of attributes determined (e.g., calculated) for the RAHT node k.

AC coefficients may be directly coded. AC coefficients may be directly coded, for example, if/when neither intra (e.g., inter-depth prediction) nor inter prediction are used. The direct coding of AC coefficients may be equivalent to coding residual AC coefficients relative to a null predictor. The direct coding of AC coefficients may be referred to as a null prediction mode for coding the current RAHT node.

As described herein, transformed coefficients of transform nodes (e.g., RAHT nodes, Haar nodes) may be (e.g., more efficiently) encoded and/or decoded using prediction modes for coding attributes of the transform nodes. RAHT is considered a lossy variation of the lossless Haar transform. Both transforms use attribute values of a node at a lower level of the octree to predict attributes of the nodes at the next level. RAHT coefficients of RAHT nodes may be (e.g., more efficiently) encoded and/or decoded using prediction modes for coding attributes of the RAHT nodes. A prediction mode for a RAHT node of the RAHT tree may be a null prediction mode or one of an intra or inter prediction modes, as described herein with respect to FIG. 14. Indications of prediction modes may be entropy coded in a bitstream, for example, to improve coding performance.

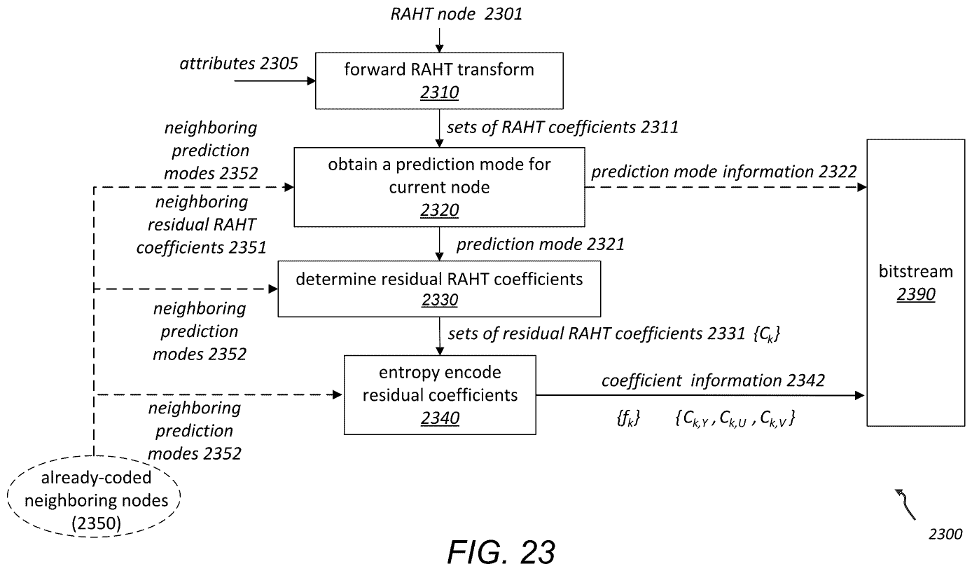

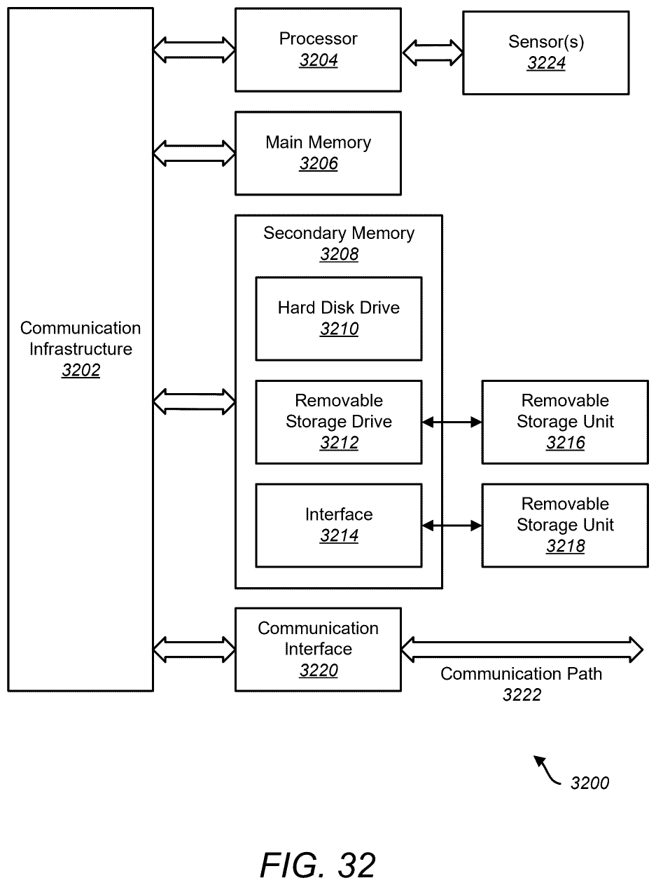

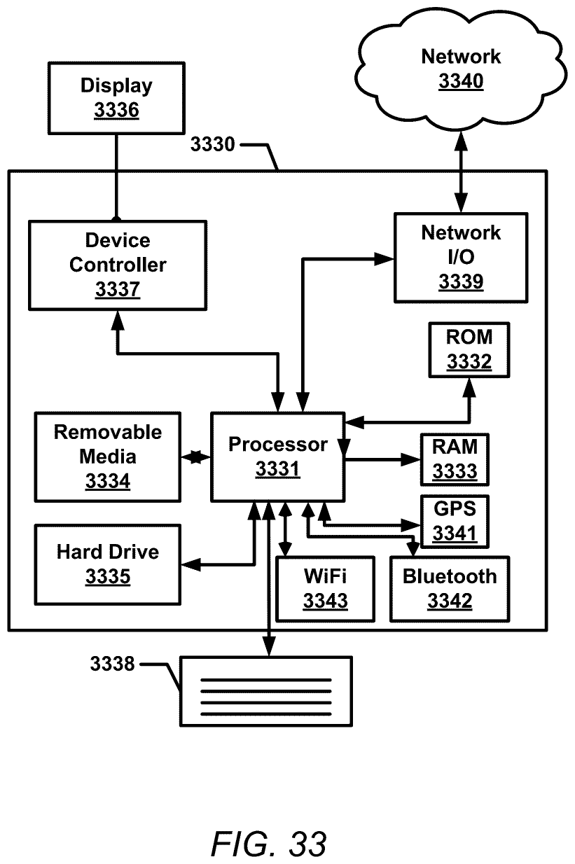

FIG. 23 shows an example method for encoding attributes. More specifically, FIG. 23 shows an example process 2300 of a method for encoding attributes of a RAHT node 2301 using a prediction mode. Although the process illustrated in FIG. 23 shows an example method for encoding attributes of a RAHT node, the example method may by applied for encoding attributes of a transform node (e.g., RAHT node, Haar node). Accordingly, the RAHT node 2301 may be an example of a transform node. The example process 2300 may be generally used for a transform (e.g., RAHT transform, Haar transform). One or more steps of the example process 2300 may be performed and/or implemented by an encoder (e.g., encoder 114 of FIG. 1), an example computer system 3200 as described herein with respect to FIG. 32, and/or an example computing device 3330 as described herein with respect to FIG. 33. In some examples, steps 2310-2340 may represent components within the encoder.

The encoder may transform attributes of a transform node (e.g., RAHT node, Haar node) to obtain sets of residual transform coefficients. The encoder may transform attributes 2305 of the RAHT node 2301 to obtain sets (e.g., {Cₖ}) of residual RAHT coefficients 2331. The sets (e.g., {Cₖ}) of residual transform coefficients (e.g., RAHT coefficients 2331) may result from applying/using a prediction mode 2321. The sets (e.g., {Cₖ}) of residual transform coefficients (e.g., RAHT coefficients 2331) may be encoded into a bitstream 2390.

The attributes 2305 of a transform node may be transformed (e.g., RAHT, Haar) into sets of transform coefficients. At step 2310, for example, the attributes 2305 of a RAHT node 2301 may be RAHT transformed into sets of RAHT coefficients 2311. For example, the attributes 2305 of a RAHT node 2301 may be forward RAHT transformed (or use a forward RAHT transform to be transformed) into sets of RAHT coefficients 2311.

At step 2320, a prediction mode 2321 may be obtained for the current node (e.g., the RAHT node 2301). The prediction mode 2321 may be determined (e.g., inferred, selected), for example, based on (e.g., from) a set of prediction modes. The set of prediction modes may be from a group including an inter prediction mode and an intra prediction mode. The set of prediction modes may be from a group including an intra prediction mode, an inter prediction mode, and a null prediction mode.

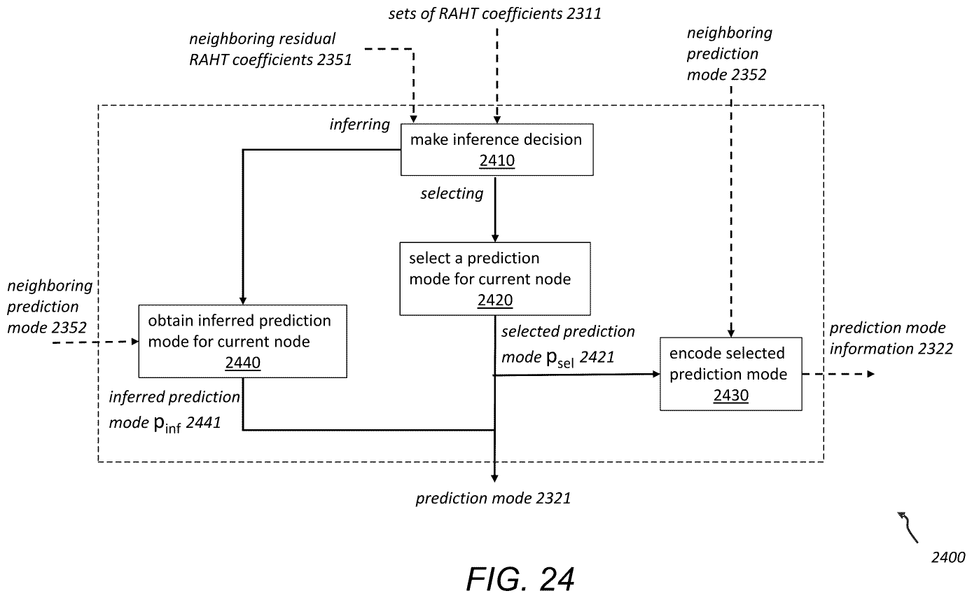

FIG. 24 shows an example method for encoding attributes. More specifically, FIG. 24 shows an example process 2400 of a method for performing step 2320 related to obtaining the prediction mode 2321 for encoding attributes of the RAHT node 2301. Although the process illustrated in FIG. 24 shows an example method for performing step 2320 related to obtaining the prediction mode 2321 for encoding attributes of the RAHT node 2301, the example method may be generally applied for encoding attributes of a transform node (e.g., RAHT node, Haar node). Accordingly, the RAHT node 2301 may be an example of a transform node. The example process 2400 may be generally used for a transform (e.g., RAHT transform, Haar transform). One or more steps of the example process 2400 may be performed and/or implemented by an encoder (e.g., encoder 114 of FIG. 1), an example computer system 3200 as described herein with respect to FIG. 32, and/or an example computing device 3330 as described herein with respect to FIG. 33. In some examples, steps 2410-2440 may represent components within the encoder.

The encoder may perform step 2320, for example, after sets of transform coefficients (e.g., RAHT coefficients 2311) have been obtained at step 2310. More specifically, the encoder may make an inference decision (e.g., at step 2410). The inference decision may indicate whether the prediction mode 2321 is either an inferred prediction mode (e.g., p_{inf} 2441, output at step 2440) or a selected prediction mode (e.g., pₛₑ₁ 2421, output at step 2420). The selected prediction mode may be selected from a set of prediction modes (e.g., at step 2420). At step 2410, the encoder may make the inference decision. The encoder may make the inference decision, for example, based on neighboring residual transform coefficients that may be associated with at least one already-coded neighboring transform node. The encoder may make the inference decision, for example, based on neighboring residual RAHT coefficients 2351. The neighboring residual RAHT coefficients 2351 may comprise, for example, residual RAHT coefficients associated with at least one already-coded neighboring RAHT node 2350 of the RAHT node 2301. The inference decision may be, for example, based on information indicating the magnitudes (e.g., m_{k,Y}, m_{k,U}, and m_{k,V}) of the neighboring residual transform coefficients (e.g. residual RAHT coefficients 2351).

The residual transformed coefficients (e.g., RAHT coefficients, Haar coefficients) may comprise sets of component coefficients. The residual transformed coefficients may comprise sets of component coefficients, for example, to represent attributes associated with the transform node (e.g., RAHT node, Haar node). In some examples, residual transformed coefficients (e.g., RAHT coefficients) may comprise a series {Cₖ}_{k=1, . . . , K} of K sets of component coefficients to represent attributes associated with the transform node (e.g., RAHT node 2301). Each set of component coefficients may comprise three component coefficients, for example, if the attributes to be coded are color attributes. The three component coefficients may correspond to three color components of a color attribute of a voxel or a point. For example, one component coefficient may be for luma, and two component coefficients may be for chroma. For example, the color space may be YC_{b}Cᵣ or YUV. The luma component of set Cₖ of coefficients may be denoted as C_{k,Y}. The two chroma components may be denoted as C_{k,U} and C_{k,V}, respectively. The set Cₖ may be represented as:

$${C}_{k} = \{ {C}_{k , Y} , {C}_{k , U} , {C}_{k , V} \} .$$

Each component coefficient (e.g., C_{k,Y}, C_{k,U} and C_{k,V}) may be represented by a sign (e.g., s_{k,Y}, s_{k,U} and s_{k,V}) and a series of bits representing its magnitude (or absolute value) (e.g., m_{k,Y}, m_{k,U} and m_{k,V}). For example, a component coefficient C_{k,Y} may be represented by a sign s_{k,Y} and a series of bits representing its magnitude (or absolute value) m_{k,Y}.

The inference decision may be made. The inference decision may be made, for example, based on the information indicating the magnitudes being less than or equal to a threshold (e.g., small magnitudes). Small magnitudes may indicate that neighboring prediction modes 2352 may be accurate and that the prediction mode 2321 may be inferred. The neighboring prediction modes 2352 may be, for example, prediction modes associated with at least one already-coded neighboring transform node (e.g., already-coded neighboring RAHT nodes 2350 of the RAHT node 2301. The prediction mode 2321 may be inferred, for example, at step 2440, from the neighboring prediction modes 2352.

At step 2440, an inferred prediction mode (e.g., p_{inf}) 2441 may be obtained. An inferred prediction mode for the current node may be obtained, for example, based on determining a neighboring prediction mode 2352. The neighboring prediction mode 2352 may be a most common/used prediction mode among the neighboring prediction modes. The determination/selection of the most common/used prediction mode may be referred to as a majority voting process.

At step 2420, a prediction mode for a current node may be selected. The prediction mode (e.g., pₛₑ₁) 2421 may be selected from a set of prediction modes. The prediction mode (e.g., pₛₑ₁) 2421 may be selected from a set of prediction modes, for example, based on rate distortion optimization (RDO) costs of the set of prediction modes. As an example, the prediction mode with the lowest RDO cost may be selected.

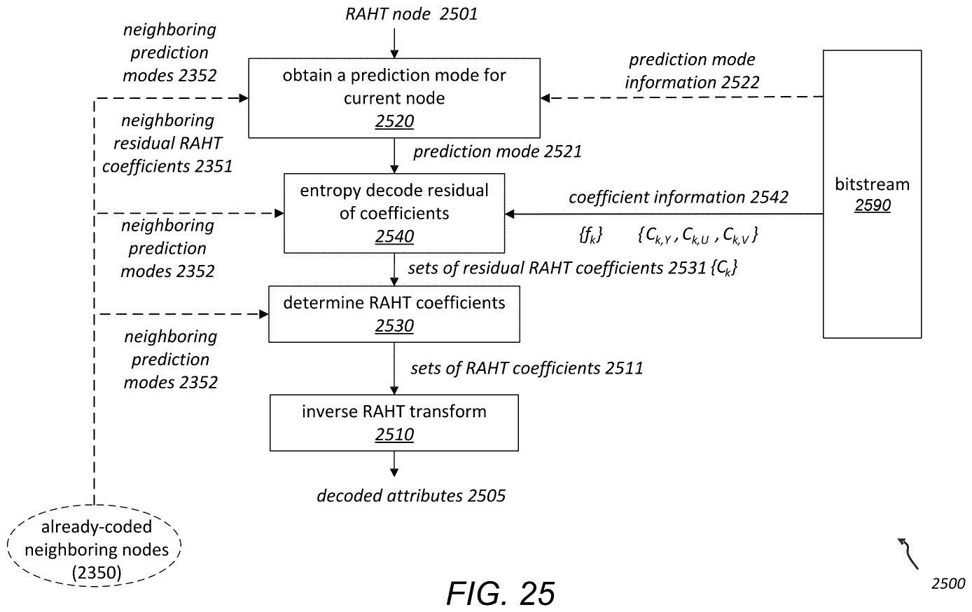

The inference decision may indicate the prediction mode 2321 being either the inferred prediction mode (e.g., p_{inf}) 2441 or the selected prediction mode (e.g., pₛₑ₁) 2421. At step 2430, the encoder may encode (e.g., entropy encode) the selected prediction mode. The encoder may encode (e.g., entropy encode) the selected prediction mode, for example, as part of prediction mode information in a bitstream. The encoder may encode (e.g., entropy encode) an indication of the selected prediction mode (e.g., pₛₑ₁) 2421 as part of prediction mode information 2322 in a bitstream 2390, for example, if the inference decision indicates that the prediction mode 2321 is the selected prediction mode (e.g., pₛₑ₁) 2421. The indication of the selected prediction mode may be skipped or omitted from being (e.g., signaling as) part of prediction mode information 2322. The indication may be skipped or omitted from being (e.g., signaling as) part of prediction mode information 2322, for example, if the inference decision indicates that the prediction mode 2321 is the inferred prediction mode (e.g., p_{inf}) 2441. In some examples, the indication may not be needed in bitstream 2390. The indication may not be needed in bitstream 2390, for example, because the decoder may make the same inference decision and infer the same inferred prediction mode (e.g., p_{inf}) 2441 as the encoder (e.g., as further described herein with respect to FIG. 25).

The encoder may encode (e.g., entropy encode) the indication of the selected prediction mode (e.g., pₛₑ₁) 2421. The encoder may entropy encode the indication of the selected prediction mode (e.g., pₛₑ₁) 2421, for example, based on a context selected from a set of contexts. For example, the context selection may be based on neighboring prediction modes 2352. The neighboring prediction modes 2352 may be, for example, prediction modes 2352 associated with at least one already-coded neighboring transform node. The neighboring prediction modes 2352 may be, for example, prediction modes 2352 associated with at least one already-coded neighboring RAHT node 2350 of the RAHT node 2301.

The obtained prediction mode 2321 may be associated with the transform node (e.g., RAHT node 2501). The obtained prediction mode 2321 may be used for encoding attributes of (e.g., further) transform nodes, such as RAHT nodes or Haar nodes.

Referring back to FIG. 23, the encoder may determine residual transformed coefficients (e.g., RAHT coefficients, Haar coefficients). A prediction mode may be applied to (e.g., used for) the transform node to obtain (e.g., compute or derive) sets (e.g., {Cₖ}) of residual transformed coefficients from sets of transformed coefficients. For example, at step 2330, the encoder may determine residual RAHT coefficients. The prediction mode 2321 may be applied to (e.g., used for) the RAHT node 2301 to obtain (e.g., compute or derive) sets (e.g., {Cₖ}) of residual RAHT coefficients 2331 from the sets of RAHT coefficients 2311. For example, the encoder may use the prediction mode 2321 to generate a predictor that may be subtracted from the set of RAHT coefficients 2311 to obtain the sets (e.g., {Cₖ}) of residual RAHT coefficients 2331.

Generating (e.g., constructing) the predictor may be performed. Generating (e.g., constructing) the predictor may be performed, for example, based on the already-coded neighboring nodes 2350 and their neighboring prediction modes 2352. For example, the constructed predictor may be an average predictor. The average predictor may be a linear combination of an intra predictor derived from an intra prediction mode and an inter predictor derived from an inter prediction mode. The weights in the linear combination may be determined. The weights in the linear combination may be determined, for example, based on neighboring prediction modes 2352.

At step 2340, the encoder may encode (e.g., entropy encode) residual coefficients. The sets (e.g., {Cₖ}) of residual transformed coefficients 2331 may be entropy encoded into the bitstream as coefficient information. For example, the sets (e.g., {Cₖ}) of residual RAHT coefficients 2331 may be entropy encoded into the bitstream 2390 as coefficient information 2342.

In some examples, the encoding (e.g., at step 2340) may comprise encoding a series of flags (e.g., {fₖ}) indicating if the sets (e.g., {Cₖ}) of residual transformed coefficients (e.g., residual RAHT coefficients 2331) are zero. The encoding may comprise encoding values of sets (e.g., C_{k,Y}, C_{k,U} and C_{k,V}), for example, after encoding the series of flags. The encoding values of sets (e.g., C_{k,Y}, C_{k,U} and C_{k,V}) may be performed, for example, based on (e.g., by) encoding flags (e.g., f_{k,Y}, f_{k,U} and f_{k,V}) indicating if respective values are zero, signs (e.g., s_{k,Y}, s_{k,U} and s_{k,V}) and magnitudes (or absolute values) (e.g., m_{k,Y}, m_{k,U} and m_{k,V}) for non-zero component coefficients in each of the sets.

The encoder may entropy encode the series of flags (e.g., {fₖ}) and/or the sets (e.g., {Cₖ}) of residual transformed coefficients (e.g., residual RAHT coefficients 2331), for example, based on a context selected from a set of contexts. For example, the context selection may be based on neighboring prediction modes 2352.

FIG. 25 shows an example method for decoding attributes. More specifically, FIG. 25 shows an example process 2500 for decoding attributes of a RAHT node 2501 using a prediction mode. Although the process illustrated in FIG. 25 shows an example method for decoding attributes of a RAHT node 2501 using a prediction mode, the example method may be generally applied for decoding attributes of a transform node (e.g., RAHT node, Haar node). Accordingly, the RAHT node 2501 may be an example of a transform node. The example process 2500 may be generally used for a transform (e.g., RAHT, Haar). One or more steps of the example process 2500 may be performed and/or implemented by a decoder (e.g., decoder 120 of FIG. 1), an example computer system 3200 as described herein with respect to FIG. 32, and/or an example computing device 3330 as described herein with respect to FIG. 33. In some examples, steps 2510-2540 may represent components within the decoder. The bitstream 2590 may be (e.g., typically) obtained from the encoding method as shown in FIG. 23. The decoder may decode sets (e.g., {Cₖ}) of residual transformed coefficients (e.g., RAHT coefficients 2531) from the bitstream 2590. The decoder may apply/use an inverse transform (e.g., RAHT, Harr), for example at step 2510, to obtain decoded attributes of a transform node. For instance, the decoder may apply/use an inverse RAHT transform (e.g., at step 2510) to obtain decoded attributes 2505 of a RAHT node 2501.

A prediction mode may be obtained for the transform node (e.g., current node). Referring for example to FIG. 25, at step 2520, a prediction mode 2521 may be obtained for the RAHT node 2501 (e.g., current node). The prediction mode 2521 may be inferred or selected from a set of prediction modes.

FIG. 26 shows an example method for decoding attributes. More specifically, FIG. 26 shows an example process 2600 for performing step 2520 in FIG. 25. Although the process illustrated in FIG. 26 shows an example method for decoding attributes of a RAHT node 2501 using a prediction mode, the example method may be generally applied for decoding attributes of a transform node (e.g., RAHT node, Haar node). Accordingly, the step 2520 may be related to obtaining the prediction mode (e.g., prediction mode 2521) for decoding attributes of the transform node (e.g., RAHT node 2501). The RAHT node 2501 may be an example of a transform node. The example process 2600 may be generally used for a transform (e.g., RAHT, Haar). One or more steps of the example process 2600 may be performed and/or implemented by a decoder (e.g., decoder 120 of FIG. 1), an example computer system 3200 as described herein with respect to FIG. 32, and/or an example computing device 3330 as described herein with respect to FIG. 33. In some examples, steps 2610-2630 may represent components within the decoder.

At step 2610, the decoder may make an inference decision. More specifically, the decoder may make an inference decision that may indicate whether the prediction mode 2521 is either the inferred prediction mode (e.g., p_{inf}) 2631 (e.g., obtained at step 2630) or the selected prediction mode (e.g., pₛₑ₁) 2621 selected from a set of prediction modes (e.g., selected at step 2620). The decoder may make the inference decision, for example, based on neighboring residual transformed coefficients, which may be associated with at least one already-coded neighboring transform node of the transform node. Referring to FIG. 26, at step 2610, the decoder may make the inference decision, for example, based on neighboring residual transformed coefficients (e.g., residual RAHT coefficients 2351). The neighboring residual RAHT coefficients 2351 may be, for example, residual RAHT coefficients associated with at least one already-coded neighboring RAHT node 2350 of the RAHT node 2501. For example, the inference decision may be based on information indicating the magnitudes (e.g., m_{k,Y}, m_{k,U}, and m_{k,V}) of neighboring residual transformed coefficients (e.g., residual RAHT coefficients 2351). For example, the inference decision may be made based on the information indicating the magnitudes being less than or equal to a threshold (e.g., small magnitudes). Small magnitudes may indicate that neighboring prediction modes 2352 (e.g., the prediction modes associated with at least one already-coded neighboring RAHT nodes 2350 of the RAHT node 2501) may be (e.g., are likely to be) accurate and the prediction mode 2521 may be inferred (e.g., at step 2630) from the neighboring prediction modes 2352.

At step 2630, the decoder may obtain an inferred prediction mode for the current node. The inferred prediction mode (e.g., p_{inf}) 2631 may be obtained, for example, based on determining a (e.g., most) common/used prediction mode among neighboring prediction modes 2352. The determination/selection of the (e.g., most) common/used prediction mode may be referred to as a majority voting process. Step 2630 may be performed identically as step 2440 of FIG. 24.

The inference decision (e.g., made at step 2610) may indicate the prediction mode 2521 being either the inferred prediction mode (e.g., p_{inf}) 2631 or the selected prediction mode (e.g., pₛₑ₁) 2621. The decoder may decode (e.g., entropy decode) (e.g., at step 2620) an indication of the selected prediction mode (e.g., pₛₑ₁) 2621, for example, if the inference decision indicates that the prediction mode 2521 is the selected prediction mode (e.g., pₛₑ₁) 2621. The decoder may decode (e.g., entropy decode) the indication of the selected prediction mode (e.g., pₛₑ₁) 2621, for example, as part of prediction mode information 2522, from bitstream 2590.

At step 2620, the decoder may decode a prediction mode for the current node. More specifically, the decoder may decode (e.g., entropy decode) the indication of the selected prediction mode (e.g., pₛₑ₁) 2621, for example, based on a context selected from a set of contexts. The context selection may be based on, for example, neighboring prediction modes 2352. The neighboring prediction modes 2352 may be, for example, prediction modes 2352 associated with at least one already-coded neighboring transform node (e.g., already-coded neighboring RAHT node 2350 of the RAHT node 2501). The prediction mode may be associated with the transform node and may be used for decoding attributes of (e.g., further) transform nodes. for example, the prediction mode 2521 may be associated with the RAHT node 2501 and may be used for decoding attributes of (e.g., further) RAHT nodes.

Referring back to FIG. 25, at step 2540, the decoder may decode (e.g., entropy decode) the residual of coefficients. More specifically, sets (e.g., {Cₖ}) of residual RAHT coefficients 2531 may be obtained by entropy decoding coefficient information 2542 from the bitstream 2590.

In some examples, the decoding (e.g., at step 2540) may comprise decoding a series of flags (e.g., {fₖ}) indicating if the sets (e.g., {Cₖ}) of residual transformed coefficients (e.g., residual RAHT coefficients 2531) are zero. The decoding may comprise decoding values of sets (e.g., C_{k,Y}, C_{k,U} and C_{k,V}), for example, after decoding the series of flags. The decoding values of sets (e.g., C_{k,Y}, C_{k,U} and C_{k,V}) may be performed, for example, based on (e.g., by) decoding flags (e.g., f_{k,Y}, f_{k,U} and f_{k,V}) indicating if respective values are zero, signs (e.g., s_{k,Y}, s_{k,U} and s_{k,V}) and magnitudes (or absolute values) (e.g., m_{k,Y}, m_{k,U} and m_{k,V}) for non-zero component coefficients in each of the sets.

The decoder may entropy decode the series of flags (e.g., {fₖ}) and/or the sets (e.g., {Cₖ}) of residual transformed coefficients (e.g., residual RAHT coefficients 2531), for example, based on a context selected from a set of contexts. The context selection may be based on neighboring prediction modes 2352.

The decoder may determine transformed coefficients (e.g., RAHT coefficients, Haar coefficients). The prediction mode may be applied to (e.g., used for) the transform node to obtain (e.g., compute or derive) sets of transformed coefficients. Referring to back to FIG. 25, at step 2530, the decoder may determine RAHT coefficients. The prediction mode 2521 may be applied to (e.g., used for) the RAHT node 2501 to obtain (e.g., compute or derive) sets of RAHT coefficients 2511. For example, the decoder may use the prediction mode 2521 to generate a predictor that may be added to the sets (e.g., {Cₖ}) of residual RAHT coefficients 2531 to obtain sets of RAHT coefficients 2511.

Generating (e.g., constructing) the predictor may be performed. Generating (e.g., constructing) the predictor may be performed, for example, based on the already-coded nodes neighboring nodes 2350 and their neighboring prediction modes 2352. For example, the constructed predictor may be an average predictor. The average predictor may be a linear combination of an intra predictor derived from an intra prediction mode and an inter predictor derived from an inter prediction mode. The weights in the linear combination may be determined. The weights in the linear combination may be determined, for example, based on neighboring prediction modes 2352.

The sets of transformed coefficients may be (e.g., all) inverse transformed (e.g., RAHT transformed, Haar transformed). At step 2510, for example, the sets of RAHT coefficients 2511 may be (e.g., all) inverse (e.g., RAHT) transformed. The sets of RAHT coefficients 2511 may be (e.g., all) inverse (e.g., RAHT) transformed, for example, to obtain decoded attributes 2505 associated with the RAHT node 2501.

Iterative transform (e.g., RAHT transform, Haar transform) may be performed. For example, the iterative RAHT transform may be performed in two phases. In a first phase, a bottom-up (or ascend) traversal of a RAHT tree (e.g., octree) may be performed. The RAHT tree may be an example of a transform tree. A bottom-up (or ascend) traversal of a RAHT tree (e.g., octree) may be performed, for example, to determine (e.g., compute) information (e.g., number/quantity of attributes, weights, inter predictor, etc.) of each of the RAHT nodes. In a second phase, the transform and coding may be performed according to a top-down (descend) traversal of the RAHT tree. Encoding and decoding of RAHT coefficients may be performed, for example, if the descend phase occurs. Encoding and decoding of RAHT coefficients may be performed during the descend phase, for example, because the inter-depth prediction may use information (e.g., weights) determined (e.g., computed) during the ascend phase and AC coefficients associated with already-coded neighboring RAHT nodes at the parent node depth of the current node. Inter-depth prediction may be coded down from the root node of the RAHT tree. Encoding and decoding of RAHT coefficients may start from the root RAHT node of the RAHT tree and may be performed depth per depth descending from the root node until leaf RAHT nodes (corresponding to voxels) may be reached. For each depth, the traversal of RAHT nodes may be in a specific order. For example, the traversal of RAHT nodes may follow a Morton order or a raster scan order.

The RAHT bitstream resulting from the encoding of RAHT coefficients may be constructed based on (e.g., according to) the traversal of the RAHT tree. A prediction mode may be selected and/or encoded in the RAHT bitstream, for example, for each RAHT node.

The prediction mode may be a null prediction mode, an intra prediction mode, or an inter prediction mode. A prediction mode (e.g., null, intra, inter) may be selected. A prediction mode (e.g., null, intra, inter) may be selected, for example, based on (e.g., by) minimizing a Rate Distortion Optimization (RDO) metric (e.g., selecting one prediction mode with the minimum RDO cost). The prediction mode (e.g., null, intra, inter) may be encoded in the RAHT bitstream, for example, by the RAHT encoding process. AC coefficients may be determined and/or encoded in the RAHT bitstream, for example, based on the selected prediction mode.

Decoding of transformed coefficients (e.g., RAHT coefficients) may follow the same traversal order as the encoding of transformed coefficients (e.g., RAHT coefficients).

Prediction modes and AC coefficients may be decoded in the same order as encoded by the encoding of transformed coefficients (e.g., RAHT coefficients).

A (e.g., large) portion of the bitstream 2390, 2590 may comprise the entropy coded indications of prediction modes 2321, 2521 associated with transform nodes (e.g., RAHT nodes 2301, 2501). The cost of the coding of an indication of a prediction mode 2321, 2521 may be reduced, for example, by inferring the prediction mode associated with the transform nodes (e.g., RAHT node 2301, 2501) to a predetermined prediction mode. For example, a fixed value may be used to indicate the predetermined prediction mode. The prediction mode associated with the RAHT node 2301, 2501 may be inferred to a predetermined prediction mode, for example, when/if the depth of the RAHT node 2301, 2501 is higher than a predetermined depth (e.g., a maximum depth) for prediction mode coding.

FIG. 27A shows an example of the top-down traversal of a transform process (e.g. RAHT process). More specifically, FIG. 27A shows the top-down traversal of the RAHT process 2700A when a threshold of a maximum depth for prediction mode coding 2710 may be used. Although FIG. 27A shows the top-down traversal of a RAHT process, the concepts illustrated in FIG. 27A may be applied to a top-down traversal of a transform process (e.g., RAHT process, Haar process). The RAHT process 2700A may be an example of a transform process. One or more steps of the example process 2700A may be performed and/or implemented by an encoder or a decoder (e.g., encoder 114 or decoder 120 of FIG. 1), an example computer system 3200 as described herein with respect to FIG. 32, and/or an example computing device 3330 as described herein with respect to FIG. 33. The encoder (or decoder) may associate an average prediction mode with the RAHT node 2301, 2501. The encoder (or decoder) may associate an average prediction mode with a transform node, for example, by comparing a transform depth (depth in the transform tree) of the transform node with the threshold of a maximum depth for prediction mode coding. For example, the encoder (or decoder) may associate an average prediction mode with the RAHT node 2301, 2501, for example, by comparing a RAHT depth 2702 (depth in the RAHT tree) of the RAHT node with the threshold of a maximum depth for prediction mode coding 2710.

The top-down traversal of the transform process (e.g., RAHT process) may start from a transform root node (e.g., RAHT root node 2700), for example, at depth zero). The transform root node (e.g., RAHT root node 2700) may be associated with an initial volume encompassing a portion of the decoded geometry of the point cloud. The decode geometry may be partitioned into a plurality of portions. Each of the plurality of portions may correspond to an initial volume and an associated transform root node (e.g., RAHT root node). Transform leaf nodes (e.g., RAHT leaf nodes 2701), for example at a final depth, corresponding to voxels may be reached. Transform leaf nodes (e.g., RAHT leaf nodes 2701) corresponding to voxels may be (e.g., eventually) reached, for example, following a breadth-first traversal of the transform tree (e.g., RAHT tree) (e.g. an octree) by proceeding depth per depth of the transform tree. Information representative of the selection of a prediction mode associated with the transform node (e.g., RAHT node 2301, 2501) may be coded (e.g., at step 2711) in the bitstream (e.g., bitstream 2390, 2590). Information representative of the selection of a prediction mode associated with the transform node (e.g., RAHT node 2301, 2501) may be coded in the bitstream 2390, 2590, for example, if/when the transform depth (e.g., RAHT depth 2702) of the transform node (e.g., RAHT node 2301, 2501) is lower than or equal to the maximum depth for prediction mode coding 2710. An indication of the selected prediction mode may be coded. No such information may be coded and, instead, the prediction mode associated with the transform node (e.g., RAHT node 2301, 2501) may be inferred to a predetermined prediction mode 2712, for example, if/when the transform depth (e.g., RAHT depth 2702) is higher than the maximum depth for prediction mode coding 2710. The prediction mode associated with the transform node (e.g., RAHT node 2301, 2501) may be inferred to a value indicating the intra prediction mode as shown, for example, in FIG. 27A. The choice of intra prediction mode may be reasonable because inter prediction tends to become less accurate for smaller nodes.

Inter prediction information may be relevant for transform nodes (e.g., RAHT nodes) with depths higher than the maximum depth for prediction mode coding 2710. For example, an average prediction mode may be used to propagate inter predictive information at depths higher than the maximum depth for prediction mode coding 2710.

For the transform node (e.g., RAHT node 2301, 2501), an average predictor derived based on the average prediction mode may be a linear combination of an intra predictor and an inter predictor as follows:

$$Pre {d}_{a v e r a g e} = μ * {Pred}_{intra} + ( 1 - μ ) * {Pred}_{inter} ( 0 \leq μ \leq 1 )$$

The weight μ of the linear combination may be determined based on the neighboring prediction modes 2352 of the transform node (e.g., RAHT node 2301, 2501).

Neighboring already-coded transform nodes (e.g., already-coded RAHT nodes) may include the parent node, the grand-parent node, spatially close already-coded transform nodes (e.g., RAHT nodes) having the same depth (e.g., cousin nodes), and/or spatially close already-coded transform nodes (e.g., already-coded RAHT nodes) having a depth minus one (e.g., uncle/aunt nodes), relative to the transform node (e.g., RAHT node 2301, 2501). The weight μ may be related to the proportion of intra prediction modes among the neighboring prediction modes 2352.

An average predictor may be associated with a transform nodes (e.g., RAHT node 2301, 2501). An average predictor may be associated with a RAHT node 2301, 2501, for example, depending on an activation status of the average prediction mode. The average predictor may be associated with the RAHT node 2301, 2501, for example, if/when (e.g., only if/when) the average prediction mode is activated. The average prediction mode may be activated, for example, based on an upper depth for average prediction mode 2720 and a lower depth for average prediction mode 2730 (see FIG. 27B). The upper depth for average prediction mode 2720 may be lower than or equal to the maximum depth for prediction mode coding 2710, and the lower depth for average prediction mode 2730 may be higher than the maximum depth for prediction mode coding 2710.

FIG. 27B shows an example of the top-down traversal of the RAHT process. More specifically, FIG. 27B shows the top-down traversal of the RAHT process 2700B when the maximum depth for prediction mode coding 2710, the upper depth for average prediction mode 2720, and the lower depth for average prediction mode 2730 may be used. Although FIG. 27B shows the top-down traversal of a RAHT process, the concepts illustrated in FIG. 27B may be applied to a top-down traversal of a transform process (e.g., RAHT process, Haar process). The RAHT process 2700B may be an example of a transform process. One or more steps of the example process 2700B may be performed and/or implemented by an encoder or a decoder (e.g., encoder 114 or decoder 120 of FIG. 1), an example computer system 3200 as described herein with respect to FIG. 32, and/or an example computing device 3330 as described herein with respect to FIG. 33.

The inter predictor derived based on the inter prediction mode may be replaced by the average predictor 2721. The inter predictor derived based on the inter prediction mode may be replaced by the average predictor 2721, for example, when/if the transform depth (e.g., RAHT depth 2702) of the transform node (e.g., RAHT node 2301, 2501) is between the upper depth for average prediction mode 2720 inclusive and the maximum depth for prediction mode coding 2710 inclusive, and the prediction mode 2321, 2521 obtained at steps 2320 and 2520 is an inter prediction mode. The average predictor 2721 may be derived, for example, based on the average prediction mode. The inter prediction mode may be replaced by an average prediction mode. The inter prediction mode may be replaced by an average prediction mode, for example, when/if the transform depth (e.g., RAHT depth 2702) of the transform node (e.g., RAHT node 2301, 2501) is between the upper depth for average prediction mode 2720 inclusive and the maximum depth for prediction mode coding 2710 inclusive, and the prediction mode 2321, 2521 obtained at steps 2320 and 2520 is an inter prediction mode. The indication of the prediction mode 2321, 2521 that is signaled in the bitstream 2390, 2590 as prediction mode information 2322, 2522 may still indicate an inter prediction mode for transform nodes (e.g., RAHT nodes, Haar nodes) at a transform depth (e.g., RAHT depth, Haar depth) between the upper depth 2720 inclusive and maximum depth 2710 inclusive.

The intra predictor derived based on the intra prediction mode may be replaced by the average predictor 2731. The intra predictor derived based on the intra prediction mode may be replaced by the average predictor 2731, for example, when/if the transform depth (e.g., RAHT depth 2702) of the transform node (e.g., RAHT node 2301, 2501) is between the maximum depth for prediction mode coding 2710 exclusive and the lower depth for average prediction mode 2730 inclusive, and the prediction mode 2321, 2521 obtained at steps 2320 and 2520 is an intra prediction mode. The average predictor 2731 may be derived, for example, based on the average prediction mode. The intra prediction mode may be replaced by an average prediction mode. The intra prediction mode may be replaced by an average prediction mode, for example, when/if the transform depth (e.g., RAHT depth 2702) of the transform node (e.g., RAHT node 2301, 2501) is between the maximum depth for prediction mode coding 2710 exclusive and the lower depth for average prediction mode 2730 inclusive, and the prediction mode 2321, 2521 obtained at steps 2320 and 2520 is an intra prediction mode. The indication of the prediction mode 2321, 2521 that is signaled in the bitstream 2390, 2590 as prediction mode information 2322, 2522 may still indicate an intra prediction mode for transform nodes (e.g., RAHT nodes, Haar nodes) at a transform depth (e.g., RAHT depth, Haar depth) between the maximum depth 2710 exclusive and lower depth 2730 inclusive.

The replacement of the inter prediction mode and/or intra prediction mode may imply that the best prediction mode as signaled in the bitstream (e.g., best prediction mode selected by the encoder) has been overwritten. More specifically, at higher transform (e.g., RAHT, Haar) depths such as at RAHT depths higher than the maximum depth for prediction mode coding 2710 (see e.g., FIG. 27A) or higher than the lower depth for average prediction mode 2730 (see e.g., FIG. 27B), all prediction modes may be inferred as an “intra prediction mode” even if an inter prediction mode would have been better. This process may induce the average predictor to become closer (e.g., with higher p) to the intra predictor than to the inter predictor, for example, because most indications of neighboring prediction modes 2352 may indicate intra prediction mode. One approach to mitigate this effect may be to extend the neighborhood of transform nodes (e.g., RAHT nodes 2301, 2501) to parent and grand-parent nodes in order to propagate inter prediction mode being the selected prediction mode from the top (lower transform depths) of the transform tree.

Nevertheless, the average predictor may (e.g., quickly) converge to be close to the intra predictor at transform (e.g., RAHT, Haar) depths higher than the maximum depth for prediction mode coding 2710 (see e.g., FIG. 27A) or higher than the lower depth for average prediction mode 2730 (see e.g., FIG. 27B). The accuracy of information of the reference frame used by inter prediction may be reduced, and a mostly-intra average predictor may be suboptimal when motion compensation is very accurate, for example, in static portions of the point cloud.

Moreover, determining the three depths (2710, 2720, 2730) to be provided by the encoder and coded in the bitstream may not be trivial and may be difficult to derive optimally. Simulations have shown that optimal values, for compression performance, of the three depths may depend on the content represented by point clouds. Contributing to the difficulty, optimal values of the three depths may depend on the intrinsic characteristics of portions of the point cloud (for example, a static portion vs a moving portion in the point cloud). The three depths may be provided uniformly for an entire brick (i.e., also referred to as a slice), associated with the transform (e.g., RAHT, Haar) root node of the transform (e.g., RAHT Haar) tree, that may include portions of the point cloud with different intrinsic characteristics.

The three depths 2710, 2720, 2730 may be intended to be representative of characteristics of the point cloud in terms of the transition between upper depths (closer to the transform root node), where inter prediction performs better than intra prediction, and lower depths (closer to the transform leaf nodes) where intra prediction performs better than inter prediction. An average prediction, that mixes both intra and inter predictions, may be introduced to smooth this transition. It has been observed, from coding experiments on various point clouds, that depth-driven transition may not be optimal because minor changes in any of the three depths 2710, 2720, 2730 may lead to significant compression performance change (e.g., up to 30%). Effective values (with high compression performance) for these three depths 2710, 2720, 2730 may be (e.g., very) instable and content dependent. It may be difficult to consistently determine effective values for the three depths 2710, 2720, 2730 that control when the average prediction mode is activated for encoding and decoding attributes of a point cloud.

Examples described herein may relate to improved point cloud attributes coding for a point cloud. The improved point cloud attributes coding may comprise determining an attribute prediction mode for coding attributes associated with a transform (e.g., RAHT, Haar) node.

The determining of the attribute prediction mode may be based on a weight. The weight may be based on a number/quantity of voxels contained in a volume associated with the transform (e.g., RAHT, Haar) node. The attribute prediction mode may be determined, for example, based on a comparison between the weight and a threshold (e.g., TH).

The weight may correspond to the number/quantity of voxels. For example, the weight may be (e.g., directly) proportional to the number/quantity of voxels. The weight may be (e.g., directly) proportional to the number/quantity of voxels such that a larger number of voxels indicates a larger weight. For example, the weight may be set to the number/quantity of voxels. For example, the weight may be obtained based on quantizing (e.g., by right shifting) the number of voxels.

Determining an attribute prediction mode using a weight that is based on the number/quantity of voxels contained in a volume associated with the transform (e.g., RAHT, Haar) node, rather than using the three depths described herein, may allow a reliable and/or adaptive determination of the attribute prediction mode, for example, compared to an attribute prediction mode determined based on the three depths. It may avoid determining the maximum depth for prediction mode coding 2710, the upper depth for average prediction mode 2720, and the lower depth for average prediction mode 2730 as described herein. Compression performance may be improved. Compression performance may have lower (e.g., much lower) sensitivity to the value of the threshold (e.g., threshold TH), for example, as compared to the compression performance of the method of the three depths 2710, 2720, 2730. Determining an attribute prediction mode based on the weight associated with the transform (e.g., RAHT, Haar) node, instead of the depth, may be more precise, for example, because the predictive accuracy of an inter predictor derived from an inter prediction mode may increase with the number/quantity of voxels for which attributes have been averaged (in the formula of AC and DC transformed coefficients) within a transform (e.g., RAHT, Haar) node. Even if depths and weights may be generally correlated, it happens that some nodes with a low depth (i.e., close to the root node) may have low weights. Determining the attribute prediction mode according to the weight may permit variation of attribute prediction mode (e.g., due to varying weights) for transform (e.g., RAHT, Haar) nodes at the same depth.

The weight being higher than the threshold may indicate that the attribute prediction mode may be determined as one prediction mode of a set of prediction modes. The weight being less than (or equal to) the threshold may indicate the attribute prediction mode being an average prediction mode that combines at least two prediction modes of the set of prediction modes.

The threshold (e.g., TH) may be encoded in a bitstream by an encoder. The threshold (e.g., TH) may be decoded from a bitstream by a decoder. The threshold (e.g., TH) may be encoded in or decoded from a sequence parameter set (SPS) for a point cloud frame. The threshold (e.g., TH) may be encoded in or decoded from an attribute parameter set (APS) for a sequence of point cloud frames (e.g., containing the point cloud frame corresponding to the point cloud). The threshold (e.g., TH) may be encoded in or decoded from an attribute brick header (ABH) for a volume associated with the transform (e.g., RAHT, Haar) tree. For example, slices (or bricks) may partition a volume of the point cloud frame and each of the slices may be associated with a respective ABH corresponding to a transform (e.g., RAHT, Haar) tree associated with the slice. The various parameter sets (e.g., SPS, APS, ABH, etc.) may be encoded in a bitstream by an encoder and/or obtained (e.g., decoded) by a decoder from the bitstream.

FIG. 27C shows an example of the top-down traversal of a RAHT process. FIG. 27C shows the top-down traversal of the RAHT process 2700C when the weight for mode selection may be used. Although FIG. 27C shows the top-down traversal of a RAHT process, the concepts illustrated in FIG. 27C may be applied to a top-down traversal of a transform process (e.g., RAHT process, Haar process). Accordingly, the RAHT process 2700C may be an example of a transform process. One or more steps of the example process 2700C may be performed and/or implemented by an encoder or a decoder (e.g., encoder 114 or decoder 120 of FIG. 1), an example computer system 3200 as described herein with respect to FIG. 32, and/or an example computing device 3330 as described herein with respect to FIG. 33. An attribute prediction mode may be determined as an intra prediction mode or an inter prediction mode 2713, for example, when/if a weight associated with a transform (e.g., RAHT, Haar) node is higher than a minimum weight for mode selection 2715.

Average prediction mode is not activated, for example, when/if a weight associated with a transform (e.g., RAHT, Haar) node is higher than a minimum weight for mode selection 2715. An attribute prediction mode may be determined as an average prediction mode, for example, when/if a weight associated with a transform (e.g., RAHT, Haar) node is lower than or equal to the minimum weight for mode selection 2715. The activation of the average prediction mode may depend locally on the weight associated with a transform (e.g., RAHT, Haar) node, for example, instead of a transform (e.g., RAHT, Haar) depth.

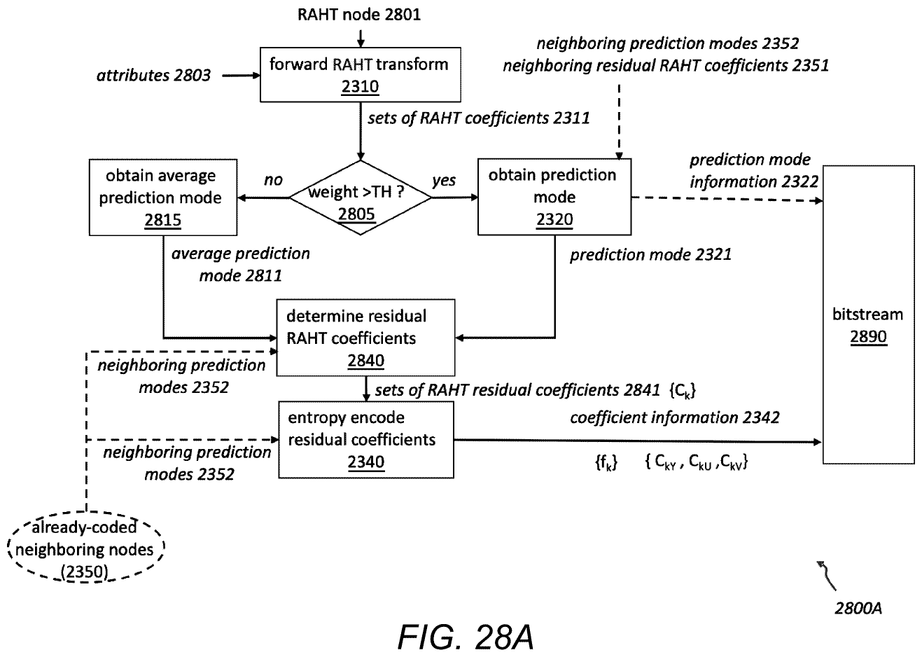

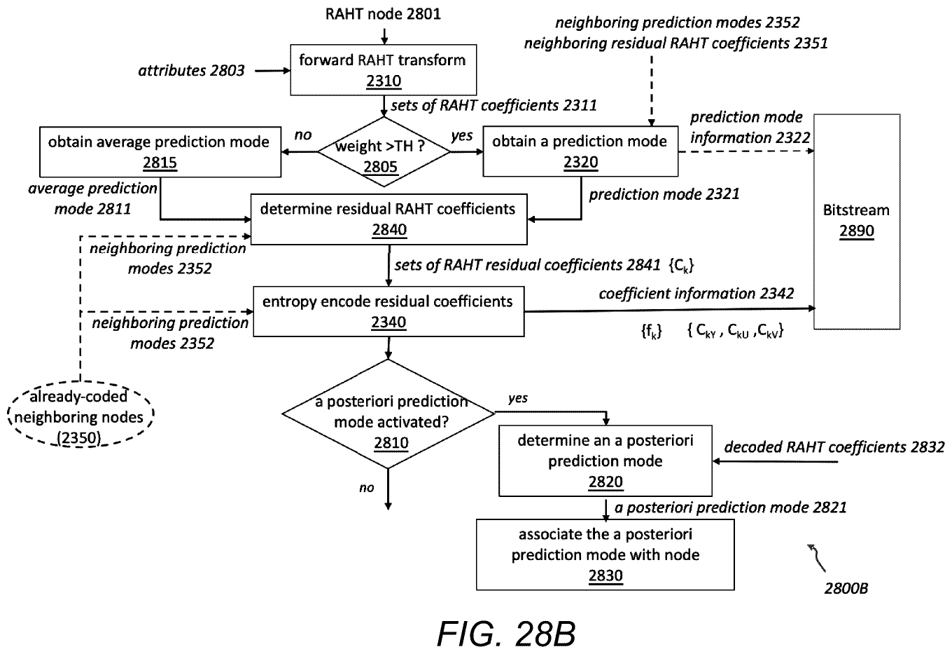

FIG. 28A shows an example method for encoding attributes. More specifically, FIG. 28A shows an example process 2800A for encoding, in a bitstream 2890, attributes of the RAHT node 2801 using an attribute prediction mode obtained based on a weight associated with the RAHT node 2801. Although FIG. 28A shows an example method for encoding attributes of a RAHT node, the example method may be generally applied for encoding attributes of a transform node (e.g., RAHT node, Haar node). Accordingly, the RAHT node 2801 may be an example of a transform node. The example process 2800A may be generally used for a transform (e.g., RAHT, Haar). One or more steps of the example process 2800A may be performed and/or implemented by an encoder (e.g., encoder 114 of FIG. 1), an example computer system 3200 as described herein with respect to FIG. 32, and/or an example computing device 3330 as described herein with respect to FIG. 33. The process 2800A may include some of the same operations (shown as having the same labeled steps) as those described herein with respect to FIG. 23 and FIG. 24. In some examples, steps 2805, 2815, and 2840 may represent components within the encoder.

The encoder may perform a forward transform (e.g., forward RAHT transform, forward Haar transform). For example, referring to FIG. 28A, at step 2310, the encoder may perform forward RAHT transform. For example, the encoder may transform attributes 2803 of the RAHT node 2801 to obtain sets of RAHT coefficients 2311.

The encoder may determine the attribute prediction mode for encoding the attributes associated with the transform node (e.g., transform node 2801). At step 2805, the encoder may determine the attribute prediction mode for encoding the attributes associated with the RAHT node 2801. The encoder may determine the attribute prediction mode for encoding the attributes associated with the transform node, for example, based on a weight associated with the transform node (e.g., RAHT node 2801). The weight may correspond to a number/quantity of voxels contained in a volume (e.g., including voxels on the boundary (face, vertex, and/or edge of the volume)) associated with the transform node (e.g., RAHT node 2801). The encoder may determine the attribute prediction mode, for example, by comparing the weight associated with the transform node (e.g., RAHT node 2801) with a threshold (e.g., TH). The encoder may determine the attribute prediction mode as being a prediction mode (e.g., the prediction mode 2321 as obtained at step 2320), for example, when/if the weight is higher than the threshold (e.g., TH). The encoder may determine the attribute prediction mode as being an average prediction mode (e.g., the average prediction mode 2811 as obtained at step 2815), for example, when/if the weight is less than (or equal to) the threshold (e.g., TH). The average prediction mode may combine at least two prediction modes of the set of prediction modes.

As described herein, the weight may correspond to the number/quantity of voxels and may be (e.g., directly) proportional to the number/quantity of voxels such that a larger number of voxels may indicate a larger weight. The weight may be set to the number of voxels. The weight may be obtained based on quantizing (e.g., by right shifting) the number of voxels.

At step 2320, the encoder may obtain the prediction mode 2321. The encoder may encode (e.g., entropy encode) an indication of the prediction mode 2321 as prediction mode information 2322 in the bitstream 2890. The encoder may encode (e.g., entropy encode) an indication of the prediction mode 2321 as prediction mode information 2322 in the bitstream 2890, for example, if the prediction mode 2321 is the selected prediction mode (e.g., pₛₑ₁) 2421. The inference decision (e.g., at step 2410) may indicate whether the prediction mode 2321 is the inferred prediction mode (e.g., p_{inf}) 2441 (e.g., obtained at step 2440) or the selected prediction mode (e.g., pₛₑ₁) 2421 selected from the set of prediction modes (e.g., at step 2420). The inference decision may be based on neighboring residual transformed coefficients (e.g., RAHT coefficients 2351). The indication of the selected prediction mode (e.g., pₛₑ₁) 2421 may be coded (e.g., entropy coded) based on a context selected from a set of contexts. The context selection may be based on neighboring prediction modes 2352. The set of prediction modes may include at least one intra prediction mode and at least one inter prediction mode. The set of prediction modes may include at least one intra prediction mode, at least one inter prediction mode, and a null prediction mode.

At step 2815, the encoder may obtain the average prediction mode 2811. The encoder may determine residual transformed coefficients (e.g., RAHT coefficients, Haar coefficients). For example, at step 2840, the encoder may determine residual RAHT coefficients. For example, the attribute prediction mode (e.g., either the prediction mode 2321 or the average prediction mode 2811) may be applied/used to/for the transform node (e.g., RAHT node 2801) to obtain (e.g., compute or derive) sets (e.g., {Cₖ}) of residual transformed coefficients (e.g., residual RAHT coefficients 2841) from the sets of transformed coefficients (e.g., RAHT coefficients 2311). The encoder may use the attribute prediction mode to generate a predictor that may be subtracted from the set of transformed coefficients (e.g., RAHT coefficients 2311) to obtain the sets (e.g., {Cₖ}) of residual transformed coefficients (e.g., residual RAHT coefficients 2841). The predictor derived from the average prediction mode 2811 may be a linear combination of an intra predictor derived from an intra prediction mode of the set of prediction modes and an inter predictor derived from an inter prediction mode of the set of prediction modes. The weights of the linear combination may be determined. The weights of the linear combination may be determined, for example, based on the neighboring prediction modes 2352. The neighboring prediction modes 2352 may include prediction modes associated with already-coded neighboring transform nodes (e.g., already-coded neighboring RAHT nodes 2350) of the transform node (e.g., RAHT node 2801). The already-coded neighboring transform nodes nodes of the transform node (e.g., RAHT node 2801) may include nodes that share a part of face, a part of an edge, or a vertex with the transform node. The already-coded neighboring transform nodes nodes of the transform node (e.g., RAHT node 2801) may include the parent node of the transform node. The already-coded neighboring transform nodes nodes of the transform (e.g., RAHT node 2801) may include nodes that may be siblings to the parent node of the transform node.

At step 2340, the encoder may (e.g., further) encode (e.g., entropy encode) residual coefficients. The encoder may (e.g., further) encode (e.g., entropy encode) the sets (e.g., {Cₖ}) of residual transformed coefficients (e.g., RAHT coefficients 2841) into the bitstream 2890 as coefficient information 2342. The residual coefficients may be encoded, for example, based on the neighboring prediction modes 2352.

FIG. 29A shows an example method for decoding attributes. More specifically, FIG. 29A shows an example process 2900A for decoding, from the bitstream 2990, attributes of a RAHT node 2901 using an attribute prediction mode obtained based on a weight associated with the RAHT node 2901. In some examples, step 2910 may represent components within the decoder. Although FIG. 29A shows an example method for decoding attributes of a RAHT node, the example method may be generally applied for decoding attributes of a transform node (e.g., RAHT node, Haar node). Accordingly, the RAHT node 2901 may be an example of a transform node. The example process 2900A may be generally used for a transform (e.g., RAHT, Haar). One or more steps of the example process 2900A may be performed and/or implemented by a decoder (e.g., decoder 120 of FIG. 1), an example computer system 3200 as described herein with respect to FIG. 32, and/or an example computing device 3330 as described herein with respect to FIG. 33. The bitstream 2990 may be typically obtained from the encoding method as shown in FIG. 28A. The process 2900A may include some of the same operations (shown as having the same labeled steps) as those described in FIG. 25, FIG. 26, and FIG. 28A.

At step 2805, the decoder may determine the attribute prediction mode for decoding the attributes associated with the transform node (e.g., RAHT node 2901). The decoder may determine the attribute prediction mode for decoding the attributes associated with the transform node (e.g., RAHT node 2901), for example, based on a weight associated with the transform node. For example, the weight may correspond to a number/quantity of voxels contained in a volume (e.g., including voxels on the boundary (face, vertex, and/or edge of the volume)) associated with the transform node (e.g., RAHT node 2901). The decoder may determine the attribute prediction mode, for example, by comparing the weight associated with the transform node (e.g., RAHT node 2901) with a threshold (e.g., TH). The decoder may determine the attribute prediction mode as being a prediction mode (e.g., the prediction mode 2521 as obtained at step 2520), for example, when/if the weight is higher the threshold (e.g., TH). The decoder may determine the attribute prediction mode as being an average prediction mode (e.g., the average prediction mode 2811 as obtained at step 2815), for example, when/if the weight is less than (or equal to) the threshold (e.g., TH). The average prediction mode may combine at least two prediction modes of the set of prediction modes.

At step 2520, the decoder may obtain the prediction mode 2521. The decoder may decode (e.g., entropy decode) an indication of the prediction mode 2521 as prediction mode information 2522 from the bitstream 2990. The decoder may decode (e.g., entropy decode) an indication of the prediction mode 2521 as prediction mode information 2522 from the bitstream 2990, for example, if the prediction mode 2521 is the selected prediction mode (e.g., pₛₑ₁) 2621. The inference decision (e.g., at step 2610) may indicate whether the prediction mode 2521 is the inferred prediction mode (e.g., p_{inf}) 2631 (e.g., obtained at step 2630) or the selected prediction mode (e.g., pₛₑ₁) 2621 selected from the set of prediction modes (e.g., at step 2620). The inference decision may be based on neighboring residual transformed coefficients (e.g., RAHT coefficients 2351). For example, the indication of the selected prediction mode (e.g., pₛₑ₁) 2621 may be coded (e.g., entropy coded) based on a context selected from a set of contexts. For example, the context selection may be based on neighboring prediction modes 2352. For example, the set of prediction modes may include at least one intra prediction mode and at least one inter prediction mode. For example, the set of prediction modes may include at least one intra prediction mode, at least one inter prediction mode, and a null prediction mode.

At step 2815, the decoder may obtain the average prediction mode 2811. At step 2540, the decoder may decode (e.g., entropy decode) residual of coefficients. The decoder may obtain sets (e.g., {Cₖ}) of residual transformed coefficients (e.g. residual RAHT coefficients 2531). The decoder may obtain sets (e.g., {Cₖ}) of residual transformed coefficients (e.g. residual RAHT coefficients 2531), for example, by decoding (e.g., entropy decoding) coefficient information 2542 from the bitstream 2990.

The decoder may determine transform (e.g., RAHT, Haar) coefficients. For example, at step 2910, the decoder may determine RAHT coefficients. The attribute prediction mode (e.g., either the prediction mode 2521 or the average prediction mode 2811) may be used/applied for/to the transform node (e.g., RAHT node 2901) to obtain (e.g., compute or derive) sets of transformed coefficients (e.g., RAHT coefficients 2911) from the sets (e.g., {Cₖ}) of residual transformed coefficients (e.g., residual RAHT coefficients 2531). The decoder may use the attribute prediction mode to generate a predictor that may be added with the sets (e.g., {Cₖ}) of residual transformed coefficients (e.g., residual RAHT coefficients 2531) to obtain the sets of transformed coefficients (e.g., RAHT coefficients 2911).

The predictor derived from the average prediction mode 2811 may be a linear combination of an intra predictor derived from an intra prediction mode of the set of prediction modes and an inter predictor derived from an inter prediction mode of the set of prediction modes.

The weights of the linear combination may be determined. The weights of the linear combination may be determined, for example, based on the neighboring prediction modes 2352. The neighboring prediction modes 2352 may include prediction modes associated with already-coded neighboring transform (e.g., RAHT, Haar) nodes. The neighboring prediction modes 2352 may include prediction modes associated with already-coded neighboring RAHT nodes (e.g., 2350) of the RAHT node 2901.

The decoder may perform an inverse transform (e.g., RAHT transform, Haar transform). For example, It step 2510, the decoder may perform inverse RAHT transform. The decoder may obtain decoded attributes 2505 by inverse transforming the sets of transformed coefficients (e.g., RAHT coefficients 2911).

The attribute prediction mode associated with each transform (e.g., RAHT, Haar) node of a same depth may be (e.g., adaptively) determined to be either the prediction mode 2321, 2521 or the average prediction mode 2811. The attribute prediction mode associated with each transform (e.g., RAHT, Haar) node of a same depth may be (e.g., adaptively) determined to be either the prediction mode 2321, 2521 or the average prediction mode 2811, for example, because the weights associated with the transform nodes may vary within a same depth of the transform (e.g., RAHT, Haar tree). The obtained prediction mode 2321, 2521 may not reflect the best prediction mode for a transform node, for example, when/if the average prediction mode is activated. Coding a next node may not be efficient because this coding may be based on neighboring prediction modes 2352 that do not necessarily indicate the best prediction modes. There may be several implications of applying/using the average prediction mode described herein that may negatively impact the compression performance. First, the choice of a context, based on the neighboring prediction modes 2352, for entropy coding the indication of the prediction mode 2321, 2521 or the residual transformed coefficients (e.g., RAHT coefficients 2351) may be suboptimal. Second, the construction of an average predictor (e.g., at steps 2330, 2530) or the average predictor of FIG. 27A or FIG. 27B, may be inaccurate because the parameter p is deduced based on likely non-optimal (i.e., resulting from using replaced prediction modes) neighboring prediction modes 2352.

Examples described herein may relate to improved point cloud attribute coding by determining and associating an a posteriori prediction mode with the transform (e.g., RAHT, Haar) node based on the a posteriori prediction mode being activated for the transform node. The a posteriori prediction mode may be activated, for example, based on the weight being lower than the threshold (e.g., TH). An a posteriori prediction mode may be determined, for example, when/if the a posteriori prediction mode is activated. One a posteriori prediction mode may be determined, for example, based on decoded transformed coefficients (e.g., RAHT coefficients) associated with the transform node. The a posteriori prediction mode may be associated with the transform (e.g., RAHT, Haar) node to ensure the correct choice of context based on the neighboring prediction modes 2352 and correct construction, for future transform nodes to be predicted, of the predictor (e.g., at steps 2830, 2910) based on the neighboring prediction modes 2352. The choice of context based on the neighboring prediction modes 2352 may be for entropy coding, for example, the indication of the prediction mode 2321, 2521, or the indication of the residual transformed coefficients (e.g., residual RAHT coefficients 2831, 2531).

FIG. 28B shows an example method for encoding attributes. More specifically, FIG. 28B shows an example process 2800B for encoding, in a bitstream 2890, attributes of the RAHT node 2801 using an attribute prediction mode and one a posteriori prediction mode associated with the RAHT node 2801 obtained based on a weight associated with the RAHT node 2801. Although FIG. 28B shows an example method for encoding attributes of a RAHT node, the example method may be generally applied for encoding attributes of a transform node (e.g., RAHT node, Haar node) using an attribute prediction mode and one a posteriori prediction mode associated with the transform node. Accordingly, the RAHT node 2801 may be an example of a transform node. The example process 2800B may be generally used for a transform (e.g., RAHT, Haar). One or more steps of the example process 2800B may be performed and/or implemented by an encoder (e.g., encoder 114 of FIG. 1), an example computer system 3200 as described herein with respect to FIG. 32, and/or an example computing device 3330 as described herein with respect to FIG. 33. The process 2800B may include some of the same operations (shown as having the same labeled steps) as those described in FIG. 28A. In some examples, steps 2810, 2820 and 2830 may represent components within the encoder.

The encoder may (e.g., further) determine a posteriori prediction mode and may associate an a posteriori prediction mode with a transform (e.g., RAHT, Haar) node. For example, the encoder may (e.g., further) determine a posteriori prediction mode 2821 and may associate the a posteriori prediction mode 2821 with the RAHT node 2801. The encoder may (e.g., further) determine the a posteriori prediction mode 2821 and may associate the a posteriori prediction mode 2821 with the transform node (e.g., RAHT node 2801), for example, after the sets (e.g., {Cₖ}) of residual transformed coefficients (e.g., RAHT coefficients 2841) have been entropy encoded (e.g., at step 2340) into the bitstream 2890.

The encoder may determine (e.g., decide) whether an a posteriori prediction mode is activated for a transform (e.g., RAHT, Haar) node or not. For example, at step 2810, the encoder may determine (e.g., decide) whether an a posteriori prediction mode is activated for the RAHT node 2801 or not. The transform node associated with the prediction mode 2321 may be considered as an already-coded neighboring transform node of a (e.g., further) transform node to be processed and the process 2800B may end. The RAHT node 2801 associated with the prediction mode 2321 may be considered as an already-coded neighboring RAHT node of a (e.g., further) RAHT node to be processed and the process 2800B may end, for example, if it is determined that the a posteriori prediction mode is not activated. At step 2820, the encoder may determine an a posteriori prediction mode 2821. The encoder may determine the a posteriori prediction mode 2821, for example, if it is determined that the a posteriori prediction mode is activated. The encoder may determine the a posteriori prediction mode 2821, for example, based on decoded transformed coefficients (e.g., RAHT coefficients 2832) associated with the transform node (e.g., RAHT node 2801) as described herein. The decoded transformed coefficients (e.g., RAHT coefficients 2832) may be obtained as follows. First, sets of decoded transformed coefficients of the transform node (e.g., RAHT coefficients of the RAHT node 2801) may be obtained. The sets of decoded transformed (e.g., RAHT) coefficients may be the sets of the transformed coefficients (e.g., RAHT coefficients 2311), for example, when/if the sets of transformed residual coefficients (e.g., RAHT residual coefficients 2841) are not quantized before being entropy encoded. The sets of decoded transform coefficients of the transform node may be inverse quantized. The sets of decoded transformed coefficients (e.g., RAHT coefficients) of the transform node (e.g., RAHT node 2801) may be inverse quantized, for example, when/if the sets of RAHT residual coefficients 2841 are quantized before being entropy encoded. Second, the prediction mode 2321 may be used to generate a predictor of the sets of RAHT coefficients of the RAHT node 2801. The predictor of the sets of transformed coefficients (e.g., RAHT coefficients) of the transform node (e.g., RAHT node 2801) may be added to the sets of residual transformed coefficients (e.g., residual RAHT coefficients 2531) to obtain the sets of decoded transformed coefficients (e.g., RAHT coefficients) of the transform node (e.g., RAHT node 2801).

At step 2830, the encoder may associate a posteriori prediction mode 2821 with the RAHT node 2801. An indication of the a posteriori prediction mode 2821 may be saved as a parameter for the RAHT node 2801. The RAHT node 2801 associated with the a posteriori prediction mode 2821 may be considered as being an already-coded neighboring RAHT node of a further RAHT node to be processed and the process 2800B may end.

FIG. 29B shows an example method for decoding attributes. More specifically, FIG. 29B shows an example process 2900B for decoding, from the bitstream 2990, attributes of a RAHT node 2901 using an attribute prediction mode and one a posteriori prediction mode associated with the RAHT node 2901 obtained based on a weight associated with the RAHT node 2901. In some examples, step 2910 may represent components within the decoder. Although FIG. 29B shows an example method for decoding attributes of a RAHT node, the example method may be generally applied for decoding attributes of a transform node (e.g., RAHT node, Haar node) using an attribute prediction mode and one a posteriori prediction mode associated with the transform node. Accordingly, the RAHT node 2901 may be an example of a transform node. The example process 2900B may be generally used for a transform (e.g., RAHT, Haar). One or more steps of the example process 2900B may be performed and/or implemented by a decoder (e.g., decoder 120 of FIG. 1), an example computer system 3200 as described herein with respect to FIG. 32, and/or an example computing device 3330 as described herein with respect to FIG. 33. The bitstream 2990 may be typically obtained from the encoding method as shown herein with respect to FIG. 28B. The process 2900B may include some of the same operations (shown as having the same labeled steps) as those described in FIG. 29A, FIG. 28B.

The decoder may (e.g., further) determine an a posteriori prediction mode and may associate the a posteriori prediction mode with a transform (e.g., RAHT, Haar) node. The decoder may (e.g., further) determine a posteriori prediction mode 2821 and may associate the a posteriori prediction mode 2821 with the transform node (e.g., RAHT node 2901).

The decoder may (e.g., further) determine a posteriori prediction mode 2821 and may associate the a posteriori prediction mode 2821 with the transform node (e.g., RAHT node 2901), for example, after the decoded attributes 2505 have been obtained (e.g., at step 2510).

At step 2810, the decoder may determine (e.g., decide) whether the a posteriori prediction mode is activated for the transform node (e.g., RAHT node 2901) or not. The transform node (e.g., RAHT node 2901) associated with the prediction mode 2321 may be considered as an already-coded neighboring transform node of a (e.g., further) transform node to be processed and the process 2900B may end, for example, if it is determined the a posteriori prediction mode is not activated. At step 2820, the decoder may determine the posteriori prediction mode 2821. The decoder may determine the posteriori prediction mode 2821, for example, if the decoder determines that the a posteriori prediction mode is activated. The decoder may determine the a posteriori prediction mode 2821, for example, based on decoded transformed coefficients (e.g., RAHT coefficients 2832) associated with the transform node (e.g., RAHT node 2801) as described herein. The decoded transformed coefficients (e.g., RAHT coefficients 2832) may be the sets of transformed coefficients (e.g., RAHT coefficients 2911). The sets of decoded transformed coefficients (e.g., RAHT coefficients) of the transform node (e.g., RAHT node 2801) may be inverse quantized. The sets of decoded transformed coefficients (e.g., RAHT coefficients) of the transform node (e.g., RAHT node 2801) may be inverse quantized, for example, when/if the sets of transformed residual coefficients (e.g., RAHT residual coefficients 2841) are quantized before entropy encoded. The prediction mode 2521 may be used to generate a predictor of the sets of transformed coefficients (e.g., RAHT coefficients) of the transform node (e.g., RAHT node 2901). The predictor of the sets of transformed coefficients (e.g., RAHT coefficients) of the transform node (e.g., RAHT node 2901) may be added to the sets of (dequantized) residual transformed coefficients (e.g., residual RAHT coefficients 2531) to obtain the sets of decoded transformed coefficients (e.g., RAHT coefficients) of the transform node (e.g., RAHT node 2801).

The decoder may associate an a posteriori prediction mode with the transform (e.g., RAHT, Haar) node. For example, at step 2830, the decoder may associate a posteriori prediction mode 2821 with the RAHT node 2901. An indication of the a posteriori prediction mode 2821 may be saved as a parameter for the transform node (e.g., RAHT node 2901). The transform node (e.g., RAHT node 2901) associated with the a posteriori prediction mode 2821 may be considered as being an already-coded neighboring transform (e.g., RAHT, Haar) node of a further transform node to be processed and the process 2900B may end.

The a posteriori prediction mode 2821 may be determined (e.g., at step 2820) as one of the prediction modes of a set of prediction modes. The set of prediction modes may include at least one intra prediction mode and/or at least one inter prediction mode and/or a null mode. Examples of intra and inter prediction modes are described herein. Determining the a posteriori prediction mode 2821 (e.g., at step 2820) may include calculating distances (e.g., representing distortions) for respective prediction modes of the set of prediction modes.

Determining the a posteriori prediction mode 2821 (e.g., at step 2820) may include determining the a posteriori prediction mode 2821 as being the prediction mode with the minimum distance. Each distance of the distances (e.g., distances representing distortions) may be calculated. Each distance of the distances may be calculated, for example, based on (e.g., between) decoded attribute information of the transform node (e.g., RAHT node 2801, 2901) derived from the decoded transformed coefficients (e.g., RAHT coefficients 2832) and a prediction of the decoded attribute information of the transform node (e.g., RAHT node 2801, 2901) derived from a respective prediction mode of the set of prediction modes. By doing so, both encoder and decoder may determine the same a posteriori prediction mode. Synchronization between encoding and decoding processes may be realized (e.g., ensured).

The decoded attribute information of the transform node (e.g., RAHT node 2801, 2901) may include decoded attributes associated with the transform node (e.g., RAHT node 2801, 2901). The decoded attributes associated with the transform node (e.g., RAHT node 2801, 2901) may be determined (e.g., derived). The decoded attributes associated with the transform node (e.g., RAHT node 2801, 2901) may be determined (e.g., derived), for example, based on (e.g., from) the decoded transformed coefficients (e.g., RAHT coefficients 2832). The prediction of the decoded attribute information of the transform node (e.g., RAHT node 2801, 2901) may include predicted decoded attributes associated with the transform node (e.g., RAHT node 2801, 2901). The predicted decoded attributes associated with the transform node (e.g., RAHT node 2801, 2901) maybe determined (e.g., derived). The predicted decoded attributes associated with the transform node (e.g., RAHT node 2801, 2901) may be determined (e.g., derived), for example, based on the prediction mode of the set of prediction modes. Each distance may be determined (e.g., calculated) based on (e.g., between) the decoded attributes of the transform node (e.g., RAHT node 2801, 2901) and the predicted decoded attributes.

Process 2800B (FIG. 28B) may obtain the decoded attribute information of the transform (e.g., RAHT, Haar) node by decoding attributes of the transform node using the same process as process 2900B in FIG. 29B as described herein. For example, process 2800B (FIG. 28B) may obtain the decoded attribute information of the RAHT node 2801 by decoding attributes of the RAHT node 2801 using the same process as process 2900B in FIG. 29B as described herein. The prediction mode 2321, corresponding to prediction mode 2521 obtained at the decoder, may be used to generate (e.g., at step 2330) a prediction that may be added to the sets of residual transformed coefficients (e.g., RAHT coefficients 2331) to obtain sets of decoded transformed coefficients (e.g., RAHT coefficients). The prediction mode 2321 may be used to generate a prediction that may be added to the sets of residual transformed coefficients (e.g., residual RAHT coefficients 2331), for example, after decoding the coefficient information 2342 encoding the sets of residual transformed coefficients (e.g., residual RAHT coefficients 2331). The decoded attributes associated with the transform node (e.g., RAHT node 2801) may be obtained, for example, by inverse transforming (e.g., step 2510) the sets of decoded transformed coefficients (e.g., RAHT coefficients).

The prediction of the decoded attribute information of the transform node (e.g., RAHT node 2801, 2901) may be determined. The prediction of the decoded attribute information of the transform node (e.g., RAHT node 2801, 2901) may be determined (e.g., derived), for example, based on decoded attribute information of child transform nodes (e.g., nodes j) of the transform node (e.g., RAHT node 2801, 2901).

The distance may be a sum of errors (e.g., differences) over the child transform nodes of the transform node (e.g., RAHT node 2801, 2901). Each error may be defined between decoded attribute information of a respective child transform node (e.g., node j) of the child transform node (e.g., RAHT nodes_and the decoded attribute information associated with the transform node (e.g., RAHT node 2801, 2901). The sum of errors may be an absolute difference (e.g., SAD) or a sum of squared difference (e.g., SSE).

The decoded attribute information of a child transform node (e.g., node j) may be determined (e.g., derived). The sets of (decoded) transformed coefficients (e.g., RAHT coefficients) of the transform node (e.g., RAHT node 2801, 2901) may include decoded AC coefficients and a decoded DC coefficient. The decoded DC coefficient may be from (e.g., inherited from) the transform node (e.g., RAHT node 2801, 2901) as described herein. Decoded DC coefficients (e.g., cⱼ) may be obtained for each child transform node (e.g., node j) of the sets of decoded transformed coefficients (e.g., RAHT coefficients) of the transform node (e.g., RAHT node 2801, 2901). Decoded DC coefficients (e.g., cⱼ) may be obtained for each child transform node (e.g., node j) of the sets of decoded transformed coefficients (e.g., RAHT coefficients) of the transform node (e.g., RAHT node 2801, 2901), for example, by applying/using an inverse transform (e.g., RAHT transform, Haar transform) to/for the transform node (e.g., RAHT node 2801, 2901). The decoded attribute information of a child transform nodes (e.g., node j) may be the decoded transformed coefficient (e.g., cⱼ). The decoded transform coefficient (e.g., cⱼ) may be the sum of attribute values, associated with voxels contained in the volume associated with the child transform node (e.g., node j), divided by the square root of a number/quantity of attributes (i.e., the square root of the transform (e.g., RAHT) weight of the child transform node j) as described herein.

The decoded attribute information of a child transform node (e.g., node j) of the transform node (e.g., RAHT node 2801, 2901) may be the mean attribute of the child transform node (e.g., node j) of the transform node (e.g., RAHT node 2801, 2901). The mean attribute of the child transform node (e.g., node j) of the transform node (e.g., RAHT node 2801, 2901) may be determined (e.g., derived) by dividing the decoded DC coefficient (e.g., cⱼ) by the square root of the number/quantity of attributes (i.e., the square root of the transform weight of the child node). A decoded transformed coefficient (e.g., c) associated with the transform node (e.g., RAHT node 2801, 2901) may be the sum of attribute values, associated with voxels contained in the volume associated with the transform node (e.g., RAHT node 2801, 2901), divided by the square root of a number/quantity of attributes (i.e., the square root of the RAHT weight of the RAHT node j) as described herein.

Each error may be determined (e.g., calculated) based on (e.g., between) the mean attribute (e.g., c) of the transform (e.g., RAHT, Haar) node and a prediction. The prediction may be determined (e.g., derived), for example, based on the mean attribute of a child transform node (e.g., node j) of the transform node (e.g., RAHT node 2801, 2901). An intra prediction of a child transform node (e.g., node j) of the transform node (e.g., RAHT node 2801, 2901) may be determined (e.g., derived). An intra prediction of a child RAHT node (e.g., node j) of the RAHT node 2801, 2901 may be determined (e.g., derived), for example, by interpolation of the mean attribute associated with each child RAHT node (e.g., node j) (e.g., as depicted for example in FIG. 22). An inter prediction of a child transform node (e.g., node j) of the transform (e.g., RAHT node 2801, 2901) may be obtained. An inter prediction of a child transform node (e.g., node j) of the transform node (e.g., RAHT node 2801, 2901) may be obtained, for example, by motion compensation of a reference frame in the mean attribute domain and obtaining mean attribute values for each child node (e.g., node j) of the transform node (e.g., RAHT node 2801, 2901). A first distance may be determined (e.g., calculated) based on (e.g., between) the intra prediction and the mean attributes of the transform node (e.g., RAHT node 2801, 2901). A second distance may be determined (e.g., calculated) based on (e.g., between) the inter prediction and the mean attribute of the transform node (e.g., RAHT node 2801, 2901). The a posteriori prediction mode 2821 may be determined as the intra predictor. The a posteriori prediction mode 2821 may be determined as the intra predictor, for example, if the first distance is lower than the second distance. The a posteriori prediction mode 2821 may be determined as the inter predictor, for example, if the first distance is higher than or equal to the second distance.

Already-coded transform (e.g., RAHT, Haar) nodes and their associated a posteriori prediction mode 2821 may be used to determine (e.g., construct) an average predictor (e.g., Pred_{average}) for a transform node (e.g., RAHT node 2801, 2901). The average predictor (e.g., Pred_{average}) may be, for example, representing average prediction mode 2811. The average predictor Pred_{average} may be obtained as a linear combination, of an intra predictor Predᵢₙₜᵣₐ derived from an intra prediction mode and an inter predictor Predᵢₙₜₑᵣ derived from an inter prediction mode, depending on a parameter p:

$$P r e {d}_{a v e r a g e} = μ * {Pred}_{intra} + ( 1 - μ ) * {Pred}_{inter}$$

The parameter μ may be determined, for example, based on the neighboring prediction modes 2352. At least a part of the neighboring prediction modes 2352 may include one or more a posteriori prediction modes 2821, of one or more neighboring transform (e.g., RAHT, Haar) nodes. The one or more a posteriori prediction modes 2821 may indicate the one or more respective (e.g., best) selected prediction modes. The selected prediction modes may be, for example, a best prediction mode being selected from a set of prediction modes (e.g., intra or inter or NULL prediction mode). By doing so, the parameter μ of the average predictor for a transform (e.g., RAHT, Haar) node may be determined more accurately based on neighboring prediction modes 2352. The parameter μ of the average predictor for a transform (e.g., RAHT, Haar) node may be determined more accurately, for example, because one or more of neighboring prediction modes 2352 may be obtained as one or more respective a posteriori prediction modes, which may be more accurate indications of which of intra predictors or inter predictors may be locally better. The quality of the average predictor may be thus improved as well as compression performance. The parameter μ may have a positive correlation with the proportion of neighboring prediction modes 2352, which may be obtained from a posteriori prediction modes 2821 if activated, being intra modes.

When/if the a posteriori prediction mode is activated, neighboring prediction modes 2352 may be more likely to reflect the true, best prediction mode and improve context selection of entropy coding of indication of prediction mode 2321, 2521 associated with the transform node (e.g., RAHT node 2801, 2901) and/or of sets of residual transformed coefficients (e.g residual RAHT coefficients 2841, 2531), and/or improve determining the set of transformed coefficients (e.g., RAHT coefficients 2840, 2910). The selection of a context may be performed more accurately based on neighboring prediction modes 2352 because one or more of neighboring prediction modes 2352 may be obtained as one or more respective a posteriori prediction modes, which may be more accurate indications of which of intra predictors or inter predictors may be locally better. The quality of context selection may be thus improved as well as compression performance. The set of prediction modes may include at least one intra mode and/or at least one inter mode and/or a null prediction mode.

FIG. 30 shows an example method for encoding attributes of a RAHT node. More specifically, FIG. 30 shows a flowchart 3000 of an example method for encoding, in a bitstream, attributes of the RAHT node using an attribute prediction mode. Although FIG. 30 shows an example method for encoding attributes of a RAHT node, the example method may be generally applied for encoding attributes of a transform node (e.g., RAHT node, Haar node) using an attribute prediction mode. The attribute prediction mode may be obtained, for example, based on a weight associated with the transform (e.g., RAHT, Haar) node. Accordingly, the RAHT node may be an example of a transform node. The example method may be generally used for a transform (e.g., RAHT, Haar). One or more steps of the example method (e.g., flowchart 3000) may be performed and/or implemented by an encoder (e.g., encoder 114 of FIG. 1), an example computer system 3200 as described herein with respect to FIG. 32, and/or an example computing device 3330 as described herein with respect to FIG. 33.

The encoder may obtain a weight associated with a transform (e.g., RAHT, Haar) node of a transform tree. For example, at step 3002, the encoder may obtain a weight associated with a RAHT node of a RAHT tree. The encoder may obtain a weight associated with a transform node of a transform tree, for example, based on a number/quantity of voxels contained in a volume associated with the transform (e.g., RAHT, Haar) node. The weight may correspond to the number/quantity of voxels. The weight may be (e.g., directly) proportional to the number/quantity of voxels, as described herein with respect to FIGS. 28-29.

At step 3004, the encoder may determine an attribute prediction mode. The encoder may determine an attribute prediction mode, for example, based on the weight associated with a transform (e.g., RAHT, Haar) node. The encoder may determine the attribute prediction mode as being selected from a set of prediction modes or being an average prediction mode based on comparing the weight to the threshold, as described herein with respect to FIGS. 28-29.

The encoder may encode, in a bitstream, attributes associated with the transform (e.g., RAHT, Haar) node. For example, at step 3006, the encoder may encode, in a bitstream, attributes associated with the RAHT node. The encoder may encode attributes associated with the transform (e.g., RAHT, Haar) node, for example, based on the attribute prediction mode.

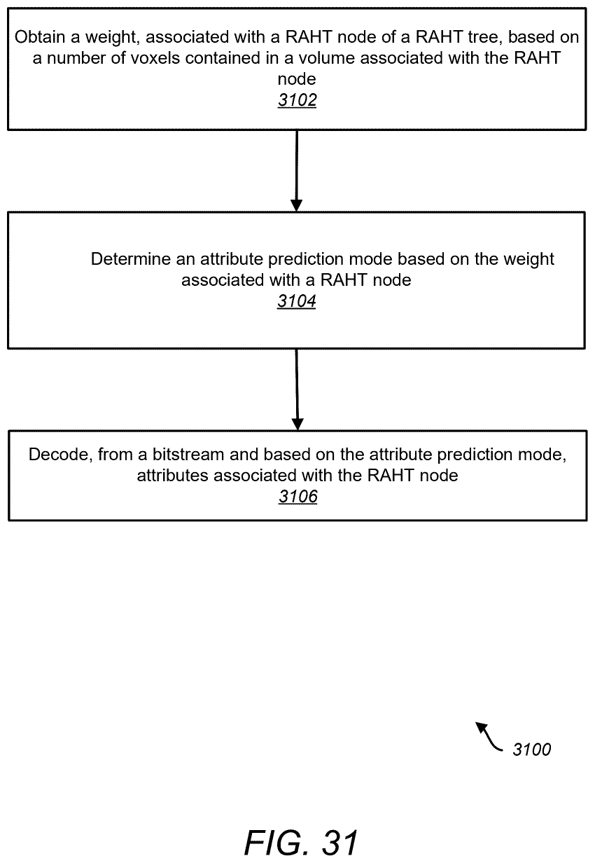

FIG. 31 shows an example method for decoding attributes of a RAHT node. More specifically, FIG. 31 shows a flowchart 3100 of an example method for decoding, from a bitstream, attributes of the RAHT node using an attribute prediction mode. The attribute prediction mode may be obtained, for example, based on a weight associated with the RAHT node. Although FIG. 31 shows an example method for decoding attributes of a RAHT node, the example method may be generally applied for decoding attributes of a transform node (e.g., RAHT node, Haar node) using an attribute prediction mode. Accordingly, the RAHT node may be an example of a transform node. The example method may be generally used for a transform (e.g., RAHT, Haar). One or more steps of the example method (e.g., flowchart 3100) may be performed and/or implemented by a decoder (e.g., decoder 120 of FIG. 1), an example computer system 3200 as described herein with respect to FIG. 32, and/or an example computing device 3330 as described herein with respect to FIG. 33.

The decoder may obtain a weight associated with a transform (e.g., RAHT, Haar) node of a transform tree. For example, at step 3102, the decoder may obtain a weight associated with a RAHT node of a RAHT tree. The decoder may obtain a weight associated with a transform node of a transform tree, for example, based on a number/quantity of voxels contained in a volume associated with the transform (e.g., RAHT, Haar) node. The weight may correspond to the number/quantity of voxels. The weight may be (e.g., directly) proportional to the number/quantity of voxels, as described herein with respect to FIGS. 28-29.

At step 3104, the decoder may determine an attribute prediction mode. The decoder may determine an attribute prediction mode, for example, based on the weight associated with a transform (e.g., RAHT, Haar) node. The decoder may determine the attribute prediction mode as being selected from a set of prediction modes or being an average prediction mode based on comparing the weight to the threshold, as described herein with respect to FIGS. 28-29.

At step 3106, the decoder may decode, from a bitstream, attributes associated with the transform (e.g., RAHT, Haar) node. The decoder may decode attributes associated with the transform (e.g., RAHT, Haar) node, for example, based on the attribute prediction mode.

Features of the present disclosure may generally apply to a transform. The transform may comprise a RAHT transform as described in the examples herein. The transform may comprise a Haar transform associated with lossless coding. For example, the term RAHT transform in the present disclosure may be equivalent to a transform. The RAHT node in the present disclosure may be equivalent to a transform node. The RAHT tree in the present disclosure may be equivalent to a transform tree. The RAHT coefficient in the present disclosure may be equivalent to a transformed coefficient.

Features of the present disclosure may be implemented in hardware using analog and/or digital circuits, in software, through the execution of instructions by one or more general purpose or special-purpose processors, or as a combination of hardware and software. Consequently, features of the present disclosure may be implemented in the environment of a computer system or other processing system. An example of such a computer system 3200 is shown in FIG. 32. FIG. 32 shows an example computer system in which examples of the present disclosure may be implemented. For example, the example computer system 3200 shown in FIG. 32 may implement one or more of the methods described herein. For example, various devices and/or systems described herein (e.g., in FIGS. 1, 10-18, 23-26, and 28-29) may be implemented in the form of one or more computer systems 3200. Furthermore, each of the steps of the flowcharts depicted in this disclosure may be implemented on one or more computer systems 3200. If/when more than one computer system 3200 is used to implement features of the present disclosure, the computer systems 3200 may be interconnected by one or more networks to form a cluster of computer systems that may act as a single pool of seamless resources. The interconnected computer systems 3200 may form a “cloud” of computers.

The computer system 3200 may comprise one or more processors, such as a processor 3204. The processor 3204 may be a special purpose processor, a general purpose processor, a microprocessor, and/or a digital signal processor. The processor 3204 may be connected to a communication infrastructure 3202 (e.g., a bus or network). The computer system 3200 may also comprise a main memory 3206 (e.g., a random access memory (RAM)) and/or a secondary memory 3208.

The secondary memory 3208 may comprise a hard disk drive 3210 and/or a removable storage drive 3212 (e.g., a magnetic tape drive, an optical disk drive, and/or the like). The removable storage drive 3212 may read from and/or write to a removable storage unit 3216. The removable storage unit 3216 may comprise a magnetic tape, an optical disk, and/or the like. The removable storage unit 3216 may be read by and/or may be written to the removable storage drive 3212. The removable storage unit 3216 may comprise a computer usable storage medium having stored therein computer software and/or data.

The secondary memory 3208 may comprise other similar means for allowing computer programs or other instructions to be loaded into the computer system 3200. Such means may include a removable storage unit 3218 and/or an interface 3214. Examples of such means may comprise a program cartridge and/or a cartridge interface (such as in video game devices), a removable memory chip (such as an erasable programmable read-only memory (EPROM) or a programmable read-only memory (PROM)) and associated socket, a thumb drive and USB port, and/or other removable storage units 3218 and interfaces 3214 which may allow software and/or data to be transferred from the removable storage unit 3218 to the computer system 3200.

The computer system 3200 may also comprise a communications interface 3220. The communications interface 3220 may allow software and data to be transferred between the computer system 3200 and external devices. Examples of the communications interface 3220 may include a modem, a network interface (e.g., an Ethernet card), a communications port, etc. Software and/or data transferred via the communications interface 3220 may be in the form of signals which may be electronic, electromagnetic, optical, and/or other signals capable of being received by the communications interface 3220. The signals may be provided to the communications interface 3220 via a communications path 3222. The communications path 3222 may carry signals and may be implemented using wire or cable, fiber optics, a phone line, a cellular phone link, an RF link, and/or any other communications channel(s).

The computer system 3200 may also comprise one or more sensor(s) 3224. The sensor(s) 3224 may measure or detect one or more physical quantities and convert the measured or detected physical quantities into an electrical signal in digital and/or analog form. For example, the sensor(s) 3224 may include an eye tracking sensor to track the eye movement of a user. A display of a point cloud may be updated, for example, based on the eye movement of a user. The sensor(s) 3224 may include a head tracking sensor to track the head movement of a user. A display of a point cloud may be updated, for example, based on the head movement of a user. The sensor(s) 3224 may include a camera sensor for taking photographs and/or a 3D scanning device (e.g., a laser scanning device, a structured light scanning device, and/or a modulated light scanning device). The 3D scanning devices may determine geometry information by moving one or more laser heads, structured light, and/or modulated light cameras relative to the object or scene being scanned. The geometry information may be used to construct a point cloud.

A computer program medium and/or a computer readable medium may be used to refer to tangible storage media, such as removable storage units 3216 and 3218 or a hard disk installed in the hard disk drive 3210. The computer program products may be means for providing software to the computer system 3200. The computer programs (which may also be called computer control logic) may be stored in the main memory 3206 and/or the secondary memory 3208. The computer programs may be received via the communications interface 3220. Such computer programs, when executed, may enable the computer system 3200 to implement the present disclosure as discussed herein. In particular, the computer programs, when executed, may enable the processor 3204 to implement the processes of the present disclosure, such as any of the methods described herein. Accordingly, such computer programs may represent controllers of the computer system 3200.

Features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

FIG. 33 shows example elements of a computing device that may be used to implement any of the various devices described herein, including, for example, a source device (e.g., 102), an encoder (e.g., 114), a destination device (e.g., 106), a decoder (e.g., 120), and/or any computing device described herein. The computing device 3330 may include one or more processors 3331, which may execute instructions stored in the random-access memory (RAM) 3333, the removable media 3334 (such as a Universal Serial Bus (USB) drive, compact disk (CD) or digital versatile disk (DVD), or floppy disk drive), or any other desired storage medium. Instructions may also be stored in an attached (or internal) hard drive 3335. The computing device 3330 may also include a security processor (not shown), which may execute instructions of one or more computer programs to monitor the processes executing on the processor 3331 and any process that requests access to any hardware and/or software components of the computing device 3330 (e.g., ROM 3332, RAM 3333, the removable media 3334, the hard drive 3335, the device controller 3337, a network interface 3339, a GPS 3341, a Bluetooth interface 3342, a WiFi interface 3343, etc.). The computing device 3330 may include one or more output devices, such as the display 3336 (e.g., a screen, a display device, a monitor, a television, etc.), and may include one or more output device controllers 3337, such as a video processor. There may also be one or more user input devices 3338, such as a remote control, keyboard, mouse, touch screen, microphone, etc. The computing device 3330 may also include one or more network interfaces, such as a network interface 3339, which may be a wired interface, a wireless interface, or a combination of the two. The network interface 3339 may provide an interface for the computing device 3330 to communicate with a network 3340 (e.g., a RAN, or any other network). The network interface 3339 may include a modem (e.g., a cable modem), and the external network 3340 may include communication links, an external network, an in-home network, a provider's wireless, coaxial, fiber, or hybrid fiber/coaxial distribution system (e.g., a DOCSIS network), or any other desired network. Additionally, the computing device 3330 may include a location-detecting device, such as a global positioning system (GPS) microprocessor 3341, which may be configured to receive and process global positioning signals and determine, with possible assistance from an external server and antenna, a geographic position of the computing device 3330.

The example in FIG. 33 may be a hardware configuration, although the components shown may be implemented as software as well. Modifications may be made to add, remove, combine, divide, etc. components of the computing device 3330 as desired. Additionally, the components may be implemented using basic computing devices and components, and the same components (e.g., processor 3331, ROM storage 3332, display 3336, etc.) may be used to implement any of the other computing devices and components described herein. For example, the various components described herein may be implemented using computing devices having components such as a processor executing computer-executable instructions stored on a computer-readable medium, as shown in FIG. 33. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may comprise a decoder. The decoder may determine a weight associated with a transform node of a transform tree for a point cloud associated with content. The decoder may determine an attribute prediction mode based on the weight associated with the transform node. The decoder may decode, from a bitstream and based on the attribute prediction mode, attributes associated with the transform node. The decoder may determine the weight based on a quantity of voxels contained in a volume associated with the transform node. The decoder may determine the weight in a way that may be at least one of: determining the weight as being directly proportional to a quantity of voxels contained in a volume associated with the transform node; setting the weight as the quantity of voxels contained in a volume associated with the transform node; or determining the weight based on quantizing the quantity of voxels contained in a volume associated with the transform node. The decoder may determine the attribute prediction mode based on a comparison between the weight and a threshold decoded from the bitstream. The decoder may determine the attribute prediction mode in a way that may be at least one of: determining, based on the weight being higher than a threshold, that the attribute prediction mode is one prediction mode of a set of prediction modes; or determining, based on the weight being less than or equal to the threshold, that the attribute prediction mode is an average prediction mode that is based on at least two prediction modes of the set of prediction modes. The decoder may determine, based on the weight being higher than a threshold, that the attribute prediction mode is one prediction mode of a set of prediction modes. The set of prediction modes may include one or more of: at least one intra prediction mode; at least one inter prediction mode; or a null prediction mode. The decoder may determine, based on the weight being less than a threshold, an a posteriori prediction mode. The decoder may determine an a posteriori prediction mode based on distances for respective prediction modes of a set of prediction modes. Each distance may be calculated based on decoded attributes associated with the transform node and predicted decoded attributes associated with the transform node. The decoder may determine an a posteriori prediction mode as one of a set of prediction modes, and the a posteriori prediction mode may have a minimum distance among distances calculated for the set of prediction modes. The threshold may be decoded from at least one of: a sequence parameter set for a sequence of point cloud frames; an attribute parameter set for a point cloud frame; or an attribute brick header for a volume associated with the transform tree. A prediction of decoded attribute information of the transform node may be determined based on decoded attribute information of child transform nodes of the transform node. Decoded attribute information of a child transform node of the transform node may be a mean attribute of the child transform node. The computing device may comprise one or more processors and memory, storing instructions that, when executed by the one or more processors, perform the method described herein. A system may comprise the computing device configured to perform the described method, additional operations, and/or include additional elements; and a second computing device configured to encode the attributes associated with the transform node. A computer-readable medium may store instructions that, when executed, cause performance of the described method, additional operations, and/or include additional elements.

A computing device may perform a method comprising multiple operations. The computing device may comprise a decoder. The decoder may determine a weight, associated with a Region Adaptive Hierarchical Transform (RAHT) node of a RAHT tree for a point cloud associated with content, based on a quantity of voxels contained in a volume associated with the RAHT node. The decoder may determine an attribute prediction mode based on the weight associated with the RAHT node. The decoder may decode, from a bitstream and based on the attribute prediction mode, attributes associated with the RAHT node. The decoder may determine the weight in a way that may be at least one of: determining the weight as being directly proportional to the quantity of voxels; setting the weight as the quantity of voxels; or determining the weight based on quantizing the quantity of voxels. The decoder may determine the attribute prediction mode based on a comparison between the weight and a threshold decoded from the bitstream. The decoder may determine the attribute prediction mode in a way that may be at least one of: determining, based on the weight being higher than a threshold, that the attribute prediction mode is one prediction mode of a set of prediction modes; or determining, based on the weight being less than or equal to the threshold, that the attribute prediction mode is an average prediction mode that is based on at least two prediction modes of the set of prediction modes. The decoder may determine, based on the weight being less than a threshold, an a posteriori prediction mode. The decoder may determine an a posteriori prediction mode based on distances for respective prediction modes of a set of prediction modes. Each distance may be calculated based on decoded attributes associated with the RAHT node and predicted decoded attributes associated with the RAHT node. The computing device may comprise one or more processors and memory, storing instructions that, when executed by the one or more processors, perform the method described herein. A system may comprise the computing device configured to perform the described method, additional operations, and/or include additional elements; and a second computing device configured to encode the attributes associated with the RAHT node. A computer-readable medium may store instructions that, when executed, cause performance of the described method, additional operations, and/or include additional elements.

A computing device may perform a method comprising multiple operations. The computing device may comprise an encoder. The encoder may determine a weight associated with a transform node of a transform tree for a point cloud associated with content. The encoder may determine an attribute prediction mode based on the weight associated with the transform node. The encoder may encode, in a bitstream and based on the attribute prediction mode, attributes associated with the transform node. The encoder may determine the weight based on a quantity of voxels contained in a volume associated with the transform node. The encoder may determine the weight in a way that may be at least one of: determining the weight as being directly proportional to a quantity of voxels contained in a volume associated with the transform node; setting the weight as the quantity of voxels contained in a volume associated with the transform node; or determining the weight based on quantizing the quantity of voxels contained in a volume associated with the transform node. The encoder may determine the attribute prediction mode based on a comparison between the weight and a threshold that may be encoded in the bitstream. The encoder may determine the attribute prediction mode in a way that may be at least one of: determining, based on the weight being higher than a threshold, that the attribute prediction mode is one prediction mode of a set of prediction modes; or determining, based on the weight being less than or equal to the threshold, that the attribute prediction mode is an average prediction mode that is based on at least two prediction modes of the set of prediction modes. The encoder may determine an a posteriori prediction mode based on distances for respective prediction modes of a set of prediction modes. Each distance may be calculated based on encoded attributes associated with the transform node and predicted encoded attributes associated with the transform node. The computing device may comprise one or more processors and memory, storing instructions that, when executed by the one or more processors, perform the method described herein. A system may comprise the computing device configured to perform the described method, additional operations, and/or include additional elements; and a second computing device configured to decode the attributes associated with the transform node. A computer-readable medium may store instructions that, when executed, cause performance of the described method, additional operations, and/or include additional elements.

A computing device may perform a method comprising multiple operations. The computing device may comprise an encoder or a decoder. The encoder may obtain a weight associated with a RAHT node of a RAHT tree, based on a quantity of voxels contained in a volume associated with the RAHT node. The encoder may determine an attribute prediction mode based on the weight associated with the RAHT node. The encoder may encode, in a bitstream and based on the attribute prediction mode, attributes associated with the RAHT node. The decoder may obtain a weight, associated with a RAHT node of a RAHT tree, based on a quantity of voxels contained in a volume associated with the RAHT node. The decoder may determine an attribute prediction mode based on the weight associated with the RAHT node. The decoder may decode, from a bitstream and based on the attribute prediction mode, attributes associated with the RAHT node. The attribute prediction mode may be determined based on a comparison between the weight and a threshold. The weight being higher than the threshold may indicate that the attribute prediction mode is determined as one prediction mode of a set of prediction modes. The weight being less than or equal to the threshold may indicate the attribute prediction mode being an average prediction mode that combines at least two prediction modes of the set of prediction modes. The threshold may be encoded in a bitstream or decoded from a bitstream. The threshold may be encoded in or decoded from a sequence parameter set for a sequence of point cloud frames. The threshold may be encoded in or decoded from an attribute parameter set for a point cloud frame. The threshold may be encoded in or decoded from an attribute brick header for a volume associated with the RAHT tree. An a posteriori prediction mode may be determined and associated with the RAHT node based on the a posteriori prediction mode being activated. The a posteriori prediction mode may be activated based on the weight being lower than the threshold. The posteriori prediction mode may be determined as one of the set of prediction modes. The encoder or decoder may determine the a posteriori prediction mode. More specifically, the encoder or decoder may calculate distances for respective prediction modes of the set of prediction modes. Each distance may be calculated between decoded attribute information of the RAHT node derived from the decoded RAHT coefficients and a prediction of the decoded attribute information associated with the RAHT node derived from a respective prediction mode of the set of prediction modes. The encoder or decoder may determine the a posteriori prediction mode as being the prediction mode with the minimum distance. The decoded attribute information of the RAHT node may include decoded attributes associated with the RAHT node derived from the decoded RAHT coefficients. The prediction of the decoded attribute information of the RAHT node may include predicted decoded attributes associated with the RAHT node and derived based on the prediction mode of the set of prediction modes. Each distance may be calculated between the decoded attributes of the RAHT node and the predicted decoded attributes. The prediction of the decoded attribute information of the RAHT node may be derived based on decoded attribute information of child RAHT nodes of the RAHT node. The distance may be a sum of errors over the child RAHT nodes of the RAHT node. Each error may be defined between decoded attribute information of a respective child RAHT node of the child RAHT nodes and the decoded attribute information associated with the RAHT node. The sum of errors may be a sum of absolute difference or a sum of squared difference. The decoded attribute information of a child RAHT node of the RAHT node may be the mean attribute of the child RAHT node. Each error may be calculated between the mean attribute of the RAHT node and a prediction derived based on the mean attribute of a child RAHT node of the RAHT node. The set of prediction modes may include at least one intra prediction mode and/or at least one inter prediction mode and/or a null prediction mode. The computing device may comprise one or more processors and memory, storing instructions that, when executed by the one or more processors, perform the method described herein. A system may comprise the computing device configured to perform the described method, additional operations, and/or include additional elements; and a second computing device configured to decode or encode the attributes associated with the RAHT node. A computer-readable medium may store instructions that, when executed, cause performance of the described method, additional operations, and/or include additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
determining a weight associated with a transform node of a transform tree for a point cloud associated with content;
determining an attribute prediction mode based on the weight associated with the transform node; and
decoding, from a bitstream and based on the attribute prediction mode, attributes associated with the transform node.

2. The method of claim 1, wherein the determining the weight is based on a quantity of voxels contained in a volume associated with the transform node.

3. The method of claim 1, wherein the determining the weight further comprises at least one of:
determining the weight as being directly proportional to a quantity of voxels contained in a volume associated with the transform node;
setting the weight as the quantity of voxels contained in a volume associated with the transform node; or
determining the weight based on quantizing the quantity of voxels contained in a volume associated with the transform node.

4. The method of claim 1, wherein the determining the attribute prediction mode further comprises:
determining the attribute prediction mode based on a comparison between the weight and a threshold decoded from the bitstream.

5. The method of claim 1, wherein the determining the attribute prediction mode further comprises at least one of:
determining, based on the weight being higher than a threshold, the attribute prediction mode is one prediction mode of a set of prediction modes; or
determining, based on the weight being less than or equal to the threshold, the attribute prediction mode is an average prediction mode that is based on at least two prediction modes of the set of prediction modes.

6. The method of claim 1, wherein the determining the attribute prediction mode further comprises:
determining, based on the weight being higher than a threshold, the attribute prediction mode is one prediction mode of a set of prediction modes,
wherein the set of prediction modes include one or more of:
at least one intra prediction mode;
at least one inter prediction mode; or
a null prediction mode.

7. The method of claim 1, wherein the determining the attribute prediction mode further comprises:
determining, based on the weight being less than a threshold, an a posteriori prediction mode.

8. The method of claim 1, wherein the determining the attribute prediction mode further comprises:
determining an a posteriori prediction mode based on distances for respective prediction modes of a set of prediction modes,
wherein each distance is calculated based on decoded attributes associated with the transform node and predicted decoded attributes associated with the transform node.

9. A method comprising:
determining a weight, associated with a Region Adaptive Hierarchical Transform (RAHT) node of a RAHT tree for a point cloud associated with content, based on a quantity of voxels contained in a volume associated with the RAHT node;
determining an attribute prediction mode based on the weight associated with the RAHT node; and
decoding, from a bitstream and based on the attribute prediction mode, attributes associated with the RAHT node.

10. The method of claim 9, wherein the determining the weight further comprises at least one of:
determining the weight as being directly proportional to the quantity of voxels;
setting the weight as the quantity of voxels; or
determining the weight based on quantizing the quantity of voxels.

11. The method of claim 9, wherein the determining the attribute prediction mode further comprises:
determining the attribute prediction mode based on a comparison between the weight and a threshold decoded from the bitstream.

12. The method of claim 9, wherein the determining the attribute prediction mode further comprises at least one of:
determining, based on the weight being higher than a threshold, the attribute prediction mode is one prediction mode of a set of prediction modes; or
determining, based on the weight being less than or equal to the threshold, the attribute prediction mode is an average prediction mode that is based on at least two prediction modes of the set of prediction modes.

13. The method of claim 9, wherein the determining the attribute prediction mode further comprises:
determining, based on the weight being less than a threshold, an a posteriori prediction mode.

14. The method of claim 9, wherein the determining the attribute prediction mode further comprises:
determining an a posteriori prediction mode based on distances for respective prediction modes of a set of prediction modes,
wherein each distance is calculated based on decoded attributes associated with the RAHT node and predicted decoded attributes associated with the RAHT node.

15. A method comprising:
determining a weight associated with a transform node of a transform tree for a point cloud associated with content;
determining an attribute prediction mode based on the weight associated with the transform node; and
encoding, in a bitstream and based on the attribute prediction mode, attributes associated with the transform node.

16. The method of claim 15, wherein the determining the weight is based on a quantity of voxels contained in a volume associated with the transform node.

17. The method of claim 15, wherein the determining the weight further comprises at least one of:
determining the weight as being directly proportional to a quantity of voxels contained in a volume associated with the transform node;
setting the weight as the quantity of voxels contained in a volume associated with the transform node; or
determining the weight based on quantizing the quantity of voxels contained in a volume associated with the transform node.

18. The method of claim 15, wherein the determining the attribute prediction mode further comprises:
determining the attribute prediction mode based on a comparison between the weight and a threshold that is encoded in the bitstream.

19. The method of claim 15, wherein the determining the attribute prediction mode further comprises at least one of:
determining, based on the weight being higher than a threshold, the attribute prediction mode is one prediction mode of a set of prediction modes; or
determining, based on the weight being less than or equal to the threshold, the attribute prediction mode is an average prediction mode that is based on at least two prediction modes of the set of prediction modes.

20. The method of claim 15, wherein the determining the attribute prediction mode further comprises:
determining an a posteriori prediction mode based on distances for respective prediction modes of a set of prediction modes,
wherein each distance is calculated based on encoded attributes associated with the transform node and predicted encoded attributes associated with the transform node.
